(19) United States
(12) Patent Application Publication
(10) Pub. No.: US 2017/0364637 A1
(43) Pub. Date: Dec. 21, 2017

(54) MOBILE HEALTH MANAGEMENT DATABASE, TARGETED EDUCATIONAL ASSISTANCE (TEA) ENGINE, SELECTIVE HEALTH CARE DATA SHARING, FAMILY TREE GRAPHICAL USER INTERFACE, AND HEALTH JOURNAL SOCIAL NETWORK WALL FEED, COMPUTER-IMPLEMENTED SYSTEM, METHOD AND COMPUTER PROGRAM PRODUCT

(71) Applicant: ICmed, LLC, Baltimore, MD (US)

(72) Inventors: Anil Kumar Kshepakaran, Reisterstown, MD (US); Gregory Henry Pelton, Towson, MD (US); James Joseph Jacobsen, Reisterstown, MD (US); Yaya Jata Fanusie, Columbia, MD (US); Michael Joseph McShea, Ellicott City, MD (US); Patrick Arthur O'Shea, Richmond, VA (US)

(73) Assignee: ICmed, LLC, Baltimore, MD (US)

(21) Appl. No.: 15/603,441

(22) Filed: May 24, 2017

Related U.S. Application Data
(60) Provisional application No. 62/340,760, filed on May 24, 2016.

(51) Int. Cl. G06F 19/00; G06F 17/30; G06Q 50/00; G06F 3/0488; G06F 21/62; G06F 21/60

(52) U.S. Cl. CPC G06F 19/322; G06F 17/30539; G06F 19/3406; G06F 21/602; G06F 3/0488; G06F 21/6245; G06Q 50/01; G06F 19/345

(57) ABSTRACT

A system, method and computer program product of capturing and displaying health information of a first person on an electronic computing device, the electronic computing device can include: one or more computer processors; and one or more memory devices, the computer-implemented method can include, e.g., a) receiving data electronically about a first person user on the first client computing device, where the first person user has one or more family member users, each having one or more computing devices, or a user with which the user may wish to share a personal health data record, the data about the first person user can include: any identification data, any inputted health related data, or any captured health related data about the first person, can include: any health related data; an application programming interface (API) accessible data; or other health records such as, e.g., electronic medical record (EMR); scanned data; sensed data; or optical character recognition (OCR) captured data; b) receiving data about one or more second person users, where the at least one second person user can include: any other person user with which the first person wishes to be connected, a family member, a guardian, a friend, an individual, or care provider, the data about the second person users can include: any identification data, any inputted health related data, or any captured health related data about the second person user(s); and c) sharing at least a portion of the data electronically about the first person user, to the second person user(s). Various other embodiments can include various features such as a health journal, targeted educational content, an interactive family tree, selectable sharing, escalated alerting, notifications, and collaborative digital file cabinet.

### CROSS-REFERENCE TO RELATED APPLICATIONS

This Application claims the benefit under 35 U.S.C. §119(e) of U.S. Provisional Patent Application No. 62/340,760 filed May 24, 2016, the contents of which is incorporated herein by reference in its entirety.

### BACKGROUND

### Technical Field

The present disclosure relates generally to computers and computer related technology. More particularly, the present disclosure relates to an improved computer based system of capturing and providing access to personal health histories on a computer device.

### Related Art

Various conventional systems have been created to capture health history data such as, e.g., but not limited to, US 20110125528, US 20020143578 A1, US 20140337050 A1, WO 2011001248 A1, US 20140100874 A1, U.S. Pat. No. 8,788,287 B2, U.S. Pat. No. 9,159,223 B2, US 20100185517 A1, U.S. Pat. No. 8,684,922 B2, US 20020082868 A1, U.S. Pat. No. 8,156,158 B2, US 20140172864 A1, U.S. Pat. No. 6,240,421 B1, US 20140313303 A1, US 2009177495 A1, U.S. Pat. No. 5,924,074 A, U.S. Pat. No. 6,039,688 A, U.S. Pat. No. 6,581,038 B1, U.S. Pat. No. 7,444,291 B1, U.S. Pat. No. 7,412,458 B1, U.S. Pat. No. 6,802,810 B2, U.S. Pat. No. 7,181,375 B2, US 20030225597 A1, US 20040122706 A1, US 20040122702 A1, US 20050010088 A1, and US 20070175980 A1, the contents of all of which are incorporated herein by reference in their entireties.

However, conventional personal health information systems lack intuitive interaction, portability, scalability and accessibility features, making their use less than optimal.

What is needed is an improved personal health information system that includes associations with family health histories, overcomes shortcomings of conventional solutions, and can provide computing performance improvements to provide improved electronic access to the vast amounts of personal health data and educational material that continues to remain conventionally inaccessible to provide tools conventionally unavailable to help people manage and learn from their health profiles more efficiently.

### SUMMARY OF AN EXEMPLARY EMBODIMENT OF THE CLAIMED INVENTION

Various exemplary embodiments of a computer-implemented method, system and computer program product of capturing and displaying health information of a first person on an electronic computing device, the electronic computing device can include: at least one computer processor; and at least one memory device, the computer-implemented method can include: a) receiving, by the at least one computer processor, data about a first person user on at the at least one first client computing device, wherein the first person user has one or more family member users, each having at least one computing device, or at least one user, or organization with which the user may wish to share a personal health data record, the data about the at least one first person user comprising: any identification data about the first person; any inputted health related data about the first person; or any captured health related data about the first person, comprising at least one of: any health related data; an application programming interface (API) accessible data; or other health records comprising at least one of: electronic medical record (EMR); scanned data; sensed data; or optical character recognition (OCR) captured data; b) receiving, by the at least one computer processor, data about at least one second person user, wherein the at least one second person user comprises at least one of: any other person user with which the first person wishes to be connected, a family member user, a guardian user, a friend user, an individual friend user, or an individual care provider, care provider, or organization, the data about the at least one second person user comprising: any identification data about the at least one second person; any inputted health related data about the at least one second person; or any captured health related data about the at least one second person; and c) sharing, by the at least one computer processor, at least a portion of the data about the first person user, to the at least one second person user.

According to one exemplary embodiment, the computer-implemented method can include where the sharing of said (c) comprises at least one of: i) sharing with a computing device of the at least one second user, wherein the at least one second user is an individual; ii) sharing with a plurality of computing devices of the at least one second user, wherein the at least one second user is at least one of an individual, or a group; iii)sharing with a computing device of a user previously managed by the first person user; iv) sharing by a computing device of the first person user, wherein the first person user is a parent or guardian, to a computing device of the at least one second person user, wherein the at least one second person user is a child and wherein said sharing occurs at a time comprising at least one of: A) when the child becomes an age of majority; B) at a predetermined age, or C) upon occurrence of a certain event; v) sharing with at least one computing device of the at least one second user, wherein the at least one second user comprises at least one of an individual, or a group, and wherein the at least one individual or group comprises at least one of: a computing device of a family member user; a computing device of a friend user; a computing device of a relative user; a computing device of a parent user; a computing device of a child user; a computing device of a health care provider user; a computing device of a doctor user; a computing device of a dentist user; a computing device of a specialist user; a computing device of a nurse user; a computing device of a nurse practitioner user; a computing device of a care provider user; or a computing device of another user.

According to one exemplary embodiment, the computer-implemented method can include where the sharing of said (c) comprises at least one of: i) selectively sharing of only a portion of the data of the first person user; or ii) receiving a selected portion of the data of the first person user to be selectively shared with respect to the at least one second person user.

According to one exemplary embodiment, the computer-implemented method further can include: d) receiving, by the at least one computer processor, permission data granting at least one of: permission, opt-in; or opt-out, about providing selective access to the data about the first person to allow selectively sharing a selected portion of the data about the first person to the at least one second person, or selectively choosing at least one portion, or all of the data about the first person with at least one of: the at least one second person; or at least one additional person.

According to one exemplary embodiment, the computer-implemented method can further include: d) encrypting and storing, by the at least one computer processor, the data of the first person user, and the data of the at least one second person user in the memory.

According to one exemplary embodiment, the computer-implemented method can further include: d) analyzing, by the at least one computer processor, in an electronic decision support system the data about the first person user, and the at least one second person user, to identify targeted educational assistance (TEA) content data based on the data of the first person and the at least one second person; and e) providing, by the at least one computer processor, output of the analyzed TEA content data.

According to one exemplary embodiment, the computer-implemented method can further include: f) transmitting, by the at least one computer processor, the identified targeted educational assistance (TEA) content resulting from said analyzing of said d), over an electronic communications network to at least one mobile computing device of at least one of: i. the first person; or ii. the at least one second person.

According to one exemplary embodiment, the computer-implemented method can further include: wherein the at least one computing device comprises at least one interactive touch screen based input output display; d) displaying, by the at least one computer processor, in an interactive electronic graphical user interface (GUI) on the at least one interactive touch screen based input output display, a graphical indication of any familial relationship between the first person user and the at least one second person user; and e) enabling, by the at least one computer processor, interactive access to the graphical indication of the any familial relationship between the first person user and the at least one second person user.

According to one exemplary embodiment, the computer-implemented method can further include: capturing, by the at least one computer processor, any familial relationship between the first person and the at least one second person.

According to one exemplary embodiment, the computer-implemented method can include where: the at least one second person user comprises at least one marketer, employer, insurer or care provider user of the first person user; and further comprising: d) electronically mining, by the at least one computer processor, the data of at least one of the first person user or the at least one second person user, and e) based on said electronically mining, providing, by the at least one computer processor, targeted information based on said electronically mined data.

According to one exemplary embodiment, the computer-implemented method can include where the sharing of the data is provided via an electronic online social networking wall where social network wall posts can be posted of at least one personal health data post of the first person user, for selective sharing to the at least one second person user, and receiving indication of selection of, and displaying receipt of the selected indication of a graphical user interface element by the user indicating the user's reaction to the social network post of a positive indication of the social network post shared on the electronic online social networking wall.

According to one exemplary embodiment, the computer-implemented method can include where the second person user comprises at least one marketer, employer, insurer or care provider user of the first person user in which the first person user connects to the second person user with an organizational identification number or other identifier of the second person user, to receive content from the second person user on the first person user's social networking wall (see FIG. 40).

According to one exemplary embodiment, a data processing system of capturing and displaying health information of a first person can include: an electronic computing device, the electronic computing device comprising: at least one computer processor; and at least one memory device; and wherein the at least one computer processor is configured to: receive data about a first person user on at the at least one first client computing device, wherein the first person user has one or more family member users, each having at least one computing device, or at least one user with which the user may wish to share a personal health data record, the data about the at least one first person user comprising: any identification data about the first person; any inputted health related data about the first person; or any captured health related data about the first person, comprising at least one of: any health related data; an application programming interface (API) accessible data; or other health records comprising at least one of: electronic medical record (EMR); scanned data; sensed data; or optical character recognition (OCR) captured data; receive data about at least one second person user, wherein the at least one second person user comprises at least one of: any other person user with which the first person wishes to be connected, a family member user, a guardian user, a friend user, an individual friend user, or an individual care provider, the data about the at least one second person user comprising: any identification data about the at least one second person; any inputted health related data about the at least one second person; or any captured health related data about the at least one second person; and share at least a portion of the data about the first person user, to the at least one second person user.

According to one exemplary embodiment, a data processing system of capturing and displaying data in electronic file cabinets created by the first person user or other person user with which the first person wishes to be connected, a family member user, a guardian user, a friend user, an individual friend user, or an individual care provider or organization. The data about the at least one first person user comprising: any identification data, any inputted health related data, or any captured health related data; comprising any health related data, application programming interface (API) accessible data, or other health records comprising electronic medical record (EMR), scanned data, sensed data, or optical character recognition (OCR) captured data(see FIGS. 37, 38, 39, and 41, for example).

A system for detecting that a patient is not adhering to prescribed and non-prescribed medications and for activating a chain of notifications based on the detection of non-adherence, the system comprising: an electronic computing device, the electronic computing device comprising: at least one computer processor; and at least one memory device; and wherein the at least one computer processor is configured to: receive data about patient-adherence derived from inputs from the first person user or other person user with which the first person wishes to be connected, a family member user, a guardian user, a friend user, an individual friend user, or an individual care provider or organization (see FIGS. 31, 32, 33, 34, and 35 for example).

According to one exemplary embodiment, a computer program product embodied on a computer accessible nontransitory medium can include program logic, which when executed on at least one computer processor implements a computer-implemented method of capturing and displaying health information of a first person on an electronic computing device, the electronic computing device can include: at least one computer processor; and at least one memory device, the computer-implemented method can include: a) receiving, by the at least one computer processor, data about a first person user on at the at least one first client computing device, wherein the first person user has one or more family member users, each having at least one computing device, or at least one user with which the user may wish to share a personal health data record, the data about the at least one first person user comprising: any identification data about the first person; any inputted health related data about the first person; or any captured health related data about the first person, comprising at least one of: any health related data; an application programming interface (API) accessible data; or other health records comprising at least one of: electronic medical record (EMR); scanned data; sensed data; or optical character recognition (OCR) captured data; b) receiving, by the at least one computer processor, data about at least one second person user, wherein the at least one second person user comprises at least one of: any other person user with which the first person wishes to be connected, a family member user, a guardian user, a friend user, an individual friend user, or an individual care provider, the data about the at least one second person user comprising: any identification data about the at least one second person; any inputted health related data about the at least one second person; or any captured health related data about the at least one second person; and c) sharing, by the at least one computer processor, at least a portion of the data about the first person user, to the at least one second person user.

According to another exemplary embodiment a system method or computer program product can include where the method of escalated alerting comprises:transmitting alerts, to at least one of: the first person user; or any connected second person user; or any connected second person user comprising at least one of; at least one family member, at least one individual care provider, or at least one organization.

According to another exemplary embodiment a system method or computer program product can include where the system can further comprising wherein the data processing system comprises: wherein the data processing system is configured to: capture and display data in electronic file cabinets; wherein said electronic file cabinets are configured to, upon request by the first person or other person user with which the first person wishes to be connected, a family member user, a guardian user, a friend user, an individual friend user, or an individual care provider or organization, create a folder to store the data (see, e.g., FIGS. 37, 38, 39, and 41).

According to another exemplary embodiment a system method or computer program product can include where the system can further include at least one of: wherein the data about the at least one first person user comprises: any identification data, any inputted health related data, or any captured health related data; or wherein the data comprises at least one of: personal medical and health information; any health related data, application programming interface (API) accessible data, or other health records comprising at least one of: electronic medical record (EMR), scanned data, sensed data, or optical character recognition (OCR) captured data.

According to another exemplary embodiment a system method or computer program product can include where the system further can include where the data processing system comprises: wherein the system is configured to at least one of: detect that a patient is not adhering to prescribed or non-prescribed medications; and upon detection, to activate a chain of escalating notifications based on the detection of non-adherence, the system comprising: an electronic computing device, wherein the electronic computing device comprises: at least one computer processor; and at least one memory device; and wherein the at least one computer processor is configured to: receive data about patient-adherence derived from inputs from at least one of: the first person user; other person user with which the first person wishes to be connected; a family member user; a guardian user; a friend user; an individual friend user; an individual care provider; or organization(see, e.g., FIGS. 31, 32, 33, 34, and 35).

### BRIEF DESCRIPTION OF THE DRAWINGS

The foregoing and other features and advantages of the invention will be apparent from the following, more particular description of an embodiment of the invention, as illustrated in the accompanying drawings wherein like reference numbers generally indicate identical, functionally similar, and/or structurally similar elements. The left most digits in the corresponding reference number indicate the drawing in which an element first appears.

The following figures depict various exemplary embodiments of the present invention:

FIG. 1A depicts an exemplary embodiment of a TEA Engine System block diagram, depicting exemplary high-level elements of an exemplary embodiment of the exemplary system including a user with an exemplary ICmed mobile device including a health profile, an intelligent health system including automated analysis, data stores, an ICmed Tea Engine and content providers, according to an exemplary embodiment;

FIG. 1B depicts exemplary high-level elements of an exemplary embodiment of the exemplary system including an exemplary first user having a first user device, an exemplary second user and user device, an analysis, viewing, reporting, alerting, notification subsystem, where the second user can be an individual or organization, an exemplary organization or parent management subsystem, an exemplary notification and/or messaging subsystem and/or a database subsystem, according to an exemplary embodiment;

FIG. 1C depicts an exemplary view of an exemplary embodiment of an exemplary distributed user environment using a plurality of computing and communication devices coupled together in a distributed networked system architecture, according to an exemplary embodiment;

FIG. 1D depicts an exemplary embodiment of a diagram illustrating an activity receiving input, or receiving capture of personal health information, analyzing and processing the information, providing, displaying, transmitting and/or delivering the information via a computer and communications system architecture, according to an exemplary embodiment coupled together by an exemplary cloud-based architecture network, according to an exemplary embodiment.

FIG. 1E depicts an exemplary embodiment of a diagram illustrating an exemplary user system that may include various content capture devices (not shown), in an exemplary embodiment, a mobile device, a microphone, screen and/or webcam can be coupled to an example system to capture and/or deliver the data content from a first user computer system over a communications network such as the Internet to exemplary cloud storage, and may perform further processing and analyzing on various webservers and/or application servers, and for providing access to the analyzed content by the first and/or other users such as, e.g., but not limited to, care providers, and/or others to which the information may be shared, according to an exemplary embodiment, and all may be coupled together, as illustrated, by an exemplary cloud-based architecture network, according to an exemplary embodiment;

FIG. 1F depicts an exemplary embodiment of an exemplary system illustrating an exemplary distributed user activity recording system for capturing user activity and/or personal health information of an exemplary user, whose computer system, and/or mobile device system can be coupled to an exemplary cloud-based network and storage system, which itself could be coupled to exemplary remote storage and/or, database, and/or an exemplary database management (DBMS) application system, an exemplary messaging system, an exemplary management system, and an exemplary analysis/viewing/reporting/alerts/notification system, as could be used by another exemplary user device to permit receipt, display, and review and communicate with member user devices, according to an exemplary embodiment;

FIG. 2A depicts an exemplary mobile device application exemplary graphical user interface screenshot of an exemplary first user, having a plurality of exemplary second user connections, according to an exemplary embodiment;

FIG. 2B depicts an exemplary mobile device application exemplary graphical user interface screenshot of an exemplary second user, illustrating exemplary orange circle graphical user interface (GUI) elements, indicating exemplary unread messages, e.g., for vitals, and history, according to an exemplary embodiment;

FIG. 3A depicts an exemplary mobile device application exemplary graphical user interface screenshot of the exemplary first user, illustrating an exemplary health home screen, according to an exemplary embodiment; the home health screen programmed so that views of tracking vitals and health modules can be customizable, according to an exemplary embodiment

FIG. 3B as shown illustrates various exemplary icons, an exemplary TEA indicator, and an example mood indication, as well as an exemplary back button, in one exemplary embodiment;

FIG. 3C depicts an exemplary mobile device application exemplary graphical user interface screenshot of an example embodiment of a display of an example cholesterol (CL) vitals data screen illustrating an example history of data including cholesterol data of three example dates, allowing the user to view and have the functionality to be able to share at this example level of granularity example vitals data with a second user of the system, according to an exemplary embodiment;

FIG. 3D depicts an exemplary mobile device application exemplary graphical user interface screenshot of an example embodiment of an additional display of further example cholesterol (CL) vitals data screen illustrating an example graph of the history of data including cholesterol data of the various example dates, allowing viewing by a time period, such as, e.g., but not limited to, a week, month, year, etc., as well as ability to select total cholesterol, or any subsets (LDL, HDL, TRL), for any of various selectable date ranges, and allowing the user to use a menu selection to capture a doctor suggested value, or to select to show all data, according to an exemplary embodiment; from show all data, in an exemplary embodiment, the user can be taken to screenshot; as shown, further data can be added by clicking on add data; an exemplary system can allow for receiving into the system, example doctor suggested values, and can be configured to graph in an example line chart displaying the doctor suggested values of between and on the graph, along with actual observed, captured historical cholesterol values, providing an example benchmark for the captured vitals data, in one example embodiment;

FIG. 3E depicts exemplary mobile device application exemplary graphical user interface screenshot of an example embodiment of an additional display of further example blood pressure vitals data input screen, illustrating an example interface as can be obtained when GUI element, selected to bring the user to screen for entry of required data fields, or optional data fields, using exemplary data entry keys, which can be numeric, and/or alphanumeric, and can enable jumping from field to field of the data record by selection user interface element, until done can remove the keyboard of keys, and the record can be saved with save GUI element, according to an exemplary embodiment;

FIG. 4A depicts exemplary mobile device application exemplary graphical user interface screenshot 400 of an example embodiment of an exemplary My Journal user health journal providing an online electronic social network wall for postings of personal health information record data, allowing for receiving a new entry by the add entry GUI element, and for posting online social network wall posts of exemplary text and/or emoji from a posting user, such as yourself, and/or showing posts of other users, who have selectively shared access to a post to the user of the health journal, and a user can react to the post by providing an indication reaction such as, e.g., but not limited to, an example icare indicator, a like indicator, and/or any other exemplary indication of reaction to the social network post, according to an embodiment where posts are in exemplary reverse chronological order, illustrating an example scrollable wall, according to an exemplary embodiment;

FIG. 4B depicts exemplary mobile device application exemplary graphical user interface screenshot of an example embodiment of an exemplary screen illustrating an interactive display to add a post to the My Journal user health journal shown in FIG. 4A, providing an interface to receive entry of an electronic post, which may include text 412 fields, security indication, help (?) buttons, image and/or video content upload, and an exemplary alphanumeric keyboard can be provided to allow receipt of entered data by the exemplary system, which can automatically post to the online electronic social network wall of the user, and advantageously of other users, that the posting user has granted selectable sharing access to the inputted or captured data content post, according to an exemplary embodiment;

FIG. 4C depicts an exemplary mobile device application exemplary graphical user interface screenshot of an example embodiment of an exemplary screen illustrating an exemplary embodiment of the health journal illustrating various example image content posts, as could been received using an interface as discussed with reference to FIG. 4B, as well as illustrating an exemplary scroll indicator indicating additional posts can be viewed by scrolling upward or downward, in this case, to view additional social media wall posts of the personal health information data, according to an exemplary embodiment;

FIG. 4D depicts an exemplary mobile device application exemplary graphical user interface screenshot of an example embodiment of an exemplary screen illustrating an exemplary embodiment of the health journal illustrating another user's online social media health journal wall post of an example user Mary Hamilton, who has previously selectively shared her information with the user whose health journal is displayed, according to an exemplary embodiment;

FIG. 5A depicts an exemplary mobile device application exemplary graphical user interface screenshot of an example embodiment of an exemplary screen illustrating an exemplary embodiment of an exemplary medications display page illustrating a personal health information medication post, according to an exemplary embodiment;

FIG. 5B depicts an exemplary mobile device application exemplary graphical user interface screenshot of an example embodiment of an exemplary screen illustrating an exemplary embodiment of an exemplary add medication data entry GUI page illustrating an interface to receive entry of personal health information medication data posts, including a medication interactive selection form allowing entry and receipt into the system of a total quantity in a prescription, a strength to be received, a strength measurement, a dosage, a schedule, a simple or advanced dosage description capture, a frequency selector of donation, and a size of a dose, according to an exemplary embodiment;

FIG. 5C depicts an exemplary mobile device application exemplary graphical user interface screenshot of an example embodiment of an exemplary screen illustrating an exemplary embodiment of an exemplary search medication query GUI page illustrating an interface to receive entry of a text based search using an exemplary alphanumeric keyboard to receive a query into field, and as the search terms of the query are entered, automatically, a list of potential medications fitting the search query can be displayed as the user continues to use the keyboard to enter characters into the search field, according to an exemplary embodiment;

FIG. 5D depicts an exemplary mobile device application exemplary graphical user interface screenshot of an example embodiment of an exemplary screen illustrating an exemplary embodiment of an exemplary form GUI page allowing user selection based receipt by the system of selection of an picture representing the form (tablet, capsule, drops, inhaler, etc.) of the medicine; form (e.g., shape, type, pill, inhalant, liquid, capsule, etc.) provides added instruction and confirmation of dosage type, according to an exemplary embodiment;

FIG. 5E depicts an exemplary mobile device application exemplary graphical user interface screenshot of an example embodiment of an exemplary screen illustrating an exemplary embodiment of an exemplary GUI page illustrating retaining history, a stop button to remove medication from a current list and to move to archive, and a system programmed to show an example NIH fact sheet, respectively, in one embodiment; the exemplary system retains history by date/time timestamp, or other temporal indication, an exemplary stop button to tell the system when the user is instructed to discontinue use, programmed to remove medication from current list and move to archive (which can be saved forever), according to an exemplary embodiment

FIG. 5F depicts an exemplary mobile device application exemplary graphical user interface screenshot of an example embodiment of an exemplary screen illustrating an exemplary embodiment of an exemplary GUI page illustrating an exemplary system programmed to allow display of an exemplary national institutes of health (NIH) Fact sheet, according to an exemplary embodiment;

FIG. 6A depicts an exemplary mobile device application exemplary graphical user interface screenshot of an example embodiment of an exemplary screen illustrating an exemplary embodiment of a screen illustrating entry of information about a visit, which may include care provider information, which can be automatically imported from a care provider module, a screen illustrating adding a visit, and allowing edit of visit information, according to an exemplary embodiment;

FIG. 6B depicts an exemplary mobile device application exemplary graphical user interface screenshot of an example embodiment of an exemplary screen illustrating an exemplary embodiment of a screen illustrating entry of information about a visit, tracking unplanned visits separately from planned visits, and allowing edit of visit information for an unplanned visit, according to an exemplary embodiment;

FIG. 6C depicts an exemplary mobile device application exemplary graphical user interface screenshot of an example embodiment of an exemplary screen illustrating an exemplary embodiment of a screen illustrating entry of information about a visit, tracking unplanned visits separately from planned visits, and allowing edit of visit information for a planned visit, according to an exemplary embodiment;

FIGS. 7A-7B (collectively referred to as FIG. 7) depict exemplary mobile device application exemplary graphical user interface screenshots of an example embodiment of an exemplary screen illustrating an exemplary embodiment of care providers being imported automatically from contacts, or captured through automated electronic data retrieval from, e.g., but not limited to, third party data providers, email service providers, social networks, etc., respectively, according to an example embodiment;

FIGS. 8A-8D (FIGS. 8A-8J are collectively referred to as FIG. 8) depict exemplary mobile device application exemplary graphical user interface screenshots of an example embodiment of an exemplary screen illustrating an exemplary embodiment of history separated logically into an example four sections providing efficient access and sharing options, and/or can be captured through automated electronic retrieval from e.g., third parties, etc., displaying medical history at a glance, can provide for receiving medical history notes, or by capture from third parties, etc., can prepopulate pervasive conditions for selection by a user, can provide for ease of data entry burden via user interface feature improvements for capturing data, respectively, according to an example embodiment;

FIGS. 8A-8D (FIGS. 8A-8K are collectively referred to as FIG. 8) depict exemplary mobile device application exemplary graphical user interface screenshots of an example embodiment of an exemplary screen illustrating an exemplary embodiment of history separated logically into an example four sections providing efficient access and sharing options, and/or can be captured through automated electronic retrieval from e.g., third parties, etc., displaying medical history at a glance, can provide for receiving medical history notes, or by capture from third parties, etc., can prepopulate pervasive conditions for selection by a user, can provide for ease of data entry burden via user interface feature improvements for capturing data, respectively, according to an example embodiment;

FIGS. 8E-8G depict exemplary mobile device application exemplary graphical user interface screenshots of an example embodiment of an exemplary screen illustrating an exemplary embodiment of allowing for interactive display/access to medical history for user(e.g. a first user), or other users that have been connected to profile (e.g., second users), social media can be logically separated from other medical histories in an embodiment, history can be captured by the system receiving receipt of user's manual gestures and/or keystrokes, etc. by use of interactive interfaces (voice recognition, touch screen, stylus, sensors, etc., and/or through automated electronic, optical, or other data retrieval,) respectively, according to an example embodiment;

FIGS. 8H-8K depict exemplary mobile device application exemplary graphical user interface screenshots of an example embodiment of an exemplary screen illustrating an exemplary embodiment of receiving input, or capturing data input, such as, e.g., allergy information, side effects, medications, food intolerance, reactions, etc., immunization history, interfaces for adding allergies can be provided, and for adding immunizations can be provided, respectively, in one embodiment, according to an example embodiment;

FIGS. 9A-9D (collectively referred to as FIG. 9) depict exemplary mobile device application exemplary graphical user interface screenshots of an example embodiment of an exemplary screen illustrating an exemplary embodiment of providing insurance information, such as capturing insured data, policy information, group, phone, address of insurance provider, other identification, insurance card, images of cards, make available for sharing of insurance information, providing prepopulated message to accompany sharing of insurance information, which can be edited, in example embodiments, and can generate a transmission such as, e.g., but not limited to, a message, alert, notification, communication, email, text, SMS, MMS, etc., respectively, according to an example embodiment;

FIGS. 10A-10C (collectively referred to as FIG. 10) depict exemplary mobile device application exemplary graphical user interface screenshots of an example embodiment of an exemplary screen illustrating an exemplary embodiment of functions configured to all selective sharing, transmission, sending, confirmations, etc. of any selectable portion and/or all data to another user, such as, e.g., but not limited to, a care provider, health service provider, etc., respectively, according to an example embodiment;

FIGS. 11A-11C (FIGS. 11A-11H are collectively referred to as FIG. 11) depict exemplary mobile device application exemplary graphical user interface screenshots of an example embodiment of an exemplary screen illustrating an exemplary embodiment of functions configured to allow data sharing, which can be managed using my connections, in one embodiment, and can allow drilling down a view of a platform's profile manager, shared data can be identified, such as, e.g., but not limited to, by color such as, e.g., blue for information a first user is sharing, and green for information being shared by another or a second user with the first user, respectively, according to an example embodiment;

FIGS. 11D-11E depict exemplary mobile device application exemplary graphical user interface screenshots of an example embodiment of an exemplary screen illustrating an exemplary embodiment of functions configured to provide for display of an example blue connected icon on the My Connections module denoting a “Managed Profile” this is a profile established by the user to track information of another person, who may or may not share their information with the user, example profiles can be turned over to an individual in the future, e.g. a managed profile for a child that will be handed over when age 18, etc., e.g. a profile started for a family member to save the family member user the task of setup; example invitations can be sent to connect with users; unaccepted invitations can be noted as pending; family and friends can be tracked separately from other users so that genealogical/family history can be associated with the user; an example lack of a green or blue connection icon can denote that a history is neither shared nor managed; and the example system can be programmed to provide the user an opportunity to view the data such as, Susan is sharing “Shared Data of Susan” or the data the user has input about Susan e.g. “My Data for Susan”; this can be used, e.g., but not limited to, if a user did not trust the data being shared, for example, etc., respectively, according to an exemplary embodiment;

FIGS. 11F-11H depict exemplary mobile device application exemplary graphical user interface screenshots of an example embodiment of an exemplary screen illustrating an exemplary embodiment of functions configured to, if the user hasn't added data for the user or another user that the first user is managing, then the user can get what is shown in example FIG. 11F, or when a user is in another user's profile the system can be programmed to reveal, e.g., but not limited to, the picture, or image of the person and/or the screen can turn to a different color, for example, in this example (as illustrated in FIG. 11G and FIG. 11H) can be turned, e.g., but not limited to, green from blue, respectively, according to an exemplary embodiment;

FIGS. 12A-12D (collectively FIG. 12) depict exemplary mobile device application exemplary graphical user interface screenshots of an example embodiment of an exemplary screen illustrating an exemplary embodiment of functions configured to display for interactive access the screen shots illustrating example functionality of the Family tree system, methodology and a graphical user interface (GUI); shared and managed health profiles can be accessed through the GUI; example Tree profiles can change in relation to the user selected with GUI selection, e.g. if a user clicks on the wife of a first user, the screen will show her relationships in the tree in an example embodiment; the system can be programmed to know the relationship within the tree in an embodiment; the GUI can be programmed to, e.g., move up and down, and/or left to right, to show, e.g., parents and cousins, etc. as a user can see in a typical family tree schema, respectively, according to an exemplary embodiment;

FIGS. 13A-13B (collectively FIG. 13) depict exemplary mobile device application exemplary graphical user interface screenshots of an example embodiment of an exemplary screen illustrating an exemplary embodiment of functions configured to all a user to interactively select a mood, and to display that mood, and an example screen can display various choices and can be configured to allow receipt from a user selection of any of a plurality of mood indications that can be provided and can permit capturing further data about the user, such as, e.g., a user's mental health, etc., respectively, according to an exemplary embodiment;

FIG. 14A diagram (FIGS. 14A-14D, collectively referred to as FIG. 12) depicts an exemplary mobile device application exemplary graphical user interface screenshot of an example embodiment of an exemplary screen illustrating an exemplary embodiment of functions configured to illustrate example help (?) text such as, e.g., in this case, explaining what an example TEA is providing for analysis, transmission and providing of user—targeted personalized health guidance information, respectively, according to an exemplary embodiment;

FIGS. 14B-14C depict exemplary mobile device application exemplary graphical user interface screenshots of an example embodiment of an exemplary screen illustrating an exemplary embodiment of functions configured to allow display of, or access to, example TEA, e.g., but not limited to, TEA can be provided by an exemplary health information service provider, such as, e.g., but not limited to, an ICmed service provider, a healthcare marketer, a care provider, and/or other institutions, which can be seeking to promote information to constituents, such as, e.g., but not limited to, Target (sale on walkers), retailers, pharmacies, distributors, etc., and/or e.g. a drug company, pharmaceutical company, etc., may want to target, e.g., but not limited to, users having diabetes, etc.; information can be educational, and can include, e.g., a hypertext link universal resource location (URL) to an example website, further content, etc., for additional information; and can provide for a user to access additional content, by selecting a GUI indicator “Learn more” (e.g., at the bottom right of FIG. 14B), and can take a user to the example TEA promoter's website, and/or other content, such as, e.g., but not limited, video, etc., the link can also be inserted into an example personal health information social network wall such as, e.g., but not limited to, the Journal, of the example ICmed system, in one embodiment; the TEA can be archived (as illustrated, e.g., in FIG. 14C) for retrieval at a later date, according to an exemplary embodiment;

FIG. 14D depicts an exemplary mobile device application exemplary graphical user interface screenshot of an example embodiment of an exemplary screen illustrating an exemplary embodiment of functions configured to display, or permit access by a user to pushed data, that has been sent to users that the first user is managing, such as, e.g., but not limited to, an elderly person, a child, etc. (e.g. Lucy in screen shot FIG. 14D), according to an exemplary embodiment;

FIGS. 15A and 15B (collectively referred to as FIG. 15) depict exemplary database tables indicating an exemplary set of fields for targeting example content based on particular user personal health data, according to an exemplary embodiment. If (the example conditions on the right are true), then push the exemplary TEA content listed on the left columns, according to an exemplary embodiment;

FIG. 16 depicts an exemplary flow diagram of an exemplary flow chart illustrating an example of adding family member and relations and managed accounts users flowchart of the personal health information service provider system, according to an exemplary embodiment, according to an exemplary embodiment;

FIG. 17 depicts an exemplary flow diagram of an exemplary flow chart illustrating an example of a adding users and connections example flowchart of the personal health information service provider system, according to an exemplary embodiment;

FIG. 18 depicts an exemplary flow diagram of an exemplary flow chart illustrating an example of a selective sharing flowchart of the personal health information service provider system to users, with example selective sharing checks, and various example levels of granularity of information that can be shared, according to an exemplary embodiment;

FIG. 19 depicts an exemplary flow diagram 1900 of an exemplary flow chart illustrating an example of providing example targeted information TEA content from the personal health information service provider system to users, according to an exemplary embodiment;

FIG. 20 depicts an exemplary flow diagram of an exemplary flow chart illustrating an example of creating a managed account and inviting another user to the personal health information service provider system, according to an exemplary embodiment;

FIG. 21 depicts an exemplary flow diagram of an exemplary family tree connections flow chart, according to an exemplary embodiment;

FIGS. 22A and 22B depict and exemplary embodiment of a portion of a color screenshot illustrating a GUI element that can be used, in an embodiment to indicate an example of—a heart image placed in—between two profiles shows that the users are life partners, according to an exemplary embodiment;

FIG. 22C depicts and exemplary embodiment of a portion of a color screenshot illustrating a GUI element that can be used, in an embodiment to indicate an example of—a Connected Users—Green (Represented in Green colored fonts/icons ink or coloring on GUI), according to an exemplary embodiment;

FIG. 22D depicts and exemplary embodiment of a portion of a color screenshot illustrating a GUI element that can be used, in an embodiment to indicate an example of—a Pending Connection Invites—Grey (Represented in Grey colored fonts/icons ink or coloring on GUI), according to an exemplary embodiment;

FIG. 22E depicts and exemplary embodiment of a portion of a color screenshot illustrating a GUI element that can be used, in an embodiment to indicate an example of—a Managed Accounts—Blue (Represented in Blue colored fonts/icons ink or coloring on GUI), according to an exemplary embodiment;

FIG. 22F depicts and exemplary embodiment of a portion of a color screenshot illustrating a GUI element that can be used, in an embodiment to indicate an example of—a Deceased Person—Black Edge (Represented in Black colored fonts/icons ink or coloring on GUI), according to an exemplary embodiment;

FIG. 23 depicts an exemplary public service health news notification/communication/alert, etc., in this case from the US Department of Health and Human Services (HHS), according to an exemplary embodiment, according to an exemplary embodiment;

FIG. 24 depicts an exemplary diagram of an exemplary intelligent multi-tiered alerting subsystem, according to an exemplary embodiment, which can alert, e.g., a caregiver and/or family member(s) as a primary, and a healthcare provider, for example, as a secondary contact, according to an exemplary embodiment;

FIG. 25 depicts an exemplary diagram of an exemplary computer or communications system and/or device, according to an exemplary embodiment;

FIG. 26 depicts an exemplary diagram of an exemplary integrated health file cabinet system for a computer and/or communications system and/or device, according to an exemplary embodiment;

FIG. 27 depicts an example diagram of an example data warehouse of medical and clinical data, data architecture from a large medical clinic or hospital, depicted, for example, is a data warehouse that could be datamined and/or deep learning for an exemplary Mayo clinic enterprise data warehouse; exemplary rules databases, and rules engines, which can be used to mine the example data and to generate potential data that can be provided, via TEA content, to users, according to an exemplary embodiment;

FIG. 28 illustrates exemplary semantic relationships in epidemiology between classes extracted from relational databases and inference rules, according to one exemplary embodiment of an exemplary patient record of an exemplary clinic; patient record data, and any extracts from such can be imported into the system, according to one exemplary embodiment;

FIG. 29A depicts diagram 2900 illustrating an exemplary comparison of exemplary relational data model vs. an exemplary document data model, vs. an exemplary graph data model, according to one exemplary embodiment;

FIG. 29B depicts diagram 2910 illustrating an exemplary comparison of an ontology vs. a taxonomy, according to one exemplary embodiment;

FIG. 31 depicts diagram illustrating an exemplary screenshot of a mobile device with a touchscreen display and graphical user interface and showing an exemplary dashboard of an example individual medication and an exemplary ability to track refills, store images, schedule medication, history of compliance, medication facts and/or dosage strength history started, according to exemplary embodiment;

FIG. 32 depicts diagram illustrating an exemplary screenshot of a mobile device with a touchscreen display and graphical user interface and showing an example ability to track multiple medications for instance of non-compliance in order to track alerting, according to exemplary embodiment;

FIG. 33 depicts diagram illustrating an exemplary screenshot of a mobile device with a touchscreen display and graphical user interface and showing subsection of medication dashboard with “Take Now” button, that feeds notification system for medication compliance, according to exemplary embodiment;

FIG. 34 depicts diagram illustrating a an exemplary screenshot of a mobile device with a touchscreen display and graphical user interface and showing ability to edit frequency and add reminders, according to exemplary embodiment;

FIG. 35 depicts diagram illustrating an exemplary screenshot of a mobile device with a touchscreen display and graphical user interface and showing ability to denote form (tablet) and upload pictures of medication and medication labels, according to exemplary embodiment;

FIG. 36 depicts diagram illustrating an exemplary screenshot of a mobile device with a touchscreen display and graphical user interface and depicting Integrated Health File Cabinet example electronic file cabinet, according to an exemplary embodiment;

FIG. 37 depicts diagram illustrating an exemplary screenshot of a mobile device with a touchscreen display and graphical user interface and showing ability to create new user defined folders, according to exemplary embodiment;

FIG. 38 depicts diagram illustrating an exemplary screenshot of a mobile device with a touchscreen display and graphical user interface and showing area posting from a Connected Organization of the user, according to exemplary embodiment;

FIG. 39A depicts diagram illustrating an exemplary screenshot of a mobile device with a touchscreen display and graphical user interface and showing ability to share, and edit contents of electronic file folders, according to exemplary embodiment;

FIG. 39B depicts diagram illustrating an exemplary screenshot of a mobile device with a touchscreen display and graphical user interface and showing ability to leave comments on files stored in electronic file folders, according to exemplary embodiment;

FIG. 40 depicts diagram illustrating an exemplary screenshot of a mobile device with a touchscreen display and graphical user interface and showing example of Notification and ability for Connected Organizations to publish surveys 4002 to connected users, according to exemplary embodiment;

FIG. 41 depicts diagram illustrating an exemplary screenshot of a mobile device with a touchscreen display and graphical user interface and showing example of health survey designed by Connected Organization using the ICmed Enterprise (paid edition) platform, according to exemplary embodiment;

FIG. 42 depicts diagram illustrating an exemplary screenshot of a mobile device with a touchscreen display and graphical user interface and showing ability for users to access the ICmed system with QR codes according to exemplary embodiment;

FIG. 43 depicts diagram illustrating an exemplary screenshot of a mobile device with a touchscreen display and graphical user interface and showing ability for users to connect to Organization that provide them Organizational Codes, according to exemplary embodiment;

FIG. 44 depicts diagram illustrating an exemplary screenshot of a mobile device with a touchscreen display and graphical user interface and showing ability for users to connect to other devices that track health data, according to exemplary embodiment;

FIG. 45 depicts diagram illustrating an exemplary screenshot of a mobile device with a touchscreen display and graphical user interface and showing notifications dashboard and ability to manage connection requests, notifications of changes to shared profiles, and ability to receive surveys from connected organizations, according to exemplary embodiment;

FIG. 46 depicts diagram illustrating and showing connections dashboard, and ability to manage connections with Family, Friends and Caregivers, according to exemplary embodiment, depicting, for example, an exemplary user interface for sharing data with other user contacts of a given user, such as, organizations, caregivers, employers, loved ones, family members, etc., according to an exemplary embodiment.

### DETAILED DESCRIPTION OF EXEMPLARY EMBODIMENTS OF THE INVENTION

Various exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

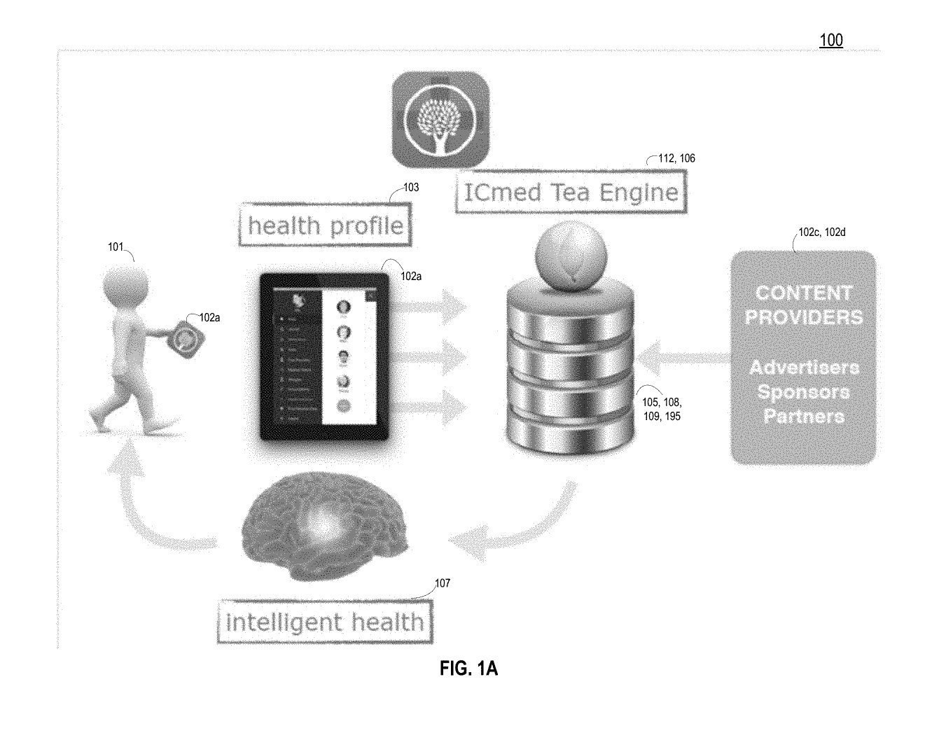

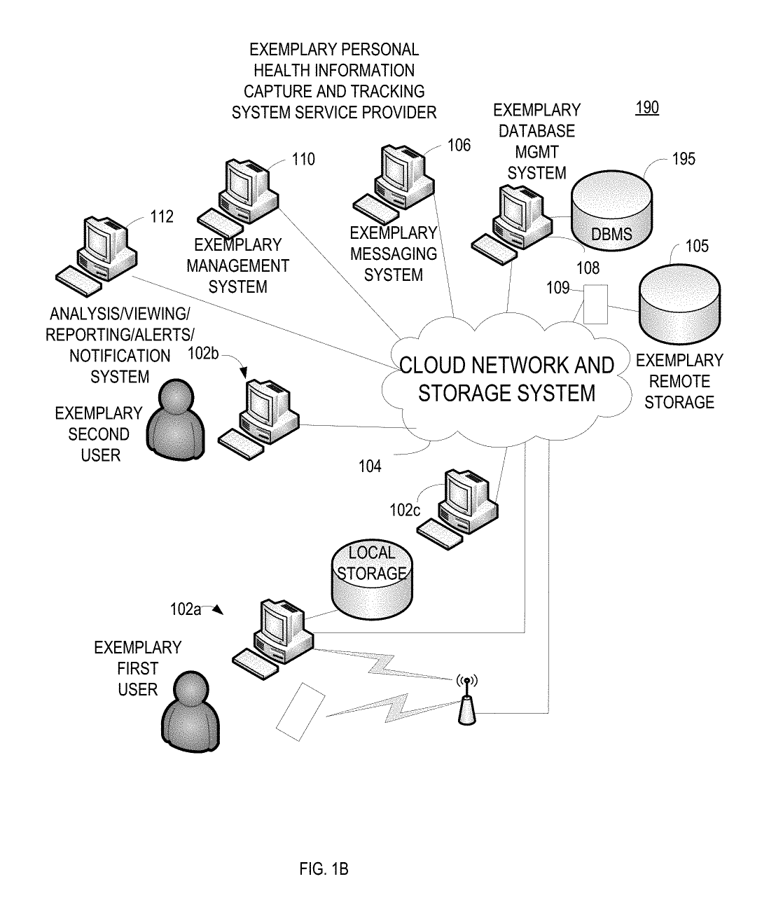

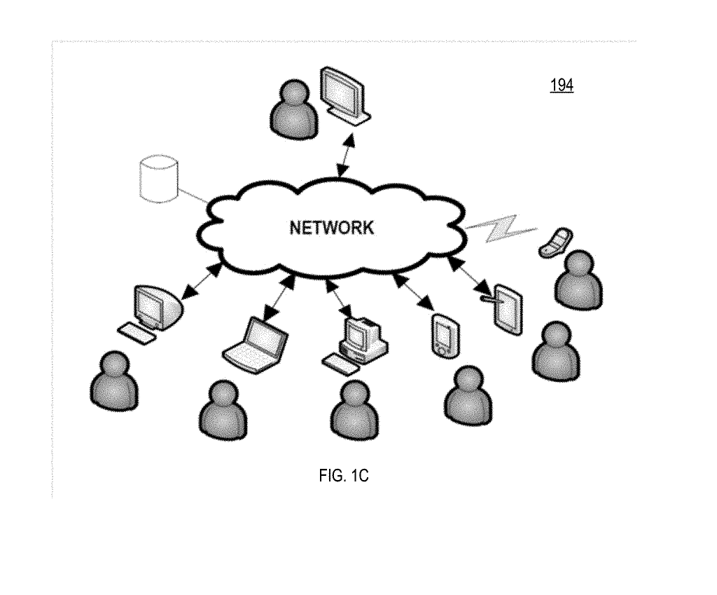

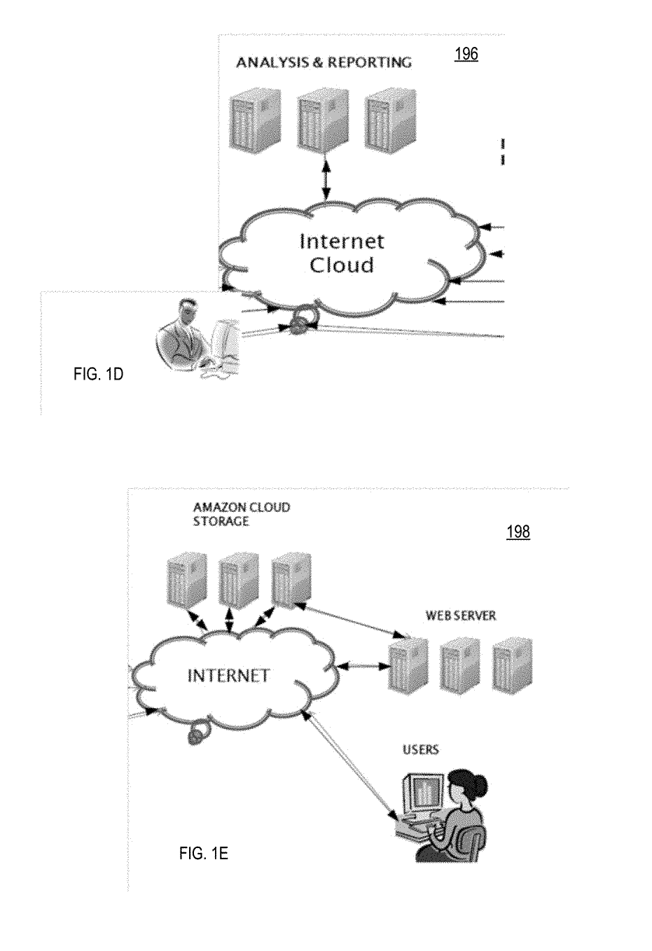

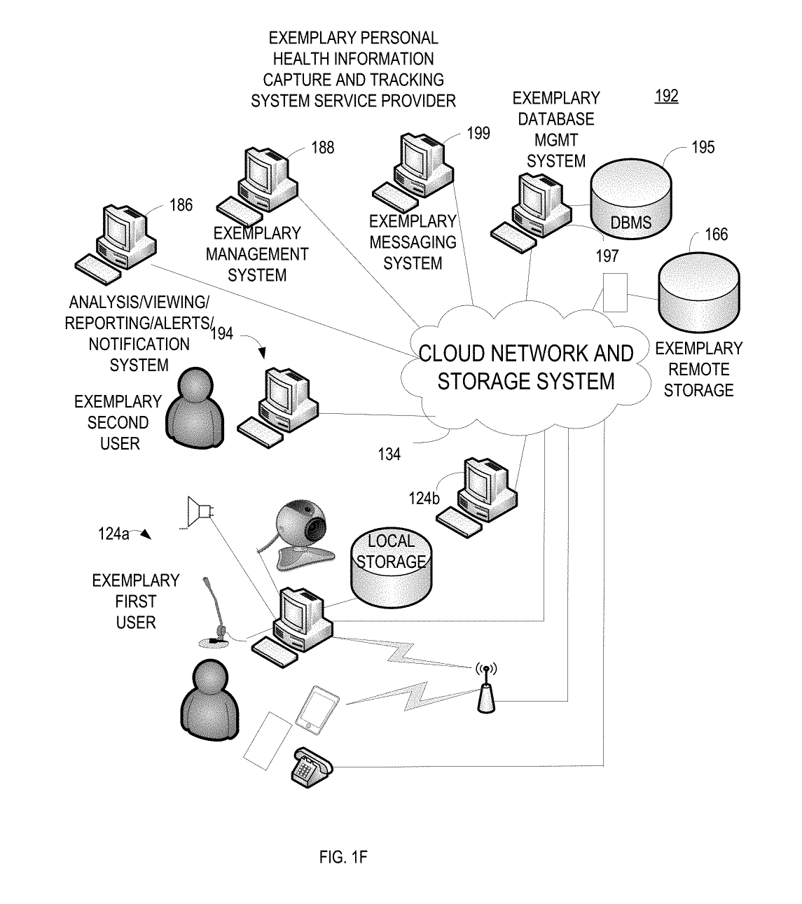

FIG. 1A depicts exemplary high-level elements of an exemplary embodiment of the exemplary system 100, according to an exemplary embodiment. FIG. 1A depicts exemplary high-level elements of an exemplary embodiment of the exemplary system 100 including a user 101 with an exemplary ICmed mobile device 102a, which can include a mobile device including wireless communications capabilities (e.g., Wi-Fi, or the like) and preferably at least a touchsensitive screen, and/or integrated camera sensing device, as well as other sensors, and including a health profile 103 subsystem, an intelligent health subsystem 107 including automated analysis, intelligence, data mining and/or including deep learning processing, data stores 105, 108, 109, and 195, an ICmed Tea Engine 106, 112 and content provider subsystems 102c, 102d, which can include, advertisers, sponsors, partners, organizations, etc., according to an exemplary embodiment;

FIG. 1B depicts an exemplary diagram 190 illustrating several exemplary high-level elements of an exemplary embodiment of an exemplary client server, networked and/or mobile device embodiment, of the exemplary system including an exemplary first user having a first user device, an exemplary second user and user device, where the second user can be an individual or organization, an analysis, viewing, reporting, alerting, notification subsystem 112, an exemplary management and/or organization and/or parent management subsystem, an exemplary notification and/or messaging subsystem and/or a database subsystem, according to an exemplary embodiment.

According to an exemplary embodiment, a mobile device app executing on a mobile device having at least one computer processor (e.g., but not limited to, central processing unit (CPU), graphics processing unit (GPU), Controller, Microcontroller, System on a Chip (SOC), multi-core, multi-processor, pipelined, CISC or RISC or POWER, supercomputer, massively parallel processing, Quantum computer processor, etc.), at least one memory storage device, and at least one interactive touchscreen display (touch sensitive, and/or proximity sensing, multitouch, etc.), providing for health information capture of a personal health history including health data captured along with a time period, and preserving an archive of past captured data into a health data database (e.g., but not limited to, relational, hierarchical, and/or graph, etc.) and providing at least one of: a) a targeted educational assistance (TEA) engine; b) a selective share ability to share at least a portion of the personal health history to other users, c) a family tree graphical user interface depiction enabling interactive access to members of a family tree, and to the stored personal health data of the members of the family tree, d) a health journal social network wall of personal health data posts by users of the system including data of a person captured or received, as well as of data of others connected to or shared with the person, or managed by the person on behalf of another person, e) a medications interface to track and systematically notify connected interested parties of adherence to medication plans and f) a digital file cabinet enabling file storage, sharing and alerting to second person users in which the first person user approves access and/or notifications.

According to an exemplary embodiment, an exemplary system can provide “selective sharing of health data.” Embodiments of the computing device can deliver to mobile devices and/or computing devices, such as, e.g., but not limited to, personal computers (PCs), or the like data via an application program, and/or browser-based application. Exemplary personal health care data can be delivered to a PC and/or mobile based technology device via a communications data network, and the data can be stored in an exemplary remote computing device cloud based system, and the data can be shared by both mobile and/or PC based access systems.

According to one exemplary embodiment, exemplar personal health data of one or more users can be shared with exemplary health care providers, according to one exemplary embodiment, by first having the user personal health data information be de-identified, when shared, and can also be shared with organizations wanting to message their constituents (such as, e.g., but not limited to, employees, members), disease organizations, and/or retailers.

According to one exemplary embodiment, another feature of the claimed invention can include an exemplary health journal, akin to a social network wall, or personal health data posting news feed of personal health posts by users, and posting shared data from users having provided selective shares of at least a portion of the user's health data, similar to a social network feed, like Facebook and/or Twitter, and allowing for users to provide indications of approval, likes, disapprovals, or other reactions, or the like, and/or advantageously an ICARE™ indication (a trademark of ICmed) and can, according to one exemplary embodiment, provide for, e.g., but not limited to, a narrative, pictures, images, video, other posted content, web pages, syndicated content, RSS feeds, etc., selective sharing with other ICmed members, the ICARE button for liking posts, a section describing a messaging portal that healthcare providers and others can communicate, via video chat, texting and uploads.

According to one exemplary embodiment, portions can be provided in-house by a computing service provider, and portions can be provided by partner service providers, to which the exemplary service provider can provide access through its computing platform, via one or more APIs.

FIG. 1C depicts an exemplary view of an exemplary embodiment of an exemplary distributed user environment using a plurality of computing and communication devices coupled together in a distributed networked system architecture 194.

FIG. 1D depicts an exemplary embodiment of an activity receiving input, or receiving capture of personal health information, analyzing and processing the information, providing, displaying, transmitting and/or delivering the information via a computer and communications system architecture 198, which can be a client server architecture, a peer-to-peer architecture, and/or other computer architecture, according to an exemplary embodiment coupled together by an exemplary cloud-based architecture wireless less, and/or wireline, communications network(such as, e.g., but not limited to, a packet switched, and/or ATM, wire and/or coax cable, and/or optical fiber network).

FIG. 1E depicts an exemplary embodiment of a system 198 illustrating an exemplary user system that may include various content capture devices (not shown), in an exemplary embodiment, a mobile device, a microphone, screen and/or webcam can be coupled to an example system computing and/or communications device to capture and/or deliver the data content from a first user computer system over an exemplary cloud metaphor, communications network such as the Internet (or an internet, and/or intranet, and/or extranet) to exemplary cloud-based and/or other network accessible storage, and may perform further processing and/or analyzing of data, and information, on various exemplary webservers and/or application servers, and for providing access to the analyzed content by the first and/or other users such as, e.g., but not limited to, care providers, and/or others to which the information may be shared, according to an exemplary embodiment, and all may be coupled together, as illustrated, by an exemplary cloud-based architecture network.

FIG. 1F depicts an exemplary embodiment of an exemplary system 192 illustrating an exemplary distributed user activity recording system for capturing user activity and/or personal health information of an exemplary user, whose computer system, and/or mobile device system 124a is coupled to an exemplary cloud-based network and storage system 134, itself coupled to exemplary remote storage 166 and/or, database 195, and/or an exemplary database management (DBMS) application system 197, an exemplary messaging system 199, an exemplary management system 198, and an exemplary analysis/viewing/reporting/alerts/notification system 196, as could be used by another exemplary user device 194 to permit receipt, display, and review and communicate with member user devices 124a, 124b, according to an exemplary embodiment.

Various exemplary, but non-limiting High-Level Elements of an exemplary embodiment of the exemplary system 190, according to an exemplary embodiment, are shown in FIG. 1B. The elements may include, in an exemplary embodiment an exemplary user data/information collection component 102, an exemplary cloud/network 104 storage system facility 105, an exemplary message processing system 106, an exemplary database server 108, an exemplary remote management system 110 and an exemplary Analysis/Viewing/Reporting/Alerts/Notifications system 112. In an exemplary embodiment, an exemplary first user device 102a may use an exemplary collection device such as, e.g., but not limited to, a personal computer (PC) or a mobile device, smartphone, communications device, computing device, etc., to capture information about the first user's personal health information, and may, according to example embodiments selectively share the personal health information with other second user devices 102b. Examples of second users can include family, friends, relatives, children, guardians, parents, children, etc., providers such as, e.g., but not limited to, care providers, health care service providers, data content providers, advertisers, marketers and various other users can have access through the system, such as, e.g., but not limited to, via device 102c. In an exemplary embodiment, an exemplary user 112a may use an exemplary viewing device 112a to access exemplary analyzed and stored interaction content at an exemplary other user level.

### Exemplary User Data/Information Collection Component 102:

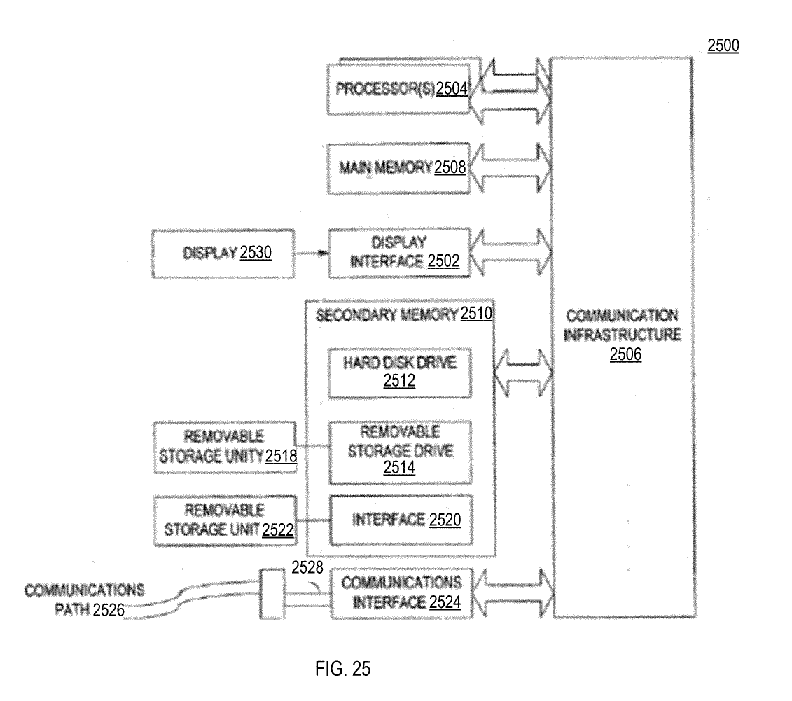

An exemplary computer system platform executing an exemplary software application program, which may reside, in an exemplary embodiment, on a first user's exemplary first computing device 102 may include, but is not limited to, a computing (see FIG. 25, for example) or communications device, desktop/laptop computers, tablet computers, personal digital assistant, telephony, smart-phone, mobile device, tablet, personal digital assistant, handheld and the like, which may in an exemplary embodiment, be responsible for collecting exemplary data/information from the user and the user's computing device relating to an interaction with an exemplary customer, or the like. An exemplary personal health data/information collection process can be configured to be automated, periodic, user initiated or any combination thereof to capture personal health data and to send such data received to the cloud computing devices for storage and later access via, e.g., but not limited to, selectively shared access by one or more second users granted access to a first user's data, according to an exemplary embodiment. According to an exemplary embodiment, the version of the software program, which may be named an exemplary ICmed, in an exemplary embodiment, available from ICmed, LLC of Baltimore, Md., USA, may be displayed on a user's computing/communications device 102 as shown in FIGS. 1A-1F, below, according to exemplary embodiments. In an exemplary embodiment, the exemplary ICmed app may be a browser based application, or a PC or mobile device based application such as, e.g., but not limited to an iOS app and/or an Android App. In another exemplary embodiment, the toolbar may be an applet, or other application program that may be provided in any of various well known ways, such as, e.g., but not limited to, an Internet browser-based toolbar, a JAVA applet, an ANDROID Application, an iPOD or iPAD application running on an iOS operating system, or other operating system such as Mac OSX from Apple and/or Microsoft Windows 10, or the like, etc.

### Exemplary Cloud/Network Storage Facility 104, 114

According to an exemplary embodiment an exemplary cloud/network storage facility 104, 114, may allow, e.g., but not limited to, direct up-load of data from user computing devices 102. According to an exemplary embodiment, many exemplary commercial cloud service providers may be used such as, e.g., but not limited to, Amazon, Rackspace, Microsoft and/or many others as will be apparent to those skilled in the art, offer such capabilities.

### Exemplary Message Processing System 106 and Exemplary Database Management System Server 108

According to an exemplary embodiment, an exemplary cloud/network based application server which may receive messages, containing metadata, from the user data collection software FIG. 1, can read data from user devices and can update the database of FIG. 1 with personal health information about the users in data elements being stored in the cloud/network storage facility. An exemplary relational database system, an SQL database, a NoSQL database, and/or a Graph Database, etc. can be used to implement embodiments of the claimed inventions. Exemplary application systems can include discrete applications and may incorporate situational awareness. Exemplary systems may include the use of monolithic, or incremental algorithms, as well as separate and/or coupled logical and/or numerical algorithms. Graph libraries may be incorporated to allow access to both graph experts and subject-matter experts, graph primitives may include, e.g., but not limited to, an exemplary static graph and/or a dynamic graph system. Exemplary use of exemplary Big Data Analytics can be used to accelerate performance of transaction processing, and can allow customized data notifications generated through the use of extensive infrastructure and/or runtimes, as may include large-scale data processing in centralized and/or distributed systems, via, e.g., parallel processing with or without writing of parallel code such as, e.g., but not limited to, via message passing interface (MPI) and/or other inter-process communication, and/or MapReduce programming model, and/or Graph-specific. In certain exemplary embodiments, backend systems may take advantage of not only mass-market hardware, and any of various graph database subsystems, but may also include graph-specific hardware systems for increased performance benefits and scaleability. Data may be organized in any of various exemplary data models including, e.g., but not limited to, relational, document and/or graph data models, and data can be organized in Taxonomies and/or in Ontologies, as illustrated in FIG. 29B.

### Exemplary Analysis/Viewing/Reporting/Alerts System 112

According to an exemplary embodiment, the exemplary data elements/content personal health data collected from the user data collection software system 102, may be processed, including, e.g., but not limited to, being made available for, e.g., but not limited to, exemplary analysis, exemplary selective sharing, for viewing by those granted selective access via an exemplary health journal social networking wall with social network posts and/or news feed, and exemplary reporting and/or exemplary managing of transmission of exemplary TEA notifications and/or alerts in the exemplary system 112.

Various Exemplary screenshot captures of an exemplary system implementing an exemplary embodiment of the claimed invention are now set forth below.

FIG. 1A depicts an exemplary embodiment of a TEA Engine System block diagram, according to an exemplary embodiment.

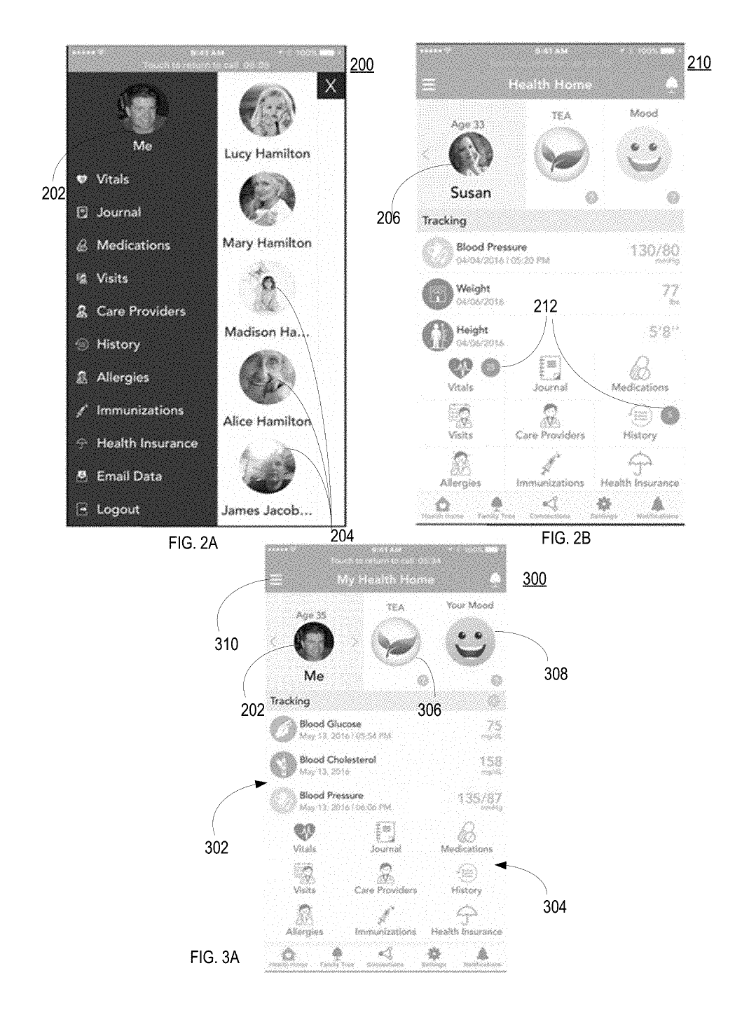

FIG. 2A depicts an exemplary mobile device application exemplary graphical user interface screenshot 200 of an exemplary first user 202, having a plurality of exemplary second user 204 connections, according to an exemplary embodiment.

FIG. 2B depicts an exemplary mobile device application exemplary graphical user interface screenshot 210 of an exemplary second user 206, illustrating exemplary orange circle graphical user interface (GUI) elements 212, indicating exemplary unread messages, e.g., for vitals, and history, according to an exemplary embodiment.

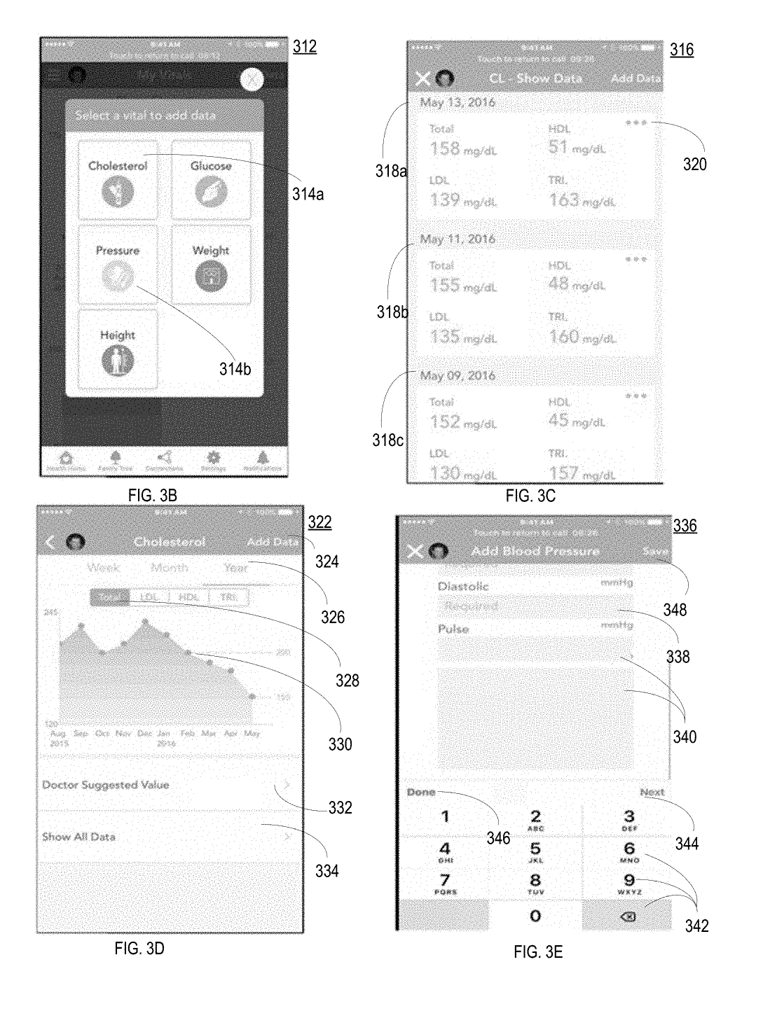

FIG. 3A depicts an exemplary mobile device application exemplary graphical user interface screenshot 300 of the exemplary first user 202, illustrating an exemplary health home screen, according to an exemplary embodiment; the home health screen programmed so that views of tracking vitals and health modules can be customizable, according to an exemplary embodiment. FIG. 3A as shown illustrates various exemplary icons 304, an exemplary TEA indicator 306, and an example mood indication 308, as well as an exemplary back button 310, in one exemplary embodiment.

FIG. 3B depicts an exemplary mobile device application exemplary graphical user interface screenshot 312 of an example embodiment of a vitals menu, concise view of options allowing the user to interactively add data for a selectable vital, according to an exemplary embodiment. For example, an example cholesterol vital 314a, an example blood pressure vital 314b, can be selected by a user selecting an example rectangular GUI element, as illustrated. In one exemplary embodiment, selection by the user of the cholesterol vital 314a can be received by the system, and can allow the system to capture additional data about the user's cholesterol and can then allow analysis and/or display for the user of a display screen with further example interactive information about the user's cholesterol, such as, e.g., but not limited to, screenshot 322, or 316. In one exemplary embodiment, selection by the user of the blood pressure vital 314b can allow the system to capture additional data about the user's blood pressure, such as, e.g., but not limited to, as shown in screenshot 322, or 316 and can then allow analysis and/or display for the user of the data received by the system, and can display for the user a screen with further information about the user's blood pressure.

FIG. 3C depicts an exemplary mobile device application exemplary graphical user interface screenshot 316 of an example embodiment of a display of an example cholesterol (CL) vitals data screen illustrating an example history of data including cholesterol data 318a-c of three example dates, allowing the user to view and have the functionality to be able to share at this example level of granularity example vitals data with a second user of the system, according to an exemplary embodiment. As shown, further data can be accessed by clicking on a “. . . ” ellipsis GUI element 320.

FIG. 3D depicts an exemplary mobile device application exemplary graphical user interface screenshot 322 of an example embodiment of an additional display of further example cholesterol (CL) vitals data screen illustrating an example graph 330 of the history of data including cholesterol data 318a-c of the various example dates, allowing viewing by a time period 326, such as, e.g., but not limited to, a week, month, year, etc., as well as ability to select total cholesterol 328, or any subsets (LDL, HDL, TRL), for any of various selectable date ranges 326, and allowing the user to use a menu selection 332 to capture a doctor suggested value, or to select to show all data 334, according to an exemplary embodiment. From show all data, in an exemplary embodiment, the user can be taken to screenshot 316. As shown, further data can be added by clicking on add data 324. An exemplary system can allow for receiving into the system, example doctor suggested values 150 and 200, and can be configured to graph in an example line chart displaying the doctor suggested values of between 150 and 200 on the graph, along with actual observed, captured historical cholesterol values, providing an example benchmark for the captured vitals data, in one example embodiment.

FIG. 3E depicts exemplary mobile device application exemplary graphical user interface screenshot 336 of an example embodiment of an additional display of further example blood pressure vitals data input screen, illustrating an example interface as can be obtained when GUI element 314b in FIG. 3B is selected to bring the user to screen 336 for entry of required data fields 338, or optional data fields 340, using exemplary data entry keys 342, which can be numeric, and/or alphanumeric, and can enable jumping from field to field of the data record by selection user interface element 344, until done 346 can remove the keyboard of keys 342, and the record can be saved with save GUI element 348, according to an exemplary embodiment. The exemplary screen 336 can receive input of captured data, can receive manually entered data via a user interface as illustrated, and/or can be synced electronically or otherwise with a 3rd party device or system user interface and/or application programming interface (API).

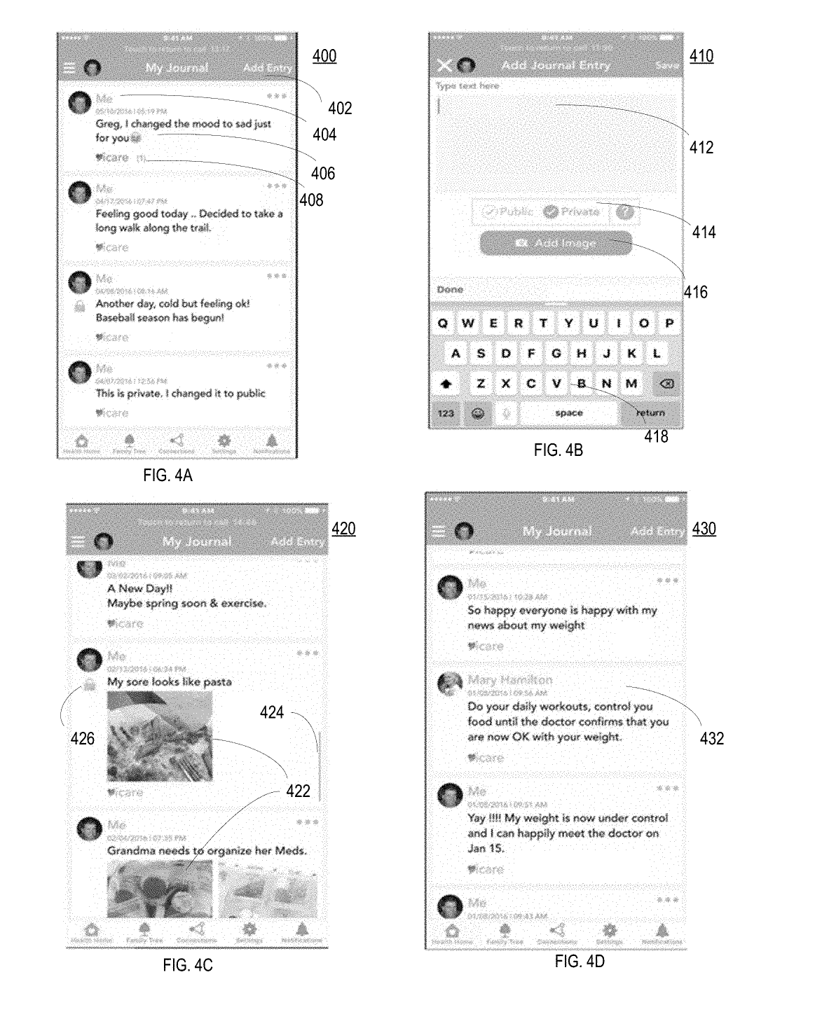

FIG. 4A depicts exemplary mobile device application exemplary graphical user interface screenshot 400 of an example embodiment of an exemplary My Journal user health journal providing an online electronic social network wall for postings of personal health information record data, allowing for receiving a new entry by the add entry GUI element 402, and for posting online social network wall posts of exemplary text and/or emoji 406 from a posting user 404, such as yourself, and/or showing posts of other users 432 as shown below with reference to FIG. 4D, who have selectively shared access to a post to the user of the health journal, and a user can react to the post by providing an indication reaction such as, e.g., but not limited to, an example icare indicator, a like indicator, and/or any other exemplary indication of reaction to the social network post, according to an embodiment where posts are in exemplary reverse chronological order, illustrating an example scrollable wall, according to an exemplary embodiment. According to an exemplary embodiment, an indication of a care with an exemplary heart and hand (icon) can provide a user of the system to indicate a way to show acknowledgement or other indication of reaction to the exemplary post. According to an exemplary embodiment, example text posts can be received by the system by receiving an add entry 402 selection, which can display an interface as shown in FIG. 4B, and may received typed textual data, and/or received data by voice recognition, and/or image content (see FIG. 4C for further details) such as pictures and/or video content data can be uploaded as also illustrated in FIG. 4B.

FIG. 4B depicts exemplary mobile device application exemplary graphical user interface screenshot 410 of an example embodiment of an exemplary screen illustrating an interactive display to add a post to the My Journal user health journal 400 shown in FIG. 4A, providing an interface to receive entry of an electronic post, which may include text 412 fields, security indication 414, help (?) buttons, image and/or video content upload 416 (discussed further below with reference to FIG. 4C), and an exemplary alphanumeric keyboard 418 can be provided to allow receipt of entered data by the exemplary system, which can automatically post to the online electronic social network wall 400 of the user, and advantageously of other users, that the posting user has granted selectable sharing access to the inputted or captured data content post, according to an exemplary embodiment.

FIG. 4C depicts an exemplary mobile device application exemplary graphical user interface screenshot 420 of an example embodiment of an exemplary screen illustrating an exemplary embodiment of the health journal illustrating various example image content 422 posts, as could been received using an interface as discussed above with reference to FIG. 4B, as well as illustrating an exemplary scroll indicator 424 indicating additional posts can be viewed by scrolling upward or downward, in this case, to view additional social media wall posts of the personal health information data, according to an exemplary embodiment. A lock 426 shows post can indicate that a post is private, i.e., that the health journal personal health information post is not public, according to an exemplary embodiment.

FIG. 4D depicts an exemplary mobile device application exemplary graphical user interface screenshot 430 of an example embodiment of an exemplary screen illustrating an exemplary embodiment of the health journal illustrating another user's online social media health journal wall post 432 of an example user Mary Hamilton, who has previously selectively shared her information with the user whose health journal is displayed, according to an exemplary embodiment. According to one exemplary embodiment, a shared journal entry cannot be edited (i.e., as depicted with exemplary shared user Mary Hamilton, it is important to note that the three dot ellipsis edit menu is not available for the user to which Hamilton has shared her data).

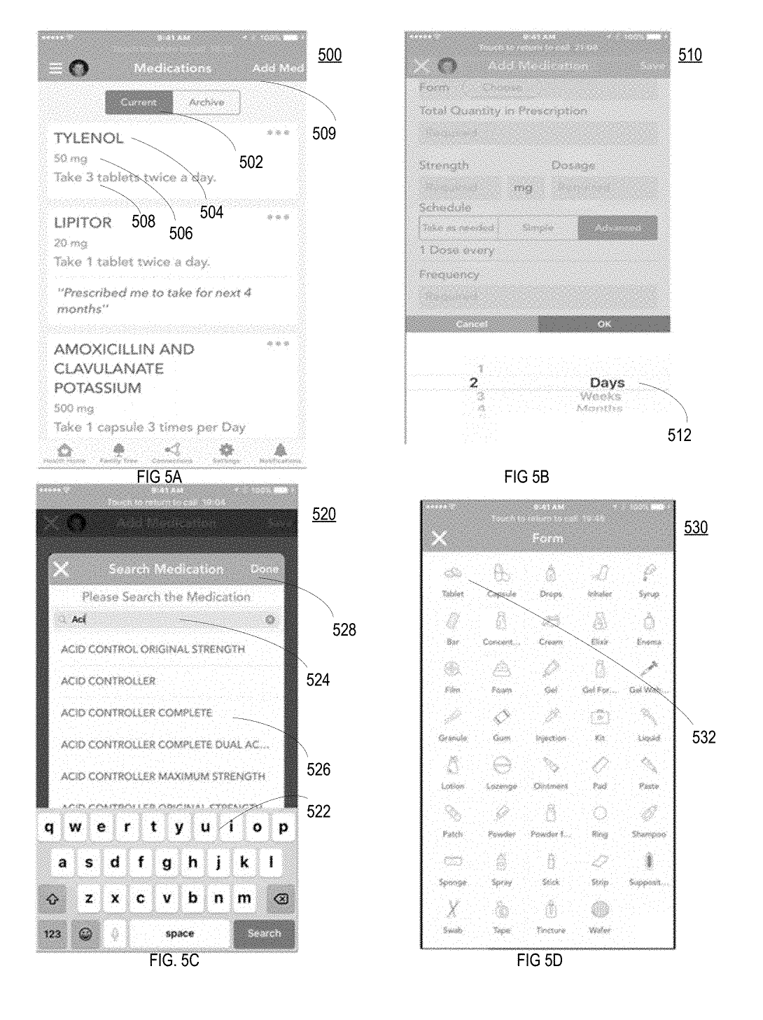

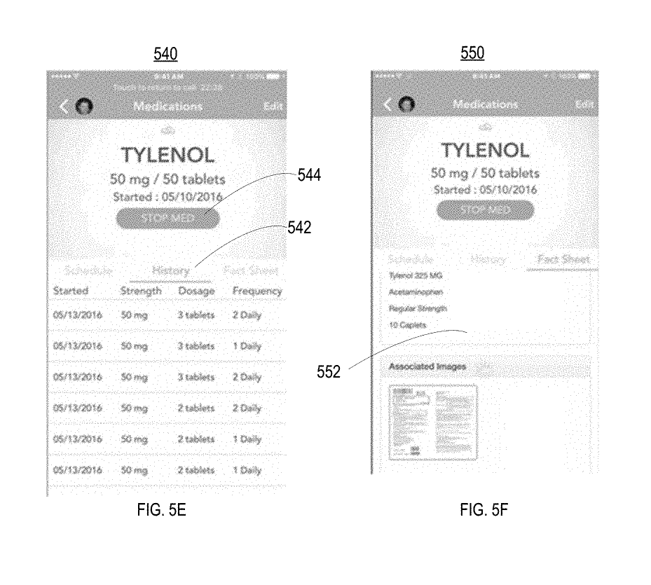

FIG. 5A depicts an exemplary mobile device application exemplary graphical user interface screenshot 500 of an example embodiment of an exemplary screen illustrating an exemplary embodiment of an exemplary medications display page illustrating a personal health information medication post, according to an exemplary embodiment. According to an example embodiment, a new medicine can be added using add med GUI element 509, and current meds 502, or archived meds can be accessed, including information such as the medicine name 504, a strength 504, which can be shown in milligrams, for example, a dosage 508, i.e., the amount of tablets to be taken, and a schedule such as, e.g., but not limited to, a frequency, in this case, twice a day, and number of tablets, i.e., 3 tablets in this case. The exemplary embodiment shows current and archived medications, and provides the ability to add dosing reminders, by selecting add med 509, a screen as shown and discussed below with reference to FIG. 5B.

FIG. 5B depicts an exemplary mobile device application exemplary graphical user interface screenshot 510 of an example embodiment of an exemplary screen illustrating an exemplary embodiment of an exemplary add medication data entry GUI page illustrating an interface to receive entry of personal health information medication data posts, including a medication interactive selection form allowing entry and receipt into the system of a total quantity in a prescription, a strength to be received, a strength measurement, a dosage, a schedule, a simple or advanced dosage description capture, a frequency selector 512 of donation, and a size of a dose, according to an exemplary embodiment. According to an exemplary embodiment, a capability can be provided to schedule an advanced dosage instruction.

FIG. 5C depicts an exemplary mobile device application exemplary graphical user interface screenshot 520 of an example embodiment of an exemplary screen illustrating an exemplary embodiment of an exemplary search medication query GUI page illustrating an interface to receive entry of a text based search 524 using an exemplary alphanumeric keyboard 522 to receive a query into field 524, and as the search terms of the query are entered, automatically, a list of potential medications fitting the search query 526 can be displayed as the user continues to use the keyboard 522 to enter characters into the search field 524, according to an exemplary embodiment. Various embodiments provide connectivity to an application programming interface (API) for automated population of medication facts associated with the search query results.

FIG. 5D depicts an exemplary mobile device application exemplary graphical user interface screenshot 530 of an example embodiment of an exemplary screen illustrating an exemplary embodiment of an exemplary form GUI page allowing user selection based receipt by the system of selection of an picture representing the form (tablet 532, capsule, drops, inhaler, etc.) of the medicine. Form provides added instruction and confirmation of dosage type, according to an exemplary embodiment.

FIG. 5E diagram 540, and FIG. 5F diagram 550, depict exemplary mobile device application exemplary graphical user interface screenshots 540, 550, of an example embodiment of an exemplary screen illustrating an exemplary embodiment of an exemplary GUI page illustrating retaining history, a stop button to remove medication from a current list and to move to archive, and a system programmed to show an example NIH fact sheet, respectively, in one embodiment.

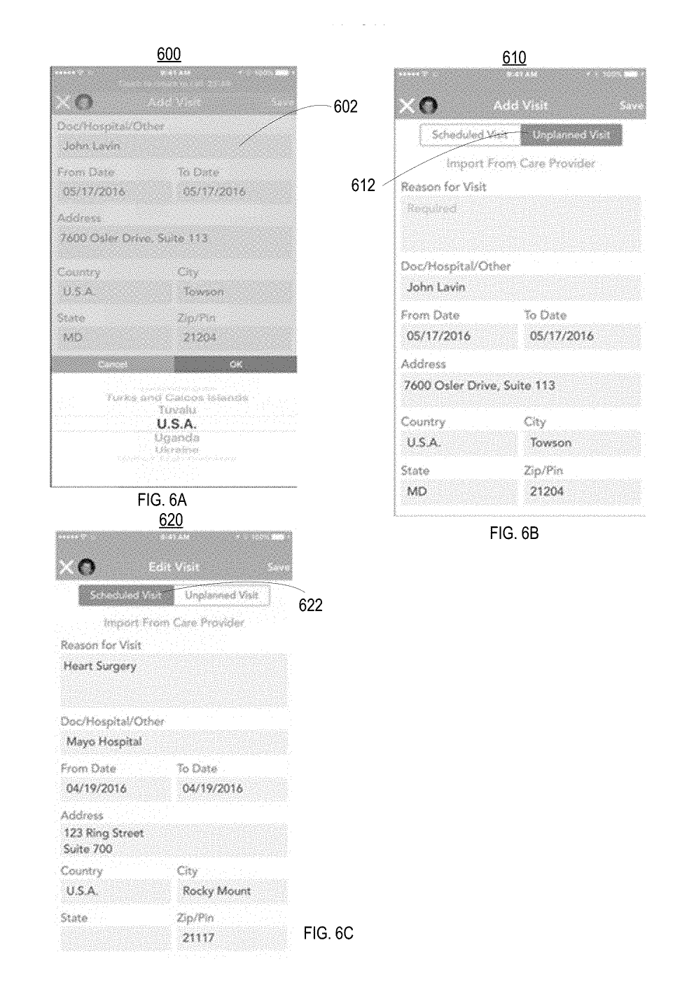

FIG. 6A diagram 600, FIG. 6B diagram 610, and FIG. 6C diagram 620, depict exemplary mobile device application exemplary graphical user interface screenshots of an example embodiment of an exemplary screen illustrating an exemplary embodiment of a screen 600 illustrating entry of information about a visit, which may include care provider information being automatically imported from a care provider module, a screen illustrating adding a visit, tracking unplanned visits separately from planned visits, and allowing edit of visit information, respectively, in one embodiment. FIG. 6B shows an unplanned visit 610, in one example embodiment FIG. 6C shows an example of a planned visit 620, in another example embodiment.

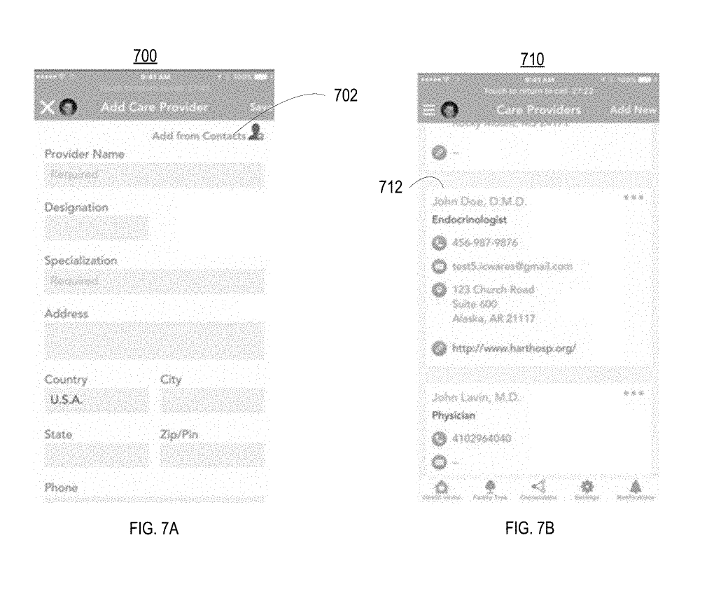

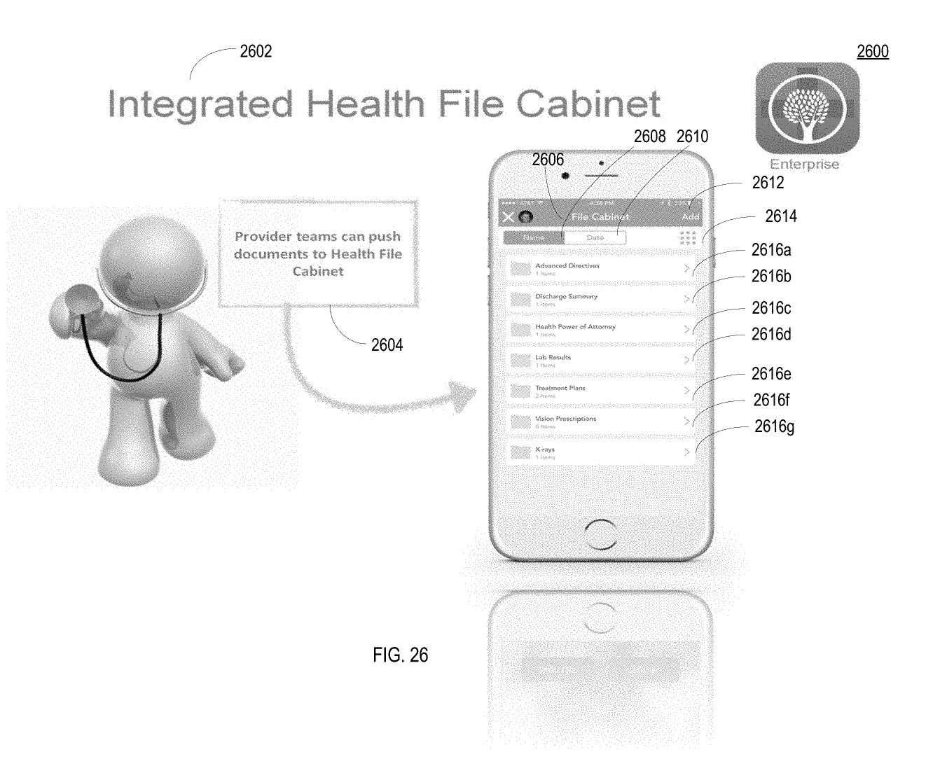

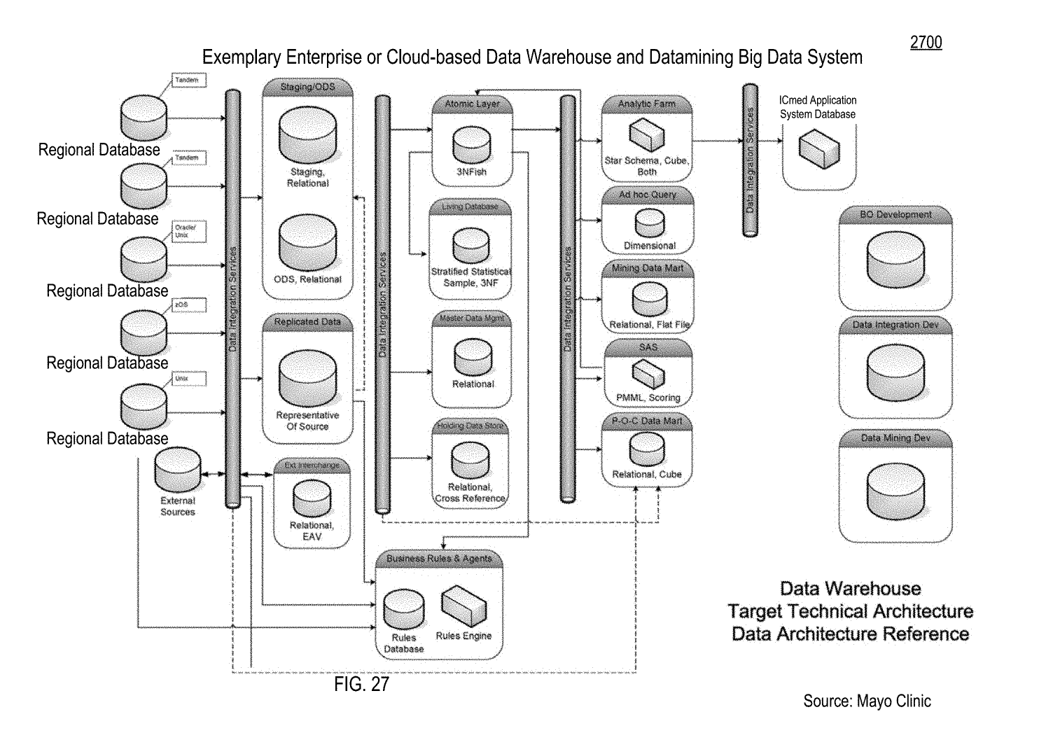

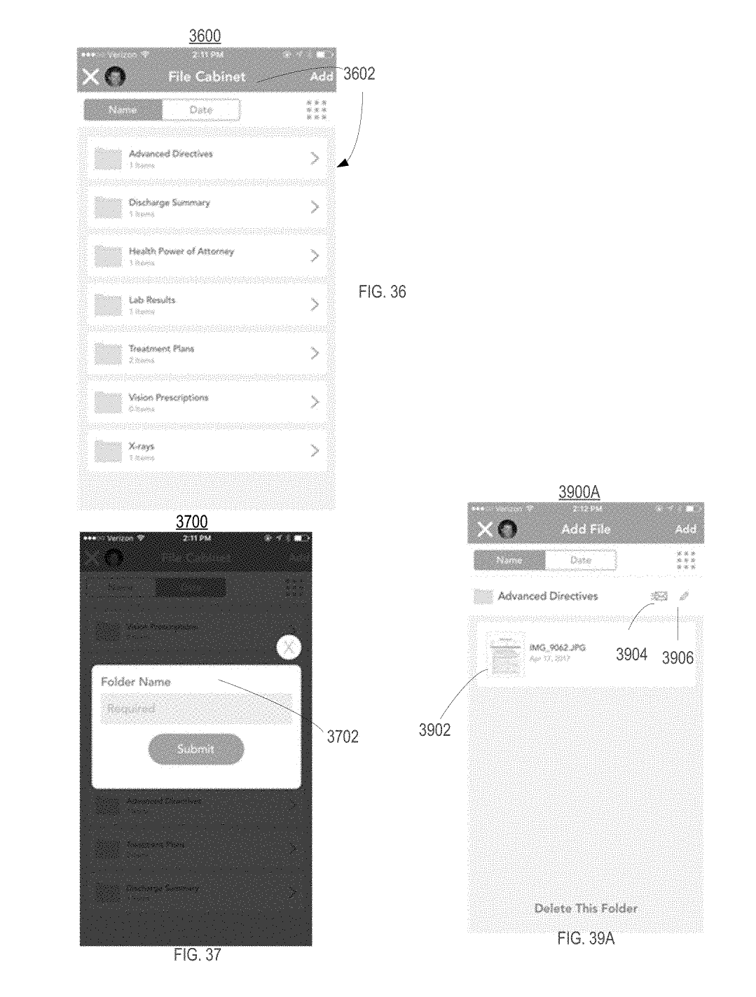

As illustrated and described below with reference to FIGS. 7, 8, 9, 11, 15-21, an exemplary electronic file cabinet 2600, described further below with reference to FIG. 26, can be provided for capturing and organizing, e.g., electronically various medical data records, according to an exemplary embodiment. In an exemplary embodiment, the electronic file cabinet can synchronize automatically across different platforms and across multiple user devices. See FIG. 26 and FIG. 36, for example, with respect to an example electronic file cabinet. According to an exemplary embodiment, various documents can be organized hierarchically, or in a file folder and file metaphor, being organized by exemplary topics such as, e.g., but not limited to, Advanced Directives 2616a, Discharge Summaries 2616b, Health Power of Attorney 2616c, and/or a Durable Power of Attorney, Will, Living Trust, Treatment Plans 2616e, X-Rays/Catscans/MRI 2616g, Vision Prescriptions 2616f; Medication Prescriptions; Lab Results 2616d, dental records, specialist referrals, scanned or electronic medical records (EMR), second opinions, a user created folder, category, or file, etc. The system is configured to allow the user to add customer notes, and or review or delete data, import or add data from outside sources such as, e.g., but not limited to, a Google Drive, a Dropbox, a Docs folder, email, etc., and the data can be provided electronically, and/or by printer, and/or sent to others via, e.g., but not limited to, wireless transmission, electronic transmission, Near field communication, Wi-Fi, BLUETOOTH, electronic mail, SMS, MMS, blockchain, etc.

FIG. 7A diagram 700, and FIG. 7B diagram 710 (collectively referred to as FIG. 7) depicting exemplary mobile device application exemplary graphical user interface screenshots of an example embodiment of an exemplary screen illustrating an exemplary embodiment of where care providers can be imported automatically from contacts, or can also be captured through automated electronic data retrieval from, e.g., but not limited to, third party data providers, email service providers, social networks, etc., respectively, in one embodiment.

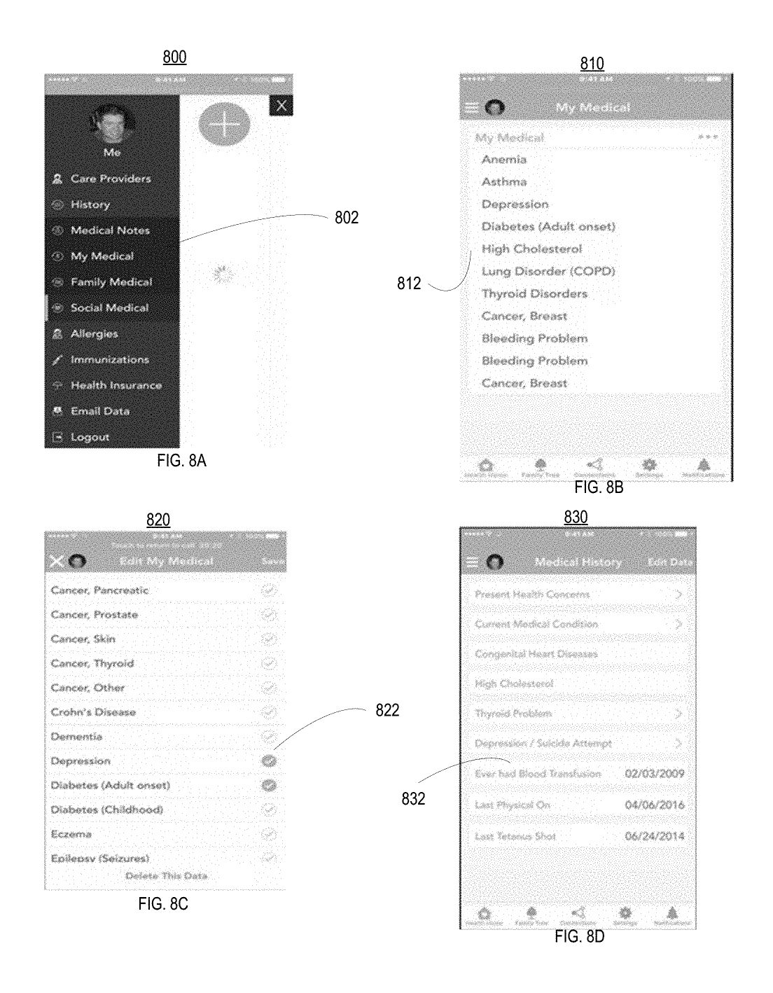

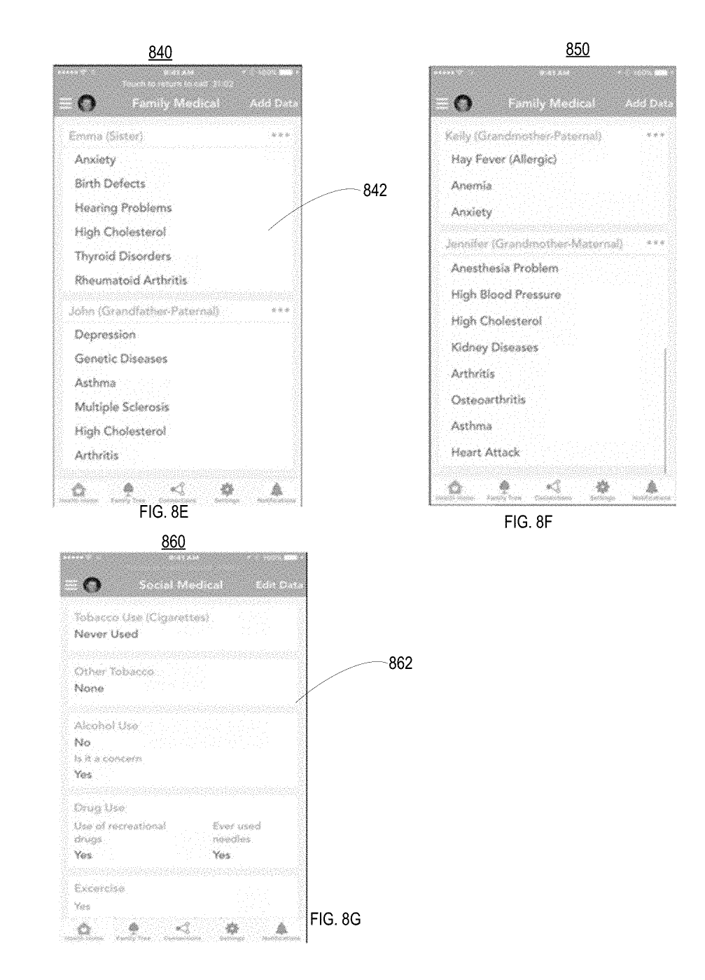

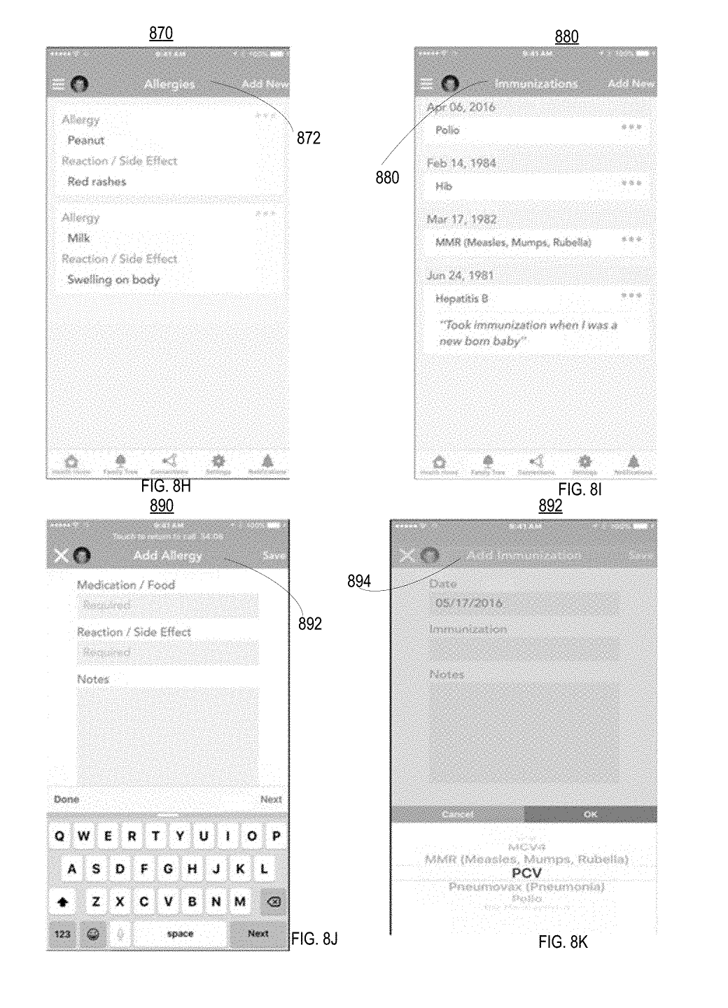

FIG. 8A diagram 800, FIG. 8B diagram 810, FIG. 8C diagram 820, and FIG. 8D diagram 830 (FIGS. 8A-8K are collectively referred to as FIG. 8) depict exemplary mobile device application exemplary graphical user interface screenshots of an example embodiment of an exemplary screen illustrating an exemplary embodiment of history separated logically 800 into an example four sections providing efficient access and sharing options, and/or can be captured through automated electronic retrieval from e.g., third parties, etc., displaying medical history 810 at a glance, can provide for receiving medical history notes 820, or by capture from third parties, etc., can prepopulate pervasive conditions for selection by a user, can provide for ease of data entry burden via user interface feature improvements for capturing data 830 by point and click selection, etc., respectively, in exemplary embodiments.

FIG. 8E diagram 840, FIG. 8F diagram 850, and FIG. 8G diagram 860 depict exemplary mobile device application exemplary graphical user interface screenshots of an example embodiment of an exemplary screen illustrating an exemplary embodiment of allowing for interactive capture(add)/display/access 840 to medical history for user (e.g. a first user), or other users that have been connected to profile (e.g., second users), medical histories can be displayed 840, 850 for viewing for all those users connected to a profile, social media medical data 860 can be logically separated from other medical histories in one exemplary embodiment, history can be captured by the system receiving receipt of user's manual gestures and/or keystrokes, etc. by use of interactive interfaces (voice recognition, touch screen, stylus, sensors, etc., and/or through automated electronic, optical, or other data retrieval, etc.) respectively, in one embodiment.

FIG. 8H diagram 870, FIG. 8I diagram 880, FIG. 8J diagram 890, and FIG. 8K diagram 892 depict exemplary mobile device application exemplary graphical user interface screenshots of an example embodiment of an exemplary screen illustrating an exemplary embodiment of receiving input, or capturing data input, such as, e.g., allergy information 870, side effects, medications, food intolerance, reactions, etc., immunization history 880, interfaces for adding allergies 890 can be provided, and for adding immunizations can be provided 892, respectively, in one embodiment.

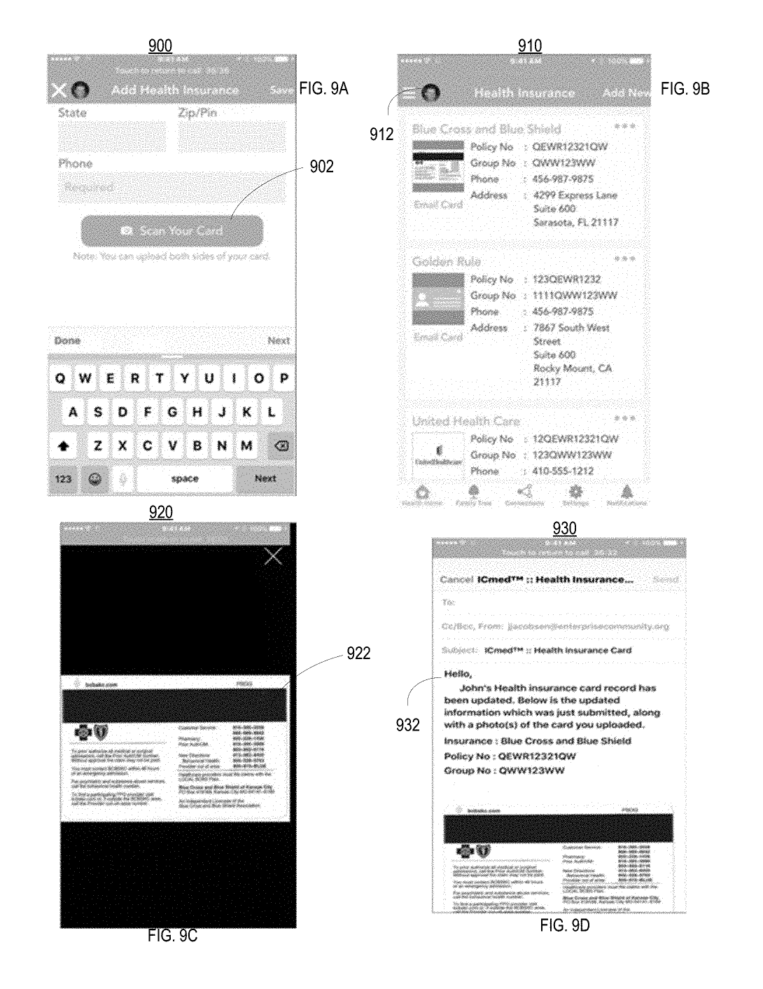

FIG. 9A diagram 900, FIG. 9B diagram 910, FIG. 9C diagram 920, FIG. 9D diagram 930, (collectively referred to as FIG. 9) depict exemplary mobile device application exemplary graphical user interface screenshots of an example embodiment of an exemplary screen illustrating an exemplary embodiment of providing insurance information 900, 910, such as, e.g., but not limited to, capturing insured data 900, policy information 910, group, phone, address of insurance provider, other identification, insurance card, images of cards 920, make available for sharing of insurance information, providing prepopulated message to accompany sharing of insurance information, which can be edited, in example embodiments, and can generate a transmission 930 such as, e.g., but not limited to, a message, alert, notification, communication, email, text, SMS, MMS, etc., respectively, in one embodiment.

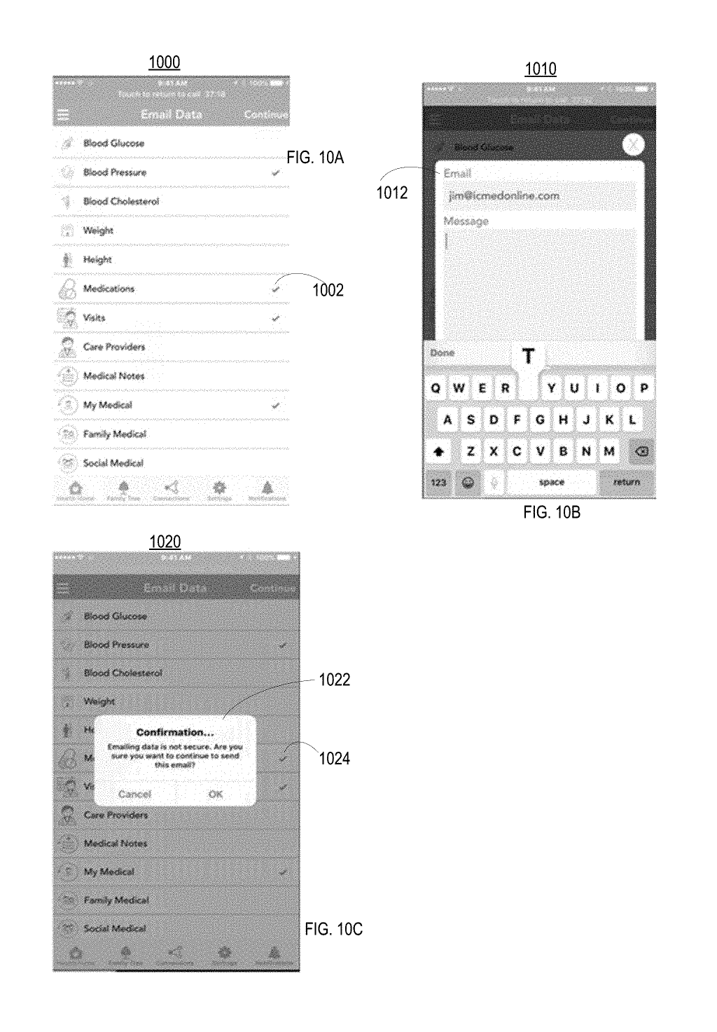

FIG. 10A diagram 1000, FIG. 10B diagram 1010, FIG. 10C diagram 1020 (collectively referred to as FIG. 10) depict exemplary mobile device application exemplary graphical user interface screenshots of an example embodiment of an exemplary screen illustrating an exemplary embodiment of functions configured to all selective sharing, transmission, sending, confirmations, etc. of any selectable portion and/or all data to another user, such as, e.g., but not limited to, a care provider, health service provider, etc., respectively, in one embodiment.

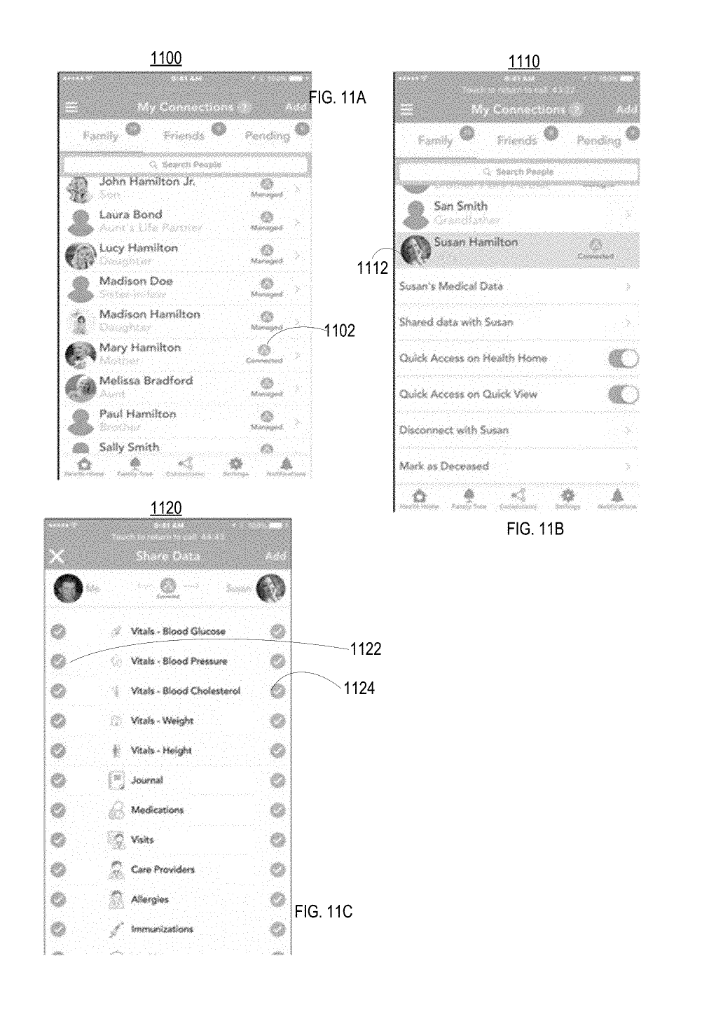

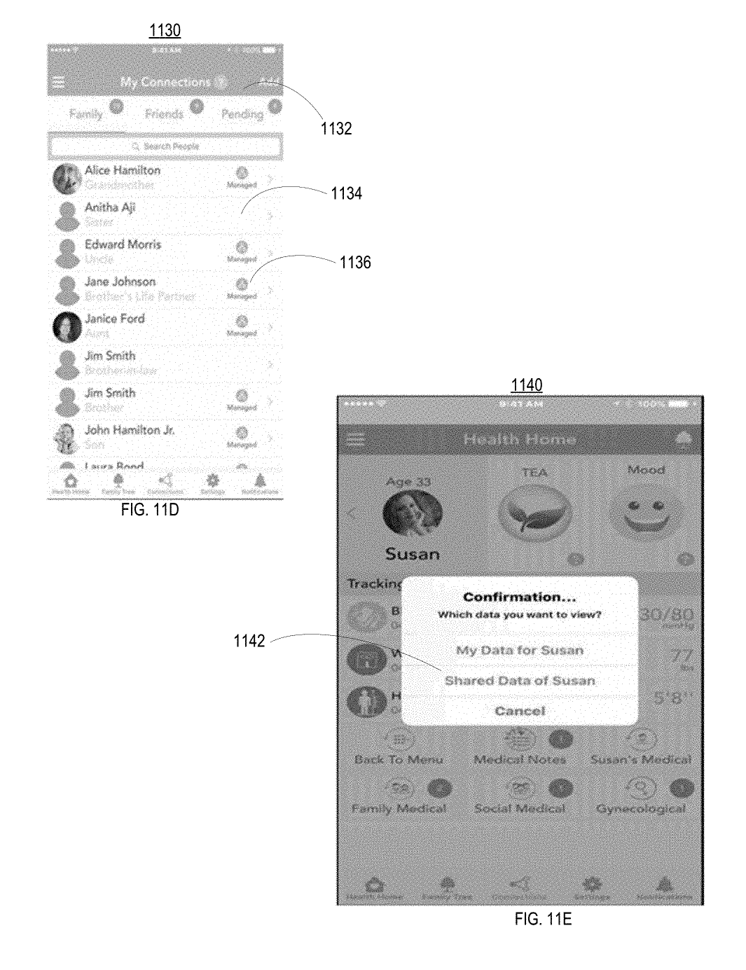

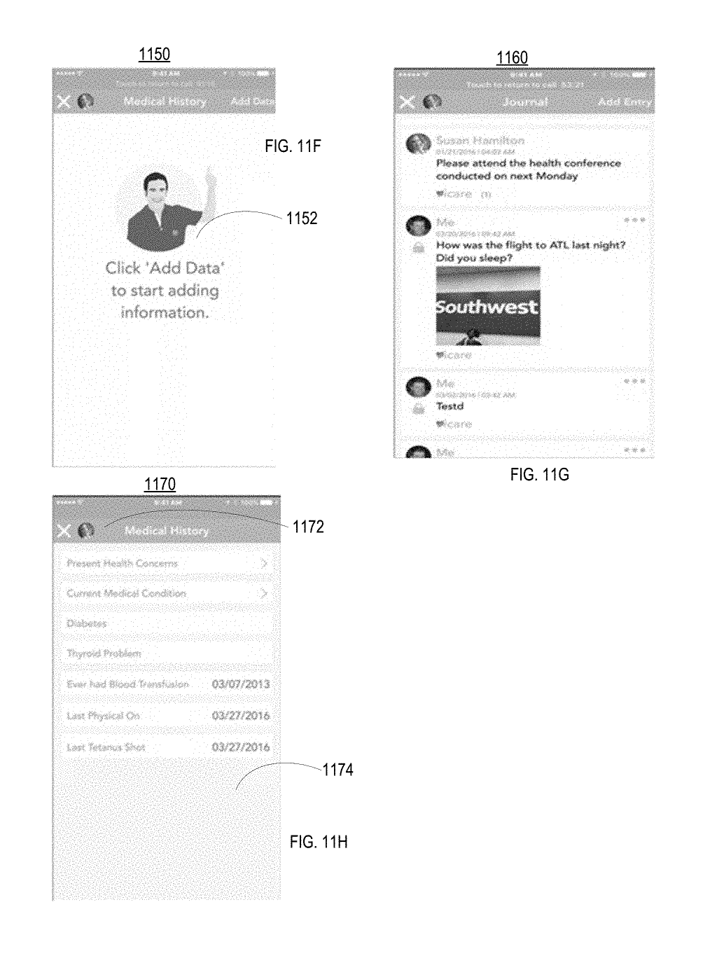

FIG. 11A diagram 1100, FIG. 11B diagram 1110, FIG. 11C diagram 1120 (FIGS. 11A-11H are collectively referred to as FIG. 11) depict exemplary mobile device application exemplary graphical user interface screenshots of an example embodiment of an exemplary screen illustrating an exemplary embodiment of functions configured to allow data sharing, which can be managed using my connections, in one embodiment, and can allow drilling down a view of a platform's profile manager, shared data can be identified, such as, e.g., but not limited to, by color such as, e.g., blue for information a first user is sharing, and green for information being shared by another or a second user with the first user, respectively, in one embodiment.

FIG. 11D diagram 1130, FIG. 11E diagram 1140, depict exemplary mobile device application exemplary graphical user interface screenshots of an example embodiment of an exemplary screen illustrating an exemplary embodiment of functions configured to provide for display of an example blue connected icon on the My Connections module denoting a “Managed Profile” this is a profile established by the user to track information of another person, who may or may not share their information with the user, example profiles can be turned over to an individual in the future, e.g. a managed profile for a child that will be handed over when age 18, etc., e.g. a profile started for a family member to save the family member user the task of setup; example invitations can be sent to connect with users; unaccepted invitations can be noted as pending; family and friends can be tracked separately from other users so that genealogical/family history can be associated with the user; an example lack of a green or blue connection icon can denote that a history is neither shared nor managed; and the example system can be programmed to provide the user an opportunity to view the data such as, Susan is sharing “Shared Data of Susan” or the data the user has input about Susan e.g. “My Data for Susan”; this can be used, e.g., but not limited to, if a user did not trust the data being shared, for example, etc., respectively, in one embodiment.

FIG. 11F diagram 1150, FIG. 11G diagram 1160, and FIG. 11H diagram 1170, depict exemplary mobile device application exemplary graphical user interface screenshots of an example embodiment of an exemplary screen illustrating an exemplary embodiment of functions configured to, if the user hasn't added data for the user or another user that the first user is managing, then the user can get what is shown in example FIG. 11F, or when a user is in another user's profile the system can be programmed to reveal, e.g., but not limited to, the picture, or image of the person and/or the screen can turn to a different color, for example, in this example (as illustrated in FIG. 11G and FIG. 11H) can be turned, e.g., but not limited to, green from blue, respectively, in one embodiment.

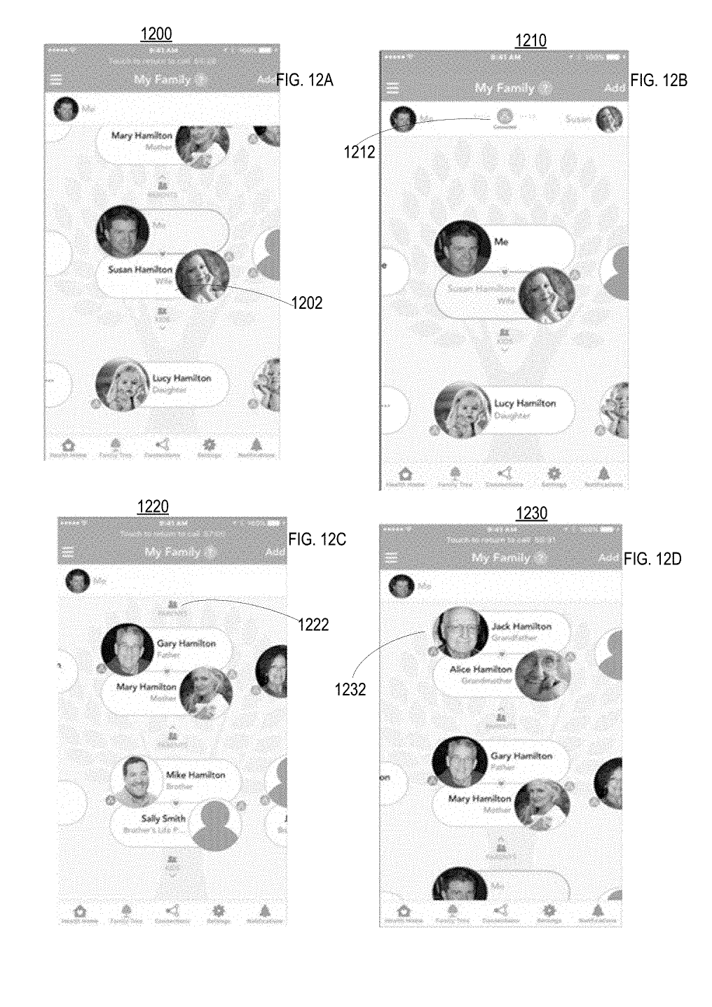

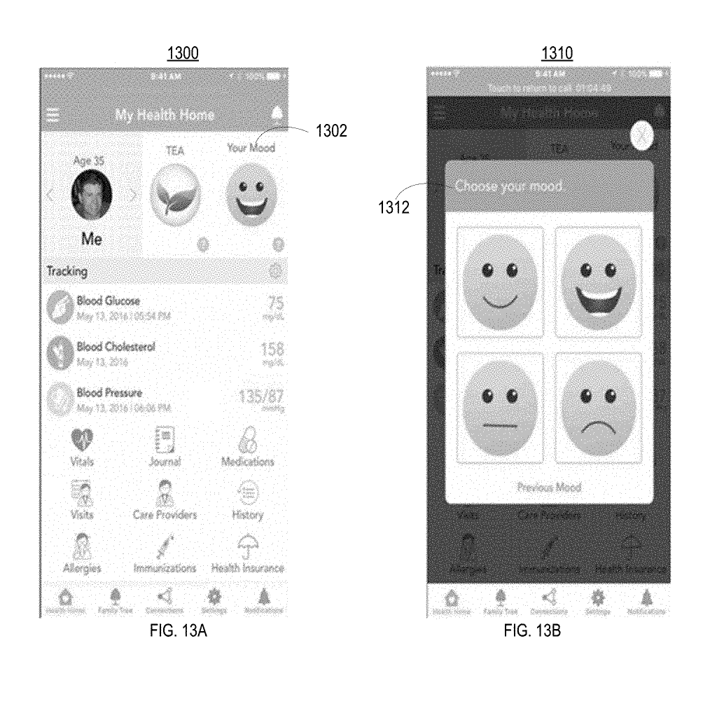

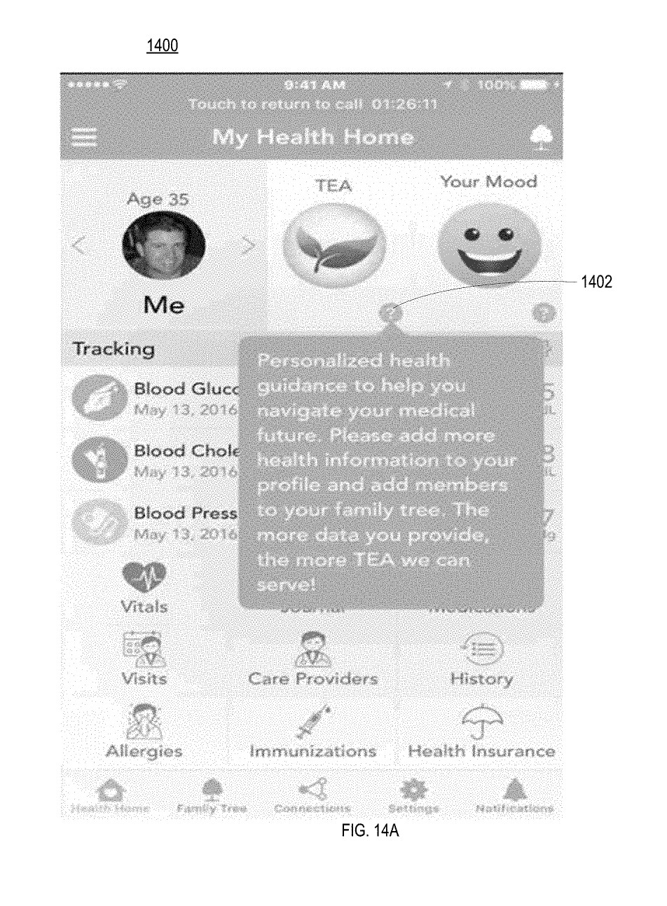

FIG. 12A diagram 1200, FIG. 12B diagram 1210, and FIG. 12C diagram 1220, and FIG. 12D diagram 1230(collectively FIG. 12) depict exemplary mobile device application exemplary graphical user interface screenshots of an example embodiment of an exemplary screen illustrating an exemplary embodiment of functions configured to display for interactive access the screen shots illustrating example functionality of the Family tree system, methodology and a graphical user interface (GUI); shared and managed health profiles can be accessed through the GUI 1200; example Tree profiles can change in relation to the user selected with GUI selection, e.g. if a user clicks on the wife 1210 of a first user, the screen will show her relationships in the tree in an example embodiment; the system can be programmed to know the relationship within the tree in an embodiment; The GUI can be programmed to, e.g., move up 1220 and down 1210, and/or left to right 1230, to show, e.g., parents and cousins, siblings, life partners, adopted siblings, etc. as a user can see in a typical family tree schema, respectively, in one embodiment.

FIG. 13A diagram 1300, and FIG. 13B diagram 1310 (collectively FIG. 13) depict exemplary mobile device application exemplary graphical user interface screenshots of an example embodiment of an exemplary screen illustrating an exemplary embodiment of functions configured to all a user to interactively select a mood, and to display that mood 1300, and an example screen can display various choices 1310 and can be configured to allow receipt from a user selection of any of a plurality of mood indications that can be provided and can permit capturing further data about the user, such as, e.g., a user's mental health, etc., respectively, in one embodiment.

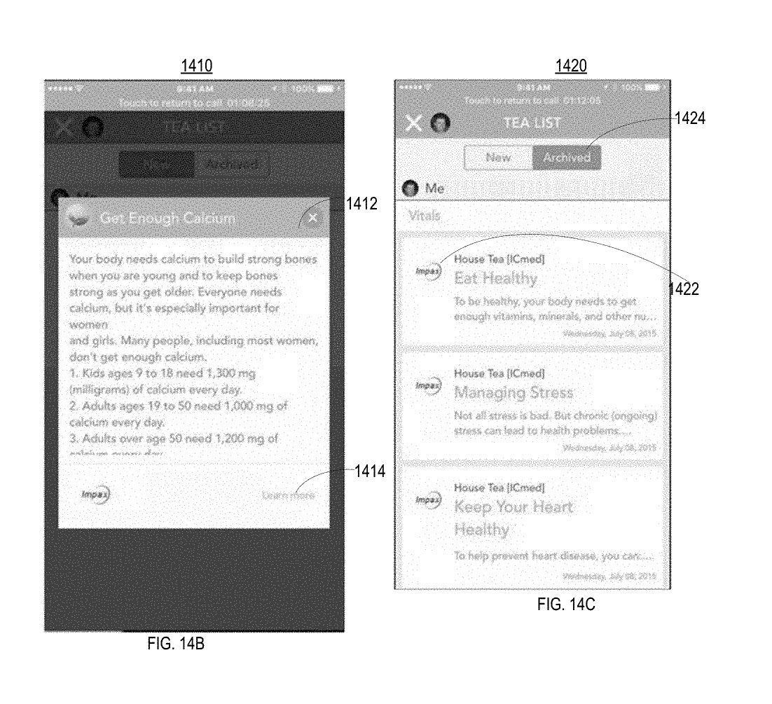

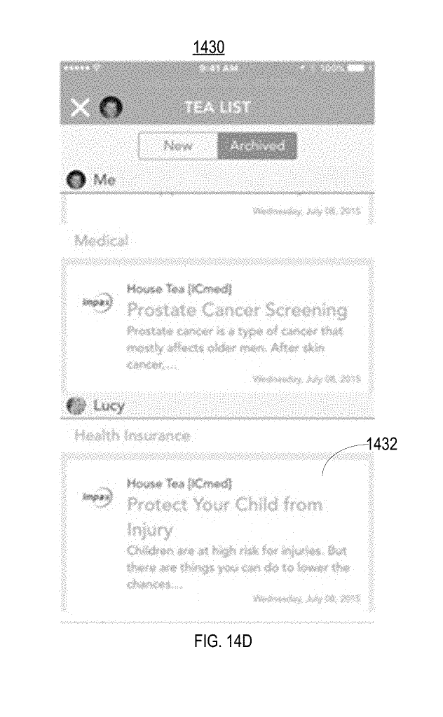

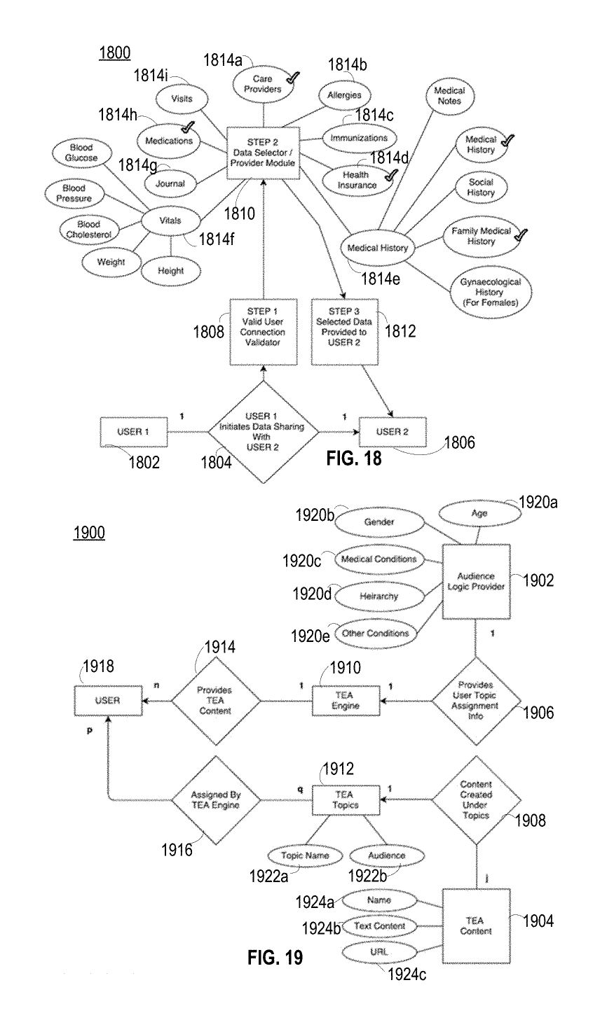

FIG. 14A diagram 1400 (FIGS. 14A-14D, collectively referred to as FIG. 12) depicts an exemplary mobile device application exemplary graphical user interface screenshot of an example embodiment of an exemplary screen illustrating an exemplary embodiment of functions configured to illustrate example help (?) text such as, e.g., in this case, explaining what an example TEA is providing for analysis, transmission and providing of user—targeted personalized health guidance information, respectively, in one exemplary embodiment. Also, see, for example FIG. 19, for additional exemplary embodiments.

FIG. 14B diagram 1410, and FIG. 14C diagram 1420 depict exemplary mobile device application exemplary graphical user interface screenshots of an example embodiment of an exemplary screen illustrating an exemplary embodiment of functions configured to allow display of, or access to, example TEA, e.g., but not limited to, TEA can be provided by an exemplary health information service provider, such as, e.g., but not limited to, an ICmed service provider, a healthcare marketer, a care provider, and/or other institutions, which can be seeking to promote information to constituents, such as, e.g., but not limited to, Target (sale on walkers), retailers, pharmacies, distributors, etc., and/or e.g. a drug company, pharmaceutical company, etc., may want to target, e.g., but not limited to, users having diabetes, etc.; information can be educational, and can include, e.g., a hypertext link universal resource location (URL) to an example website, further content, etc., for additional information; and can provide for a user to access additional content, by selecting a GUI indicator “Learn more” (e.g., at the bottom right of diagram 1410 of FIG. 14B), and can take a user to the example TEA promoter's website, and/or other content, such as, e.g., but not limited, video, etc., the link can also be inserted into an example personal health information social network wall such as, e.g., but not limited to, the Journal, of the example ICmed system, in one embodiment; the TEA can be archived (as illustrated, e.g., in 1420 of FIG. 14C) for retrieval at a later date, in one embodiment.

FIG. 14D including diagram 1430 depicts an exemplary mobile device application exemplary graphical user interface screenshot of an example embodiment of an exemplary screen illustrating an exemplary embodiment of functions configured to display, or permit access by a user to pushed data, that has been sent to users that the first user is managing, such as, e.g., but not limited to, an elderly person, a child, etc. (e.g. Lucy, as illustrated in screen shot 1430 FIG. 14D), in one embodiment.

House Tea [ICmed]—the service provider can provide NIH information, based on your profile notes relevance to Prostate cancer

Excel spreadsheet of exemplary rules base, if conditions are met, then perform particular event, e.g., notification, alert, transmission, share content, post TEA, provide targeted ad, provide targeted education content

### Business Rules Based Notification Engine

AI based neural network takes input of medical condition and demography based data, and based on that input, determines appropriate events to trigger, and takes action on initiating that event. In an exemplary embodiment, when certain profile features are checked, then perform a given triggered event, such as, e.g., but not limited to, if a person is in a particular age category, and has heightened blood pressure readings, then send content about avoiding hypertension, or send TEA about blood pressure medications, etc.

If this, then that type rules based logic. The same rules can be used in more of a decision support system, recommending actions to be taken by the person, based on certain observed data. If within a particular age category, and with certain risks in family history, providing an electronic recommendation recommending taking some action such as a prostate test screening.

Deep learning or data mining can be used in certain exemplary embodiments, which can include a class of machine learning and can include algorithms that can use, e.g., a cascade of many exemplary layers of nonlinear processing units for feature extraction and transformation, according to one exemplary embodiment. Deep learning by universal approximation theorem interpretation or probabilistic interpretation can be used in some exemplary embodiments. Various deep learning architectures may be used including, e.g., but not limited to deep neural networks, convolutional deep neural networks (useful for visual and two dimensional data), deep belief networks, large memory storage and retrieval neural networks (LAMSTAR), deep Boltzmann machines, stacked denoising auto-encoders, deep stacking networks, tensor deep stacking networks, spike and slab, deep coding networks, compound hierarchical deep models, and recurrent neural networks, which can be applied to analyzing large data sets to provide potential targeted content based on certain analysis. Alternative processing to machine learning such as, e.g., but not limited to, topic identification and various OCR and document processing can also be used.

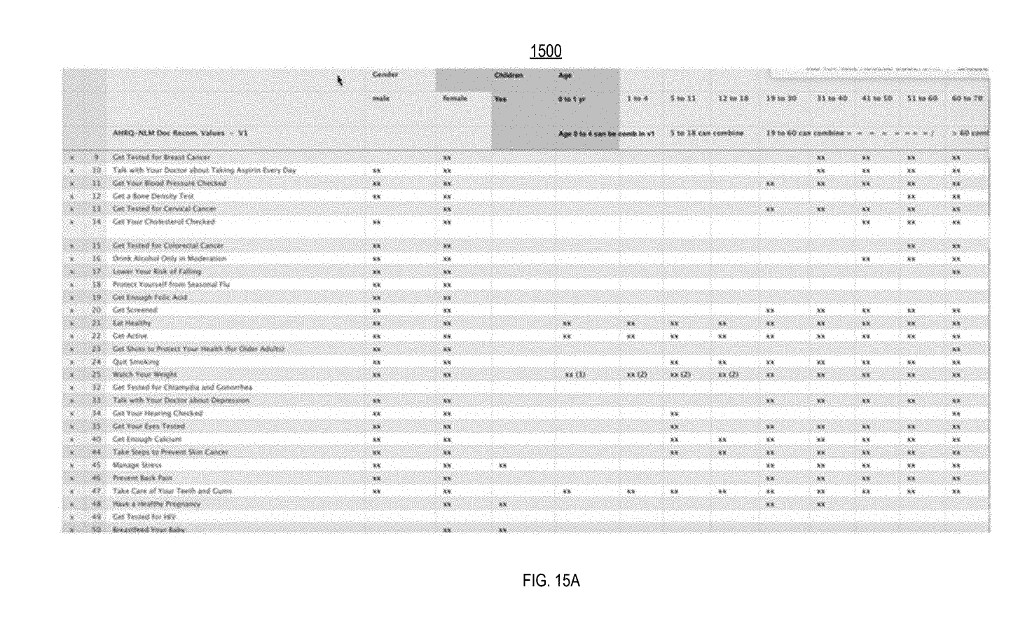

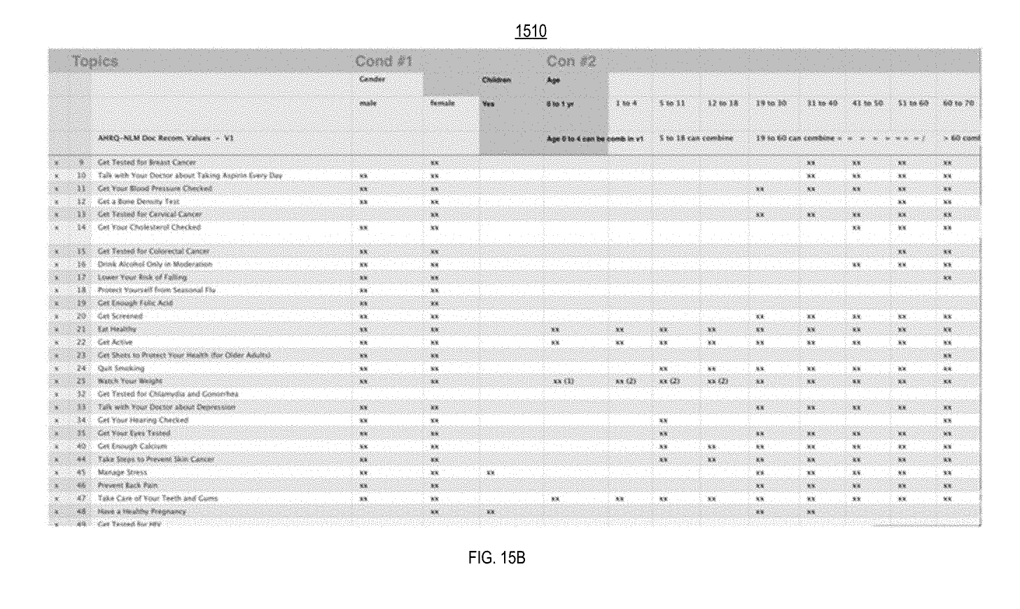

FIG. 15A depicting diagram 1500, and FIG. 15B depicting diagram 1510 (collectively referred to as FIG. 15) depict exemplary database tables indicating an exemplary set of fields for targeting example content based on particular user personal health data, according to an exemplary embodiment. Examples of data and example age ranges of relevancy of exemplary content is illustrated. Automated distribution and delivery of such content can be electronically scheduled and targeted at “at risk” groups. If (the example conditions on the right are true), then push the exemplary TEA content listed on the left columns.

Exemplary data can be obtained from health data sources such as, e.g., but not limited to, HHS, NIH, in any of various API and/or data formats, such as real simple syndication (RSS), etc. An exemplary National Institutes of Health (NIH) data feed can be considered as an illustrative example. NIH has various feeds, content feeds (text based feeds). NIH feed data can include exemplary NIH feeds accessible at a website, which can include, e.g., but not limited to, http://www.Healthfinder.gov/healthtopics/.

An exemplary personal health information database can be built upon an exemplary relational database management system such as, e.g., but not limited to, Oracle, Microsoft SQL Server, IBM DB2, etc., according to an exemplary embodiment. According to another exemplary embodiment, the database can be built atop a graphical representation of the familial relationship, and/or via a graph database, according to an exemplary embodiment.

An exemplary selective share, according to an exemplary embodiment, can provide various exemplary features for a user to grant access by others to the user's personal health history information, as well as access the information by the user herself or himself, and gives the user the ability to share, or not share this data at very specific levels of granularity of data, and to various other users.

Health Journal—family feed—icare (like) and personal posts, and those who are sharing with you, a view of the information you have captured, and if others have captured and shared with you.

Journals, according to an exemplary embodiment, has icare, which is a graphical user interface element allowing something akin to liking a given social networking wall personal health information post or entry on the exemplary health journal social networking wall, is interactive with those you share with, and is akin to a social network like indication, e.g., heart on twitter, like, thumbs up, or other reaction on Facebook, etc., according to an exemplary embodiment. In addition, rather than just entering medications and vitals, according to an exemplary embodiment, the exemplary system can allow entering pictures, videos, and/or other personal health content into the personal health history feed, according to an exemplary embodiment.

In another exemplary embodiment, the exemplary personal health data is built on a graph or a graph database, where nodes represent users, and edges represent familial relationships between a pair of people represented by the given nodes.

### Exemplary Functional Specification

### Family Tree and Selection Sharing Exemplary Operation

The following describes an exemplary operation of how an exemplary family tree and selective sharing can work, according to an exemplary embodiment, including, e.g., but not limited to, functionality of the family tree and connection pages. Exemplary methods of displaying and accessing exemplary managed vs. shared connections, according to an exemplary embodiment, are set forth, and exemplary functionality of how the system can operate in some of these exemplary use cases are set forth, including exemplary screen shots of an exemplary embodiment.

### Family Tree

Family tree is a place in ICmed where you can add your family relationships. This is implemented in ICmed in a node structure and for each family tree node you will be able to assign a profile. And for each profile a life partner can also be added. A profile selector module allows the user to select a user profile to be added to a node in the family tree.

A profile added to family tree can be of two types.
1. A user profile from your connections.
2. A user who is not in ICmed, a deceased person or a minor. (Managed Account)

Managed accounts are created for a people who may or may not be registered in ICmed. You can create a managed account for a minor, or you can create and manage an account for your father who is not able to create a profile of his own.

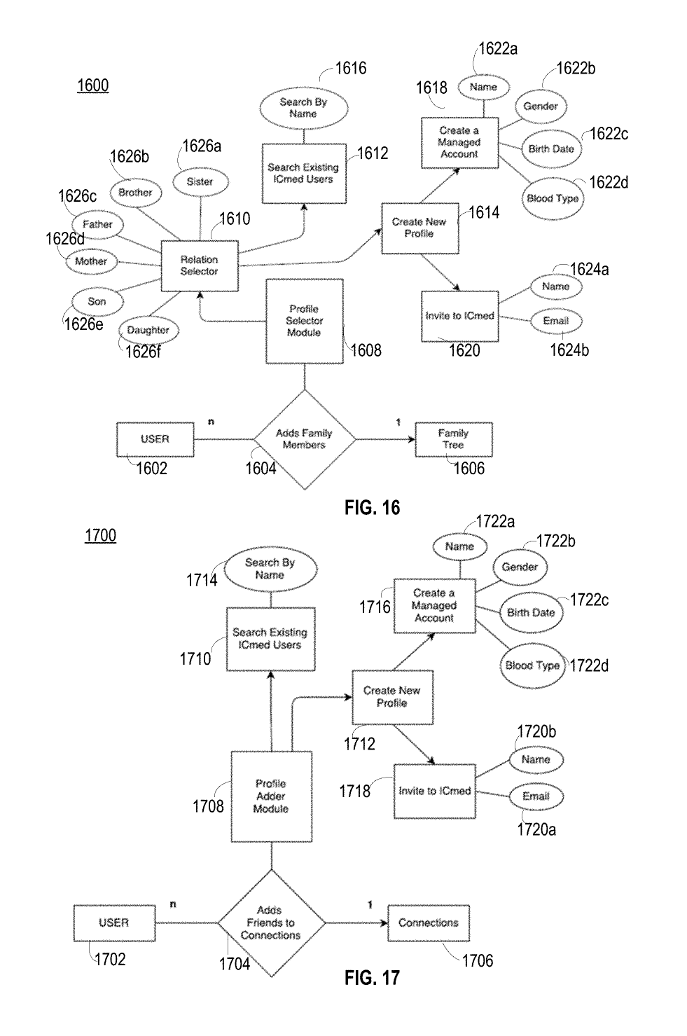

FIG. 16 depicts an exemplary flow diagram 1600 of an exemplary flow chart illustrating an example of adding family member 1604 and relations and managed accounts users flowchart of the personal health information service provider system, including adding family users to connections 1604 for a user 1602 and family tree relationships 1606, including selecting a profile 1608, using a relation selector 1610 capturing relation 1626a-1626f, searching existing users 112, e.g., by name 1616, if a new user then creating a new profile 1614, creating a managed account if desired 1618, including capturing example profile data 1622a-1622d, and after creating, allowing inviting the user to the system 1620 by capturing the user identifier, e.g., name 1624a, and/or email 1624b, according to an exemplary embodiment.

In one exemplary embodiment, the family tree data can be captured in the form of a relational database, in another exemplary embodiment a graph database of family members can be stored in the form of a graph with nodes and relationship linkages or links.

### Connections

An exemplary connection may include, in an exemplary embodiment, an established mutual link between two ICmed users. This exemplary feature of the exemplary ICmed platform may allow distinguishing specific users whom a given user may wish to collaborate with closely in the exemplary ICmed platform (such as, e.g., but not limited to, Family, Close friends, etc.). An exemplary connection feature may also facilitate managing user permissions and privileges for access to data via the exemplary ICmed platform, according to an exemplary embodiment. Exemplary connected users can have the following exemplary options in the exemplary ICmed platform, according to an exemplary embodiment.

### Connections

A Connection in ICmed is an established mutual link between two users or the user and organizations. This is the most important feature in ICmed and it is added to distinguish specific users whom a user wishes to collaborate closely (e.g., Family, Close friends, Individual Care providers and Organizations, etc.). Connected users will have option to enable data sharing and other collaboration features in ICmed. Initiating a connection request will also give the user, a feature to keep personal medical records for the connection (e.g.: My Data for My Mother) also called a Managed Account.

The ER diagram below explains the specifics and flow about adding an ICmed member, a managed account or an invite to a friend. Once registered through an invite a friend will be automatically added to his connections for a user.

FIG. 17 depicts an exemplary flow diagram 1700 of an exemplary flow chart illustrating an example of a adding users and connections 1704 example flowchart of the personal health information service provider system including adding 1704 a friend to connections for a user 1702 to add a connection 1706, adding a profile 1708, searching existing users 1710, searching by name 1714, creating a new profile if not found 1712, creating a managed account 1716 if, e.g., the user is too young, or old to use the system, including example capture of data 1722a-1722d, inviting a user to the system 1718, including, e.g., receiving a name 1720b, and/or electronic identifier (e.g., email or phone, etc.) 1720a, according to an exemplary embodiment.

### Share Medical Data

An exemplary share may include, in an exemplary embodiment, where sharing is NOT turned on by default, for connected users. Each user can then have the feature to select the modules which they may want to share with another connected user, according to an exemplary embodiment, which can include sharing or not sharing at very specific levels of granularity, such as, e.g., but not limited to, providing sharing of one's blood pressure, but not one's pulse, etc. Exemplary users who are not connected can, according to an exemplary embodiment, do not have the feature to share any data, according to an exemplary embodiment.

### Selective Sharing

Once a connection is established in ICmed, two users will be able to share data with each other. A data selector/provider module enables a user to select the modules which he wishes to share with another user. A connection is mandatory to use the selective share feature in ICmed. If data is shared by a user for someone else then the second user will be able to access the first users profile data. The ER diagram explains the sharing initiation, selection of modules and data provision elements.

FIG. 18 depicts an exemplary flow diagram 1800 of an exemplary flow chart illustrating an example of a selective sharing flowchart of the personal health information service provider system to users, with example selective sharing checks, and various example levels of granularity of information that can be shared, including initiating 1804 of data sharing by user 1 1802 with user 2 1806, including validation 1808, and selection (represented by checkmarks for data opted to be shared with a given user) 1810 and providing, by providing 1812 selected data to user 2, where such data can include vitals 1814f, medical history 1814e, health insurance 1814d, immunizations 1814c, allergies 1814b, care providers 1814a, visits 1814i, medications 1814h, journal 1814g, according to an exemplary embodiment.

### Receive TEA for Shared Data

According to an exemplary embodiment, an exemplary user John, and his brother Jasen, are connected users in the exemplary ICmed platform. According to an exemplary embodiment, where Jasen has shared his “Vitals” and “Social History” data to John, John can then receive one or more targeted educational advertisements (TEA) based on analysis of Jasen's “Vitals” and “Social History” data, according to an exemplary embodiment. According to an exemplary embodiment, the exemplary system can analyze the data shared data and can using a rules-based, neural network, artificial intelligence computer system, can determine any of various appropriate automatically deliverable targeted messages, based on the analysis of Jasen's data, that may then be delivered to the user John, for review, either on a separate listing of such notifications (advantageously avoiding users being bombarded with distracting advertisements in the user John's personal health history journal social networking personal health feed), and/or in an alternative integrated social networking wall of the exemplary user John, according to various exemplary embodiments. This exemplary feature can be implemented to help users and care providers to get the TEA educational assistance information for people that they care about, and/or may also be responsible for. Thus, according to an exemplary embodiment, information for an elderly parent, or for a child's medical condition may be shared automatically to the user, which may be serving as a care provider of their elderly parent or child, whose personal medical information has been shared to the user, or for whom the user manages the personal health information therefor.

Various deep learning and machine learning applications can be included in various embodiments taking advantage of big data, using exemplary deep learning algorithms, neural networks and/or artificial intelligence and/or expert systems and/or convolutional neural networks, and/or while also being able to take advantage of static and dynamic graphs, and/or processing via, e.g., but not limited to, Graphical Processing Unit (GPU) clusters to process big data across many users, processing their captured, and anonymized medical data to identify potential automated recommendations and/or electronic alerts based on analysis of exemplary fully mesh connected, multilayer microdata, growing topologies and crossing or skipping layers. Various exemplary benefits can include associated improvements in the health of populations, decrease in costs of care, improvements in patient experiences and health. Medical data informatics can process any of various data captured, entered, and/or received by an exemplary system and can include, e.g., but not limited to, data captured via biosensors, synchronously, asynchronously, periodically or aperiodically, in realtime and captured over time, allowing sending of patient specific alerts to family members and/or other care providers, and/or health care providers, and/or clinics.

### Targeted Educational Assistance (TEA)

ICmed TEA engines provides educational assistance information to all users according to the information added to their ICmed profile. If a user has shared data available in his profile from a different ICmed member, then they can get educational assistance information for the profile of the person who has shared the data. Internally the platform uses an audience logic provider to assign TEA topics to each user profile and shared data profile attached to a user's account. The TEA engine then schedules educational assistance information to be sent at specific times as per the configuration added inside the TEA engine for each topic.

FIG. 19 depicts an exemplary flow diagram 1900 of an exemplary flow chart illustrating an example of providing example targeted information TEA content 1904 including content elements 1924a-1924c, taking content under topics 1908, and placing in TEA topic 1912 organized by topic name 1922a and audience 1922b, an assigning by engine 1916, from, e.g., the personal health information service provider system to users 1918, where audience logic providers 1902 can provide audience elements 1920a-1920e, and providing user topic assignment information 1906, to the TEA engine 1910, for providing the TEA content 1914 to the users 1918, according to an exemplary embodiment. In one exemplary embodiment, documents can be identified by topic using an exemplary topic identifier module.

Access Exemplary Personal Health History Journal Social Networking Wall and/or Post Exemplary Replies and/or other Posts to the Journal Social Networking Wall

According to another exemplary embodiment, a user John has shared his exemplary personal health journal with all the family members with whom he is connected in the exemplary ICmed platform system. User John, according to an exemplary embodiment, can then post updates about his (John's) medical condition in the exemplary personal health journal corresponding to each other user, which is a member of his whole family, and the users corresponding to user John's family can support him by posting reply posts using user interface elements enabling receipt of social network wall posts and also the system can provide for receiving any critical medical information, and displaying it to the user John. Initiating a connection request by the user device to the personal health data service provider system, according to an exemplary embodiment, can also provide to the user, an exemplary feature to keep a personal record of medical data for the requested connection (e.g., but not limited to, “My Data,” for My Mother, etc.).

The ER diagram below depicts, according to an exemplary embodiment, exemplary specifics and exemplary data flow relating to an exemplary process and/or method of providing a user interface element for receiving by the exemplary ICmed platform system of a request to add an ICmed member, a managed account, or an invitation to a friend. According to an exemplary embodiment, once the exemplary system has received a registration request to register through, e.g., but not limited to, an electronic invitation being transmitted to a friend, the friend user's device can automatically be added and a data record associated with the friend user, can be added to the first user's connections of the first user.

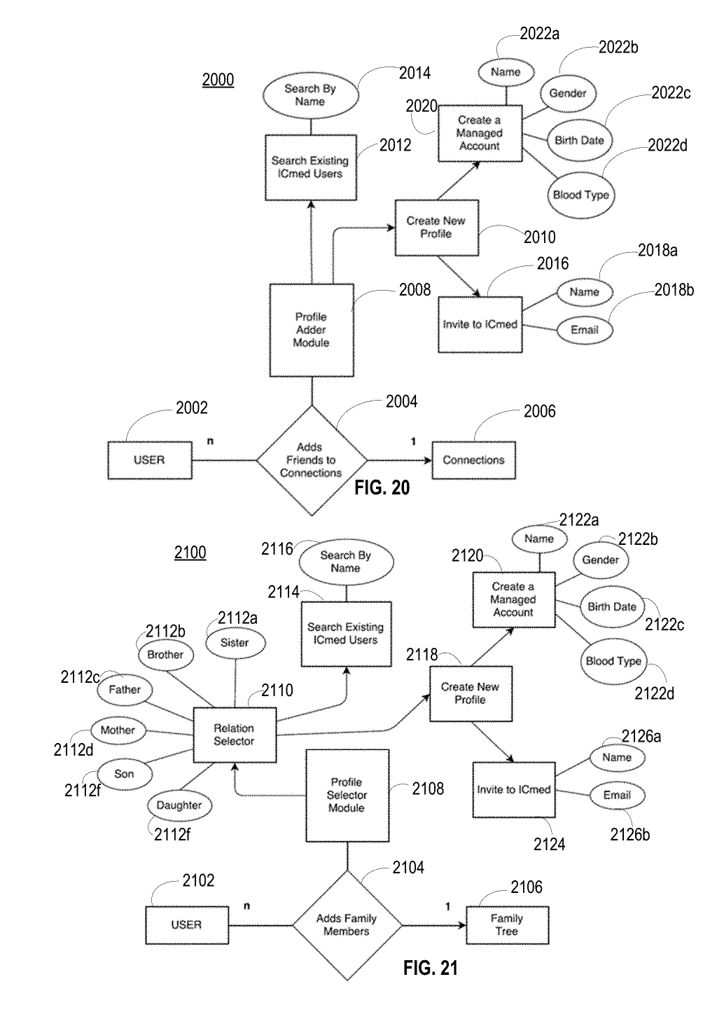

FIG. 20 depicts an exemplary flow diagram 2000 of an exemplary flow chart illustrating an example of creating a managed account and inviting another user to the personal health information service provider system, which can include a user 2002 adding 2004 a friend to connections 2006, adding a profile 2008, including searching existing users 2012, by, e.g., name 2014, and if not found, creating a new profile 2010 including creating a managed account, if desired 2020, including capturing user information 2022a-2022d, and inviting the new user to join the system by capturing an identifier of the new user such as, e.g., but not limited to, a user name 2018a, email 2018b, according to an exemplary embodiment.

### Family Tree

Family tree is a place in ICmed where you can add your family relationships. This is implemented in ICmed in a node structure and for each family tree node you will be able to assign a USER. For each user a life partner can also be added. When adding a user to ICmed family tree, a relation must be specified.

A USER added to an exemplary family tree can be of an exemplary two (or more) types:
A connected user.
A person who is not an ICmed user, a deceased person or a minor. (Managed Account).

If another user from a first given user's Connections is also part of a given family tree, then that another user person can appear under an exemplary “Family” category in the exemplary connections page, according to an exemplary embodiment.

FIG. 21 depicts an exemplary flow diagram 2100 of an exemplary family tree connections flow chart, including, for example, adding 2104 a family member to a user 2102b including building a family tree 2106, including receiving a selection of a profile 2108, receiving a selection of a relation 2110, including example relations 2112a-2112f, searching existing users 2114, searching, e.g., by name 2116, or other identifier, if not found, creating a new profile 2118, which can include creating a managed account 2120, which can include example profile data 2122a-2122d, and an invite can be transmitted/sent to the new user 2124 including receiving an identifier of the new user, e.g., name and/or email address or other identifier, according to an exemplary embodiment.

### Managed Accounts

Managed accounts, according to an exemplary embodiment, are created for a people who are not registered in an exemplary ICmed app. An exemplary user can, according to an exemplary embodiment, a) create a managed account for a minor, by using a create managed account instruction and/or user interface element, orb) create a managed account for the user's family member, e.g., father, who is deceased, etc. The living status of an exemplary user can be indicated on the user interface, according to an exemplary embodiment, by an exemplary color indication of the graphical user interface element, as discussed below, according to an exemplary embodiment. In one exemplary embodiment, a family member who is deceased can be indicated with a black color outlined circle, and/or a different color, and/or shading, and/or other GUI indication such as, e.g., but not limited to, highlighting, transparency, opacity, shading, graying out, etc.

An exemplary ICmed app system, according to an exemplary embodiment, can also have the feature to transfer a managed account to another user's control. (e.g., a child of a user, such as, a daughter, may be managed by the user until reaching an age of majority). When the child (daughter) reaches the minimum age for handling her own medical profile, then the user interface can provide instructions and/or a user interface element to enable transfer of management of the managed account from the first user, to her. An exemplary transfer can be provided electronically such as, e.g., but not limited to, an electronic mail invitation transmission and/or another electronic handoff of access of a database record associated with the user whose data management is being transferred. The child (the user's daughter) can receive the electronic invitation and can click on an electronic hypertext link such as, e.g., but not limited to, a hypertext transfer protocol (HTTP) universal resource location (URL) hypertext link, that may be delivered in the electronic transmission to the user to accept the invitation, and the child user can be then permitted access to initiate or start her account creation with the exemplary ICmed app system. All the previously captured and/or received personal health history data of the previously managed user, can be already transferred to the new account and the transferred child user can then be given full access to any, and/or all of the personal health and/or medical history of the child user, which was previously captured and/or received with respect to the child in the managed user's record of the user manager parent or guardian that was previously managing the user, prior to transfer, which may at that point be now associated with the child user's new record, where the previous manager user was the child user's parent, according to an exemplary embodiment.

### Connection Between Family History and Tree

An exemplary Family tree is a place in the exemplary ICmed system where relationship(s) can be displayed in an interactive format, according to an exemplary embodiment. If a person from a given family tree is connected with a user and the person has shared “Family History” data with the user. Then the “Family History” data or information can be accessible for the user.

According to one exemplary embodiment, there can be no link between family history and tree. According to another exemplary embodiment, both the family history and tree can be connected or coupled to one another as exemplary modules so that when a user adds a family history, the user can also enable the feature allowing adding a family history for another user who is already present in the family tree.

### Generational and Gender Information on Users

An exemplary system, to be able analyze some genetically important diseases, can be configured to track generational and gender related demographics and information about users, and relationships of users to other users. According to an exemplary embodiment, the exemplary system can receive, capture, store and maintain such information, among other processing.

According to an exemplary embodiment, an exemplary family tree can provide features for a user to store generational information. Gender and other medical information can be stored as part of the user profile, in an exemplary embodiment. Both generational and gender information can be available in the database for purposes of TEA content delivery, according to an exemplary embodiment. For example, according to an exemplary embodiment, exemplary TEA can specifically be provided for a user who has, e.g., but not limited to, his father and grandfather having a history of Alzheimers, etc.

### Ingesting Family History Discovered Through Connections

According to an exemplary embodiment, an exemplary system can provide a feature to ingest family medical? history (FMH) into a user, shared data, which is discovered from a connected user.

### Exemplary Meaning of Exemplary Color, Shading and Icons for an Exemplary Embodiment

### Currently Selected Profile

According to an exemplary embodiment, distinct meaning can be assigned to graphical user interface color, shading, and/or icons, etc., as discussed below in one embodiment. When a given user first accesses the graphical user interface element representation of the virtual family tree, the GUI representation of the profile of that given user can be selected by default, according to an exemplary embodiment. All relations that have been created previously by using the adding features, can be displayed according the given user's profile, according to an exemplary embodiment.

A given user's parents can be displayed on top (i.e., above the representation of the user vertically in the application's vertical scroll accessible portions above the position of the user's graphical representation on the virtual family tree graphical representation), according to an exemplary embodiment. The user's siblings will be displayed on the right and left (i.e., to the left and right in horizontal scroll accessible portions laterally to the left and right of the user's graphical representation on the virtual family tree graphical representation), according to an exemplary embodiment. The user's kids can be displayed at the bottom (i.e., beneath the user, below the graphical representation of the user in the lower vertical scroll portion of the virtual family tree graphical representation), according to an exemplary embodiment. A currently selected profile can be displayed in YELLOW (Yellow fill color or yellow colored graphical user interface element and/or instructions) and with an exemplary blue (Blue colored outline of the exemplary oval representation element of the user) band around it, according to an exemplary embodiment.

### Exemplary Graphical User Interface (GUI) Color-based Familial Relationship and Informational Indications According to an Exemplary Embodiment

### Life Partners

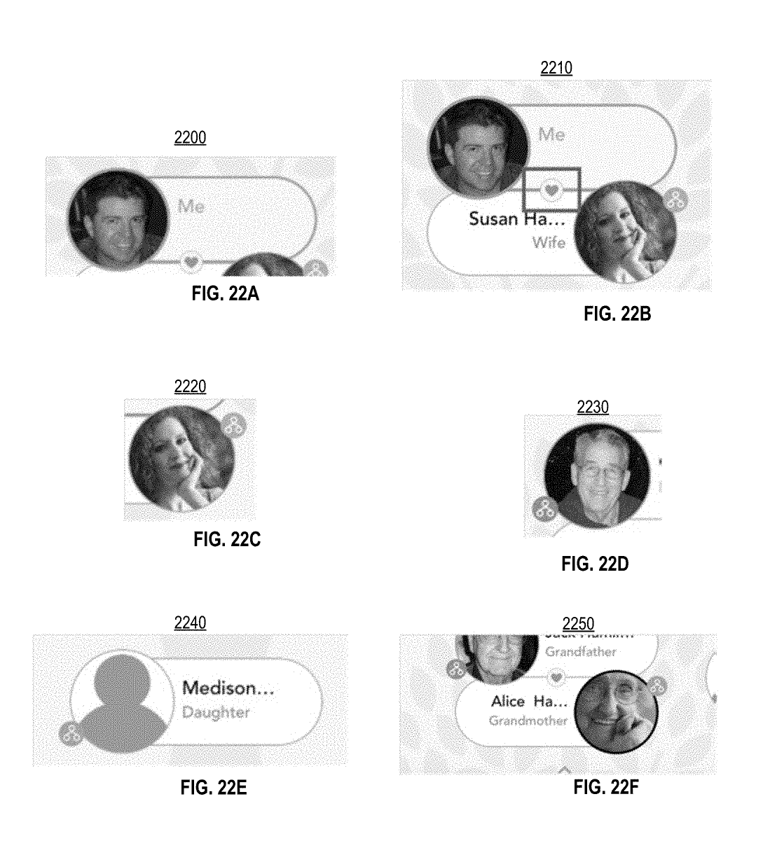

FIGS. 22A depicts diagram 2200 and FIG. 22B depicts diagram 2210 depicting an exemplary embodiment of a portion of a grayscale version of a color screenshot illustrating a GUI element that can be used, in an embodiment to indicate an example of—a heart image placed inbetween two profiles such as, e.g., but not limited to, a husband and wife, etc., showing that the two users are life partners, according to one exemplary embodiment.

FIG. 22C depicts and exemplary embodiment of a portion of a color screenshot illustrating a GUI element that can be used, in an embodiment to indicate an example of—a Connected Users—Green (Represented in Green colored fonts/icons ink or coloring on GUI), according to one exemplary embodiment.

FIG. 22D depicts and exemplary embodiment of a portion of a color screenshot illustrating a GUI element that can be used, in an embodiment to indicate an example of—a Pending Connection Invites—Grey (Represented in Grey colored fonts/icons ink or coloring on GUI), according to one exemplary embodiment.

FIG. 22E depicts and exemplary embodiment of a portion of a color screenshot illustrating a GUI element that can be used, in an embodiment to indicate an example of—a Managed Accounts—Blue (Represented in Blue colored fonts/icons ink or coloring on GUI), according to one exemplary embodiment.

FIG. 22F depicts and exemplary embodiment of a portion of a color screenshot illustrating a GUI element that can be used, in an embodiment to indicate an example of—a Deceased Person—Black Edge (Represented in Black colored fonts/icons ink or coloring on GUI), according to one exemplary embodiment.

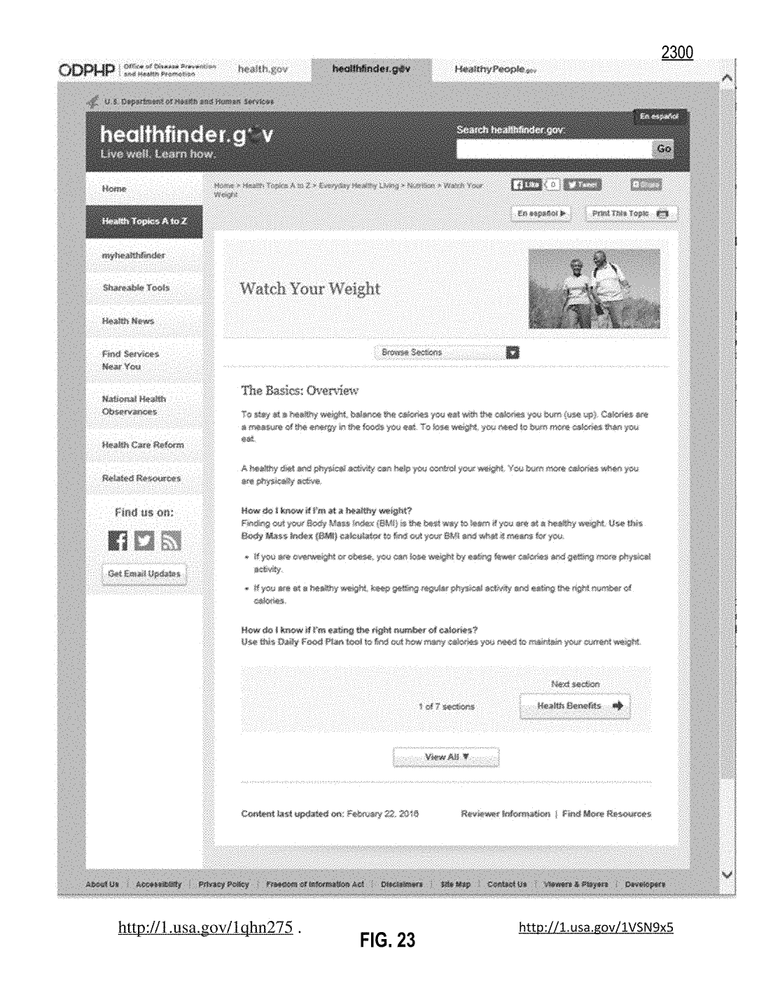

FIG. 23 depicts an exemplary public service health news notification/communication/alert, etc., in this case from the US Department of Health and Human Services (HHS), according to an exemplary embodiment, according to an exemplary embodiment.

### Alerts

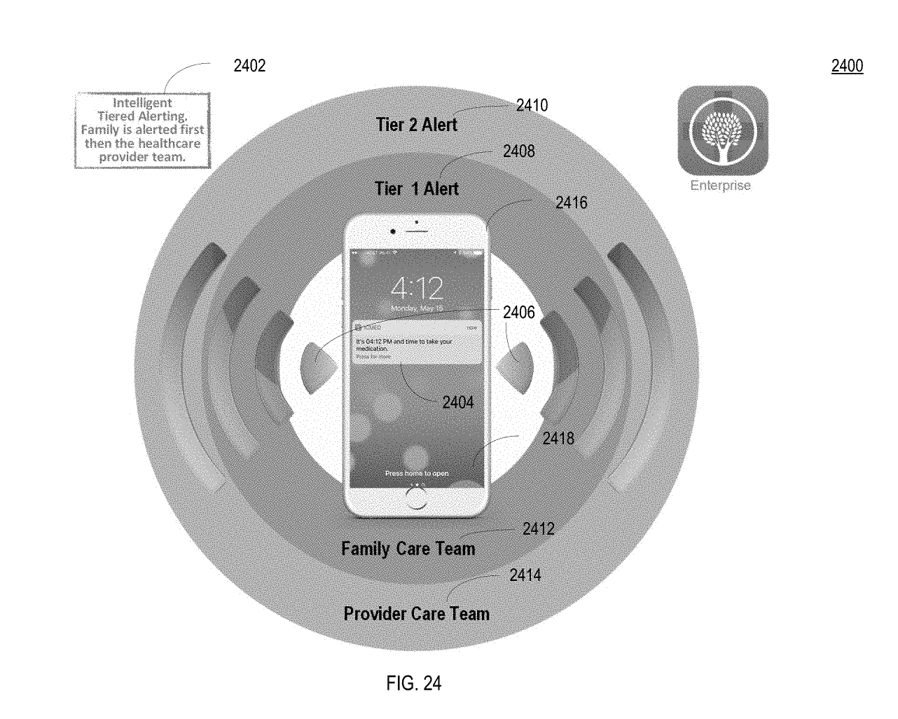

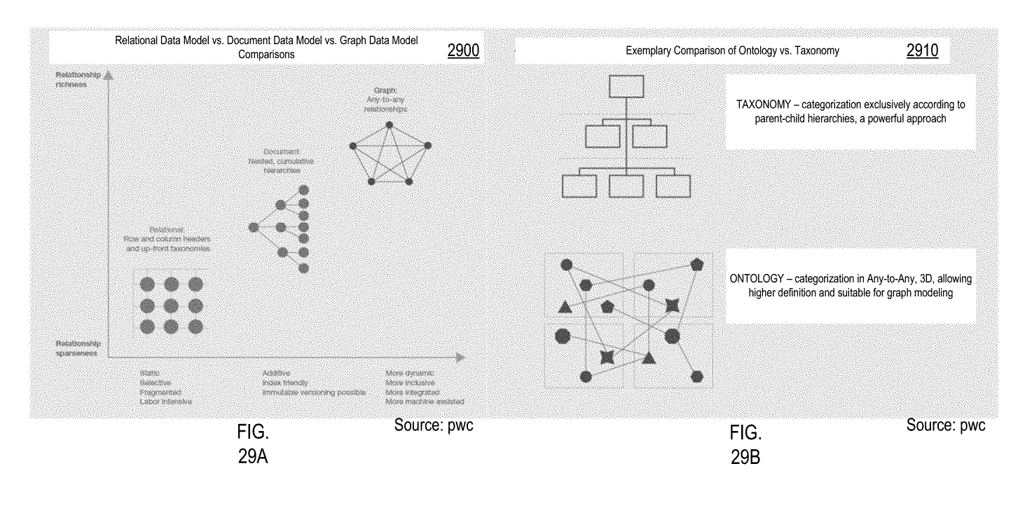

According to an exemplary embodiment, an exemplary Escalated Alerting System can be provided as shown in FIG. 24, and as illustrated via screenshots described further below with reference to screenshots depicted in FIGS. 31-35.

FIG. 24 depicts an exemplary diagram of an exemplary intelligent multi-tiered alerting subsystem, according to an exemplary embodiment, which can alert, e.g., a caregiver and/or family member(s) as a primary, and a healthcare provider, for example, as a secondary contact, according to an exemplary embodiment.

### Rules Engine

According to an exemplary embodiment, a Rules engine for House and 3rd party TEA, can be used, providing, according to an exemplary embodiment, various application programming interface (API) parameters for exemplary access, as well as, an exemplary number of TEA messages, which can be created.

According to an exemplary embodiment, exemplary health topics for TEA can be provided from any of various data providers, such as, e.g., but not limited to, U.S. Department of Health and Human Services (HHS), National Institutes of Health (NIH), public data providers, private data providers, syndicated data feed providers, real simple syndication (RSS), and/or other content and data service providers, etc. Exemplary data can be accessed through a data provider's API with, e.g., but not limited to, a single or more parameter(s), such as, e.g., but not limited to, a Topic ID API. According to an exemplary embodiment, a health data service provider, can acquire content such as, e.g., but not limited to, content regarding health topics through one or more APIs and can break down exemplary topics into pre-defined sections, in one embodiment. In one exemplary embodiment, an example topic can include, e.g., but not limited to, a topic “Watch Your Weight” which can be accessed from an exemplary URL such as, e.g., but not limited to, http://1.usa.gov/1VSN9x5 accessed Apr. 19, 2016 as showing:

There are seven sub topics under the main category which can be selected through a dropdown.

According to one exemplary embodiment, the exact same content is available through the API also. Thus, a single topic can provide the service with multiple contents for TEA which can be pushed to a defined audience at different times, according to one exemplary embodiment, see API CONTENT INFORMATION http://1.usa.gov/1qhn275.

### Rules for Applying TEA to a User

According to one exemplary embodiment, TEA can be applied to a user by rules, such as, e.g., but not limited to, parameters that can factor into a rule, can be flexible and can provide various types of TEA notifications.

According to one exemplary embodiment, the exemplary system can enable the exemplary admin system to define an exemplary group of users' devices (audience devices) to which TEA content can be delivered and can also define an exemplary frequency of delivery for each TEA content.

An exemplary system can be provided, according to one exemplary embodiment, to manage House TEA and third party TEA together from a single admin login, according to one exemplary embodiment. The single login can be demonstrated to you today, in the morning. All parameters for the TEA content delivery to ICmed users, according to one exemplary embodiment, can be included in a separate document attached. Please see “ICmed_TEA_Parameters.pdf”.

### Exemplary Throttling Feature/Function

Exemplary throttling features and/or functions can be provided, such as, e.g., but not limited to, sequencing, repetition, timing, etc.

Accordingly, an exemplary embodiment can include any of various exemplary features of an exemplary ad engine. According to one exemplary embodiment, exemplary steps are set forth below for creating an exemplary TEA from the exemplary ICmed admin panel and can deliver an exemplary admin panel to exemplary ICmed users, according to one exemplary embodiment.

### Example Step #1—Add Topics/Content

According to an exemplary embodiment, for House TEA the described process can be automated to bring in all content from the provider. Each topic, in one embodiment, can be created with TEA content blocks which can be individually delivered to users. For third party TEA, according to one exemplary embodiment, the topics and individual content should be manually entered.

### Example Step #2—Add Schedule

According to an exemplary embodiment, Once the main topic is created, the frequency of TEA delivery will be defined by the admin. For each topic this will be a daily/weekly number of content to be sent to a user, according to one exemplary embodiment.

### Example Topic:

“Watch Your Weight.”

Exemplary Content Blocks for Illustrative Exemplary TEA Delivery:
#1 The Basics;
#2 Health Benefits;
#3 Set Goals;
#4 Get Active;
#5 Eat Healthy;
#6 Portion Sizes; or
#7 Get Help.

### Schedule

### Daily

An exemplary schedule could include, e.g., but not limited to,
#TEA to Send Daily—3;
Time—9 am, 1 pm, 5 pm;
or

### Weekly

An exemplary schedule could include, e.g., but not limited to,
#TEA to Send Weekly—3;
Days to Send—MON, WED, SAT;
Time—9 am;

### Example Step #3—Add Audience

According to an exemplary embodiment, once content is added in and an exemplary schedule is created, the exemplary TEA audience can be selected. According to an exemplary embodiment, an exemplary TEA audience group can be created as new or selected from already existing presets, such as, e.g., but not limited to: Senior Citizens, Pregnant Wives, or Cancer Patients, etc.

According to an exemplary embodiment, an exemplary audience group creation module can have all parameters from “ICmed_TEA_Parameters.pd”. Multiple audience groups can be selected for a single topic, according to an exemplary embodiment.

For the above example “Watch Your Weight,” according to an exemplary embodiment, an exemplary schedule can be selected as below including, e.g., but not limited to:

Daily #TEA to Send—3

Time—9 am, 1 pm, 5 pm

According to an exemplary embodiment, there can be a total of 7 exemplary content pieces and the content can be delivered, as follows in one embodiment:

DAY 1—9 am—Content Piece #1;

DAY 1—1 pm—Content Piece #2;

DAY 1—5 pm—Content Piece #3;

DAY 2—9 am—Content Piece #4;

DAY 2—1 pm—Content Piece #5;

DAY 2—5 pm—Content Piece #6; or

DAY 3—9 am—Content Piece #7.

### Notification Messaging

According to an exemplary embodiment, exemplary notification messaging functionality can include providing update of various exemplary changes in status across a given users app, and/or across managed users. Various controls can be provided, according to an exemplary embodiment. Newly shared data can be provided to users previously provided selective sharing permissions at any of various levels of data granularity, via sharing parameters at various levels of types of data, capable of being shared, according to an exemplary embodiment.

According to an exemplary embodiment, the following exemplary changes of status for a notification message can be included, including, e.g., but not limited to,

New; and/or

Read.

### Exemplary Notifications for Exemplary Managed Account Users

According to an exemplary embodiment, since there is not an actual profile attached, managed accounts cannot have any notifications, according to one exemplary embodiment. Managed accounts, according to an exemplary embodiment, can be private and cannot be available for public users. However, TEA notifications, according to an exemplary embodiment, relating to a managed profile, can be sent to the account owner, a According to an exemplary embodiment. For example, according to an exemplary embodiment, if a user has a daughter user with a medical profile as a managed account, the user can get the TEA information for the data entered for the daughter user.

### Exemplary External Changes Can Prompt Notifications

According to an exemplary embodiment, external changes can cause notification messages, such as, e.g., but not limited to, invitations to connect, and/or acceptance of invitations, etc.

An exemplary full scope of system messages that can be sent according to one exemplary embodiment can include, e.g., but not be limited to,

How are you doing today?

Urging to fill out more info?

TEA? or

Other?, etc.

### Exemplary Notifications

According to an exemplary embodiment, the following are an exemplary set of notifications in an exemplary system. Additional alerts, notifications, and other messages can be provided by the exemplary ICmed app, according to an exemplary embodiment.

Exemplary notifications can include, e.g., but are not limited to:
Exemplary Connection Requests;
Exemplary Posts on a Shared Journal;
Exemplary TEA Notifications; or
Exemplary Questions such as, e.g., but not limited to, “How are you doing today?,”; or
“Have you taken your Medication for today?”, etc.
Exemplary escalated notification system using several layers of connections based on results from prior notification e.g., but not limited to (family is alerted first 2412, via an example tier one alert 2408, then healthcare team can be alerted 2414 via an example tier two alert 2410, if alerts to first person user are not addressed timely), see for example FIG. 24 and diagram 2400 illustrating escalated alerts. Application 2416 can use intelligent multi-tiered, escalated alerts to, e.g., but not limited to, alert family, and then alert, e.g., a healthcare team. As shown, an example alert could include an electronic communication 2406, such as, e.g., but not limited to, an electronic mail, a text, an SMS message, an instant message, an MMS message, a social media alert, a direct message, etc., to a mobile device 2416 of the user. In one embodiment, a brief alert 2404 can be sent, including a link “press for more” to allow additional information to be shared regarding the reason for the alert. Thus, data can be shared with an organization such as, e.g., but not limited to, a care giver, a medical provider, health care assistant, family member, insurance company, etc. One exemplary feature includes an ability for Organizations (second person) to push content to users (first person) through the exemplary Journal, in one embodiment. For example, content can be set off, in color, shading, or highlighting as sent from organizations, in an exemplary embodiment. For example, blue shaded content can be used to signify data that was sent by an example connected organization, in one exemplary embodiment.

Flowcharts—Various exemplary flow diagrams appear herein, and are not exhaustive, but serve as exemplary illustrations of how to make an exemplary embodiment of the claimed invention.

Data Schema—Various exemplary diagrams of an exemplary hardware architecture, software architecture, an exemplary ready to go, customized turn-key system including a mobile device app communicatively coupled to a backend database management system to access selectively shared, data from one or more other users of an exemplary system, according to an exemplary embodiment.

FIG. 25, discussed further below, depicts an exemplary computer system as can be used as a client, or server, web server, application server, and/or any other of the computing devices included in the other drawings, according to various exemplary embodiments. FIG. 25 depicts an exemplary diagram 2500 illustrating an exemplary computer/communications device hardware architecture as may be used in various components of exemplary embodiments of the present invention. FIG. 25 depicts an exemplary view 2500 of an exemplary computer system 102, 104, 112 as may be used in implementing an exemplary embodiment of the present invention. FIG. 25 depicts an exemplary embodiment of a computer system that may be used in computing devices such as, e.g., but not limited to, capture device 102, aggregation device 104, and/or server/consolidator device 112 according to an exemplary embodiment of the present invention. FIG. 25 depicts an exemplary embodiment of a computer system that may be used as client device 108, or a server device (not shown), etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 2500 is shown in FIG. 25, depicting an exemplary embodiment of a block diagram of an exemplary computer system useful for implementing the present invention. Specifically, FIG. 25 illustrates an example computer 2500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/8/10, etc. available from MICROSOFT® Corporation of Redmond, Wash., U.S.A., SOLARIS® from SUN® Microsystems of Santa Clara, Calif., U.S.A, OS/2 from IBM® Corporation of Armonk, N.Y, U.S.A, Mac/OS, Mac OSX, iOS, from APPLE® Corporation of Cupertino, Calif., U.S.A, etc, or any of various versions of UNIX® (a trademark of the Open Group of San Francisco, Calif., USA) including, e.g., LINUX®, HPUX®, IBM AIX®, and SCO/UNIX®, etc., Android OS from Google, Java from Oracle, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 2500 is shown in FIG. 25. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPhone, iOS, a smartphone, an iPad, a tablet based device, an ANDROID OS device, an iOS device, a Symbian based device, a Windows 8, 10, etc., device, etc., may also be implemented using a computer such as that shown in FIG. 25.

The computer system 2500 may include one or more processors, such as, e.g., but not limited to, processor(s) 2504. The processor(s) 2504 may be connected to a communication infrastructure 2506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 2500 may include a display interface 2502 that may forward, e.g., but not limited to, graphics, text, and other data, etc., from the communication infrastructure 2506 (or from a frame buffer, etc., not shown) for display on the display unit 2530.

The computer system 2500 may also include, e.g., but may not be limited to, a main memory 2508, random access memory (RAM), and a secondary memory 2510, etc. The secondary memory 2510 may include, for example, (but not limited to) a hard disk drive 2512 and/or a removable storage drive 2514, representing a floppy diskette drive, a magnetic tape drive, an optical disk drive, a compact disk drive CD-ROM, DVD, Personal Cloud storage, redundant array of inexpensive disks (RAID) array, etc. The removable storage drive 2514 may, e.g., but not limited to, read from and/or write to a removable storage unit 2518 in a well known manner. Removable storage unit 2518, also called a program storage device or a computer program product, may represent, e.g., but not limited to, a floppy disk, magnetic tape, optical disk, compact disk, etc. which may be read from and written to by removable storage drive 2514. As will be appreciated, the removable storage unit 2518 may include a computer usable storage medium having stored therein computer software and/or data.

In alternative exemplary embodiments, secondary memory 2510 may include other similar devices for allowing computer programs or other instructions to be loaded into computer system 2500. Such devices may include, for example, a removable storage unit 2522 and an interface 2520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 2522 and interfaces 2520, which may allow software and data to be transferred from the removable storage unit 2522 to computer system 2500.

Computer 2500 may also include an input device such as, e.g., (but not limited to) a mouse or other pointing device such as a digitizer, and a keyboard or other data entry device (none of which are labeled).

Computer 2500 may also include output devices, such as, e.g., (but not limited to) display 2530, and display interface 2502. Computer 2500 may include input/output (I/O) devices such as, e.g., (but not limited to) communications interface 2524, cable 2528 and communications path 2526, etc. These devices may include, e.g., but not limited to, a network interface card, and modems (neither are labeled). Communications interface 2524 may allow software and data to be transferred between computer system 2500 and external devices. Examples of communications interface 2524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 2524 may be in the form of signals 2528 which may be electronic, electromagnetic, optical or other signals capable of being received by communications interface 2524. These signals 2528 may be provided to communications interface 2524 via, e.g., but not limited to, a communications path 2526 (e.g., but not limited to, a channel). This channel 2526 may carry signals 2528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 2514, a hard disk installed in hard disk drive 2512, and signals 2528, etc. These computer program products may provide software to computer system 2500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,”” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 2508 and/or the secondary memory 2510 and/or removable storage units 2514, also called computer program products. Such computer programs, when executed, may enable the computer system 2500 to perform the features of the present invention as discussed herein. In particular, the computer programs, when executed, may enable the processor 2504 to provide a method to resolve conflicts during data synchronization according to an exemplary embodiment of the present invention. Accordingly, such computer programs may represent controllers of the computer system 2500.

In another exemplary embodiment, the invention may be directed to a computer program product comprising a computer readable medium having control logic (computer software) stored therein. The control logic, when executed by the processor 2504, may cause the processor 2504 to perform the functions of the invention as described herein. In another exemplary embodiment where the invention may be implemented using software, the software may be stored in a computer program product and loaded into computer system 2500 using, e.g., but not limited to, removable storage drive 2514, hard drive 2512 or communications interface 2524, etc. The control logic (software), when executed by the processor 2504, may cause the processor 2504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

In another exemplary embodiment, the invention may send escalated notifications to connected users based on outcomes from prior notifications.

### Collaborative File Cabinet

According to an exemplary embodiment of the ICmed platform, the invention includes a digital file cabinet collaborative graphical user interface depiction enabling interactive access to connected users to stored personal health data and files (such as, e.g., but not limited to, file sharing, commenting, notification of changes.) See, e.g., FIGS. 37, 38, 39, and 41.

### Exemplary Management of Exemplary Connected Organizations

An exemplary connection may include, in an exemplary embodiment, an established mutual link between ICmed users and multiple connected organizations. This exemplary feature of the exemplary ICmed platform may allow distinguishing specific users whom possess Organizational ID and or QR codes who may wish to collaborate closely with Organizations within the exemplary ICmed platform (such as, e.g., but not limited to, Hospitals, Employers, Providers.). Such collaboration within the exemplary ICmed platform include interactions with the exemplary ICmed Journal, TEA and Notifications, File Cabinet. An exemplary connection feature may also facilitate managing user permissions and privileges for access to data via the exemplary ICmed platform, according to an exemplary embodiment. See, e.g., FIGS. 30, 32, 33, 34, and 35.

FIG. 26 depicts an exemplary diagram 2600 of an exemplary integrated health file cabinet 2602 system 2600 for a computer and/or communications system and/or device, by which a provider team can push documents to a health file cabinet 2604, as shown, and can be placed in an example file folder metaphor application window of name file cabinet 2606, of folders, which can synchronize across multiple platforms, can include various categories of folders 2616a-2616g, additional example menu functions (e.g., adding folders, deleting, renaming, etc., can be pulled up by receiving a selection of GUI element 2614, additional folders can be added using GUI element 2612, folders can be sorted by name 2608, or by date 2610, and the file cabinet can be closed by receiving selection of the x GUI element, according to an exemplary embodiment.

According to an exemplary embodiment of the system, an electronic File Cabinet 2606 can provide a convenient way for users to organize important electronic documents and information such as illustrated in 2616a-2616g of FIG. 26.Digital File Cabinet, along with an exemplary feature allowing connecting to organizations that provide an organizational ID or QR code to users permits users to efficiently capture important health and medical information, in a form that allows access and ease of use.

Connections and interactions with organizations also assist users in gaining access to their own medical information, as well as sharing such information with their care givers, family and organizations.

### Non-Transitory Computer Readable Storage Medium

In some embodiments, the systems, software, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Exemplary Computer Program and Computing Device System

In some embodiments, the systems, software, and methods disclosed herein include at least one computer program, or use of the same. A computer program includes a sequence of instructions, executable in the digital processing device's central processing unit (CPU), written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Exemplary Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity.

### Exemplary Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Example Standalone Application Embodiment

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program.

In some other embodiments, a computer program includes one or more executable complied applications. In other embodiments, client server, peer-to-peer, software as a service, cloud-based subscription based, browser based, HTML, JAVA and/or other application based systems can alternatively be used

### Example Software Modules

The systems, software, and methods disclosed herein include, in various embodiments, software, server, and database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In one embodiment, a controller (not shown) as can be part of computer system 2500 and may be connected to, or coupled to, and/or communicate with entities such as, but not limited to: one or more users from user input devices; peripheral devices; an optional cryptographic processor device; and/or a communications network.

Depending on the particular implementation, features of the controller system may be achieved by implementing a microcontroller such as CAST'S R8051XC2 microcontroller; Intel's MCS 51 (i.e., 8051 microcontroller); and/or the like. Also, to implement certain features of the Scorecard, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the Scorecard component collection (distributed or otherwise) and/or features may be implemented via the microprocessor and/or via embedded components; e.g., via ASIC, coprocessor, DSP, FPGA, and/or the like. Alternately, some implementations of the controller system may be implemented with embedded components that are configured and used to achieve a variety of features or signal processing.

Depending on the particular implementation, the embedded components may include software solutions, hardware solutions, and/or some combination of both hardware/software solutions. For example, controller system features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features. A hierarchy of programmable interconnects allow logic blocks to be interconnected as needed by the system designer/administrator, somewhat like a one-chip programmable breadboard. An FPGAs logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the system may be developed on regular FPGAs and then migrated into a fixed version that more resembles ASIC implementations. Alternate or coordinating implementations may migrate controller features to a final ASIC instead of or in addition to FPGAs. Depending on the implementation all of the aforementioned embedded components and microprocessors may be considered the “CPU” and/or “processor” for the controller system.

### Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the device thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Peripheral devices may be connected and/or communicate to I/O and/or other facilities of the like such as network interfaces, storage interfaces, directly to the interface bus, system bus, the CPU, and/or the like. Peripheral devices may be external, internal and/or part of the Scorecard controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the controller may be embodied as an embedded, dedicated, and/or monitor-less (i.e., headless) device, wherein access would be provided over a network interface connection.

Cryptographic units such as, but not limited to, microcontrollers, processors, interfaces, and/or devices may be attached, and/or communicate with the controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Cryptographic Server

A cryptographic server component is a stored program component that is executed by a CPU, cryptographic processor, cryptographic processor interface, cryptographic processor device, and/or the like. Cryptographic processor interfaces can allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RCS), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Scorecard may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component can support encryption schemes allowing for the secure transmission of information across a communications network to enable the component to engage in secure transactions if so desired. The cryptographic component facilitates the secure accessing of resources and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11 compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11 a, b, d and g, (including, e.g., but not limited to IEEE 802.11g-2003, etc.), etc.

Various Exemplary Embodiments make further user of Encryption/Cryptographic processor, enabling encryption and decryption of private medical and/or health data.

Various Exemplary Embodiments make further user of Graph Network (nodes and relationships) or graph database or nodes(family members) and edges (capturing relationships), providing substantial access performance improvements, especially as numbers of users in a given system scale.

Various Exemplary Embodiments make further user of an improved Hierarchical Data Structure and/or familial graph relationship data structure interactive data access and display process.

Various Exemplary Embodiments make further user of Electronic Selective sharing/notifications/electronic alerts/social network posts.

Various Exemplary Embodiments make further user of Realtime Sensors (images, textual data captured, OCR, scanned electronic medical record data) continual data capture, including for example, biosensors, life science related data sensors such as, e.g., but not limited to ECG, EKG, Neurological sensed data, MRI, CAT Scan, diabetes and/or insulin sensors, blood pressure, cardiopulmonary activity sensing, pulse, sleep, breathing sensors, etc.

Various Exemplary Embodiments make further user of Artificial intelligence (neural networks, fuzzy logic, electronic decision support systems).

Various Exemplary Embodiments make further user of improved Graphical User Interface elements (interactive graphic elements, touch sensitive buttons, etc.).

Various Exemplary Embodiments make further user of Mobile Device Application platform on iOS or Android or other mobile operating system and sensors (touchscreen user interface, GUI, etc.).

Various Exemplary Embodiments make further user of any of various position sensing, and/or Location based sensing (GPS), altitude, altimeter, depth sensing subterranean, and internal and external building position sensing and tracking.

Various Exemplary Embodiments make further user of Continually updating capturing health content enhanced with location and medical information based analytics

Various Exemplary Embodiments make further user of Improved graphical user interface (GUI) with hierarchical familial relationship based data structure and graphical display of personal health data and including family relationship based and provider based.

Various Exemplary Embodiments make further user of Electronic social networking wall (electronic social networking posts of personal health information on an electronic “health journal).

Various Exemplary Embodiments make further user of Electronic selective sharing (social network based, electronic alerts/notifications, via GUI elements permitting various fine granularity levels of selection of personal health data permissible to be shared to a given second user from and by a first user having personal health data to share.

Various Exemplary Embodiments make further user of Realtime health monitoring sensors and sensed data capture.

Various Exemplary Embodiments make further user of Opt-in/Opt-out, sharing, and acceptance of HIPAA regulated access to personal health records, and maintenance of access tracking, history, and persistence.

Various Exemplary Embodiments make further user of User authentication and security systems (passwords, biometrics, hash algorithms).

FIG. 46, depicts, for example, an exemplary user interface for sharing data with other user contacts of a given user, such as, organizations, caregivers, employers, loved ones, family members, etc. User interface elements can enable turning on or off the selectable sharing, according to an exemplary embodiment.

Various Exemplary Embodiments make further user of platform specific interfaces (head up display (e.g., Google Glass like), augmented reality (e.g., Microsoft Hololens, Meta, MetaVision, Magic Leap, etc., and for more details regarding this the reader is referred to US 20140063055 A1, the contents of which are incorporated herein by reference in their entirety), and/or virtual reality (e.g., Oculus Rift, Google Cardboard, Samsung Gear VR, Hololens, etc.), and/or wearables (e.g., Apple watch, iwatch, heart rate and activity sensors, FitBit, etc.) wrist based interactive devices, heart, sugar, insulin, etc. monitors and/or sensors, etc.)See also, FIG. 46, for example, for additional illustrations of user connections.

Various Exemplary Embodiments make further user of alternative human based data input technologies such as, e.g., but not limited to, voice recognition system enhancements and other accessibility features, gesture technologies, motion based sensing (e.g., Kinect and Wii motion controller).

According to exemplary embodiments, users can selectively share their data with organizations and/or care givers, e.g., an oncologist, a dentist, a cardiologist, general practioner, a specialist, etc.

FIG. 27 illustrates an example diagram 2700, an example data warehouse of medical and clinical data, such as, e.g., but not limited to, a data architecture from a large medical clinic or hospital, depicted, for example, is a data warehouse that could be datamined and/or deep for an exemplary Mayo clinic enterprise data warehouse. Exemplary rules databases, and rules engines can be used to mine the example data and can be used to generate potential data that could be provided, such as, via TEA content, to users, according to an exemplary embodiment.

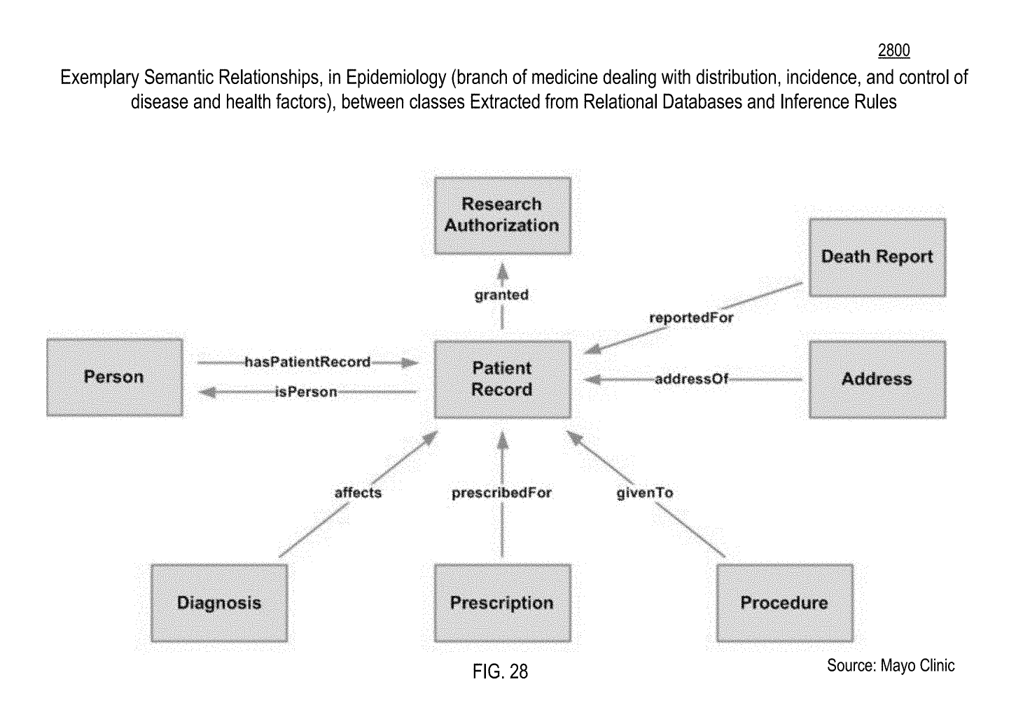

FIG. 28 depicts an exemplary diagram 2800 illustrating exemplary semantic relationships in epidemiology between classes extracted from relational databases and inference rules, according to one exemplary embodiment of an exemplary patient record of an exemplary clinic. Patient record data, and any extracts from such can be imported into the system, according to an exemplary embodiment. Various processing methods, including machine learning, deep learning, and big data datamining techniques, as noted herein can be used to analyze data, e.g., at an anonymized aggregate level, or via opt in authorization, etc., to allow providing recommendations, notifications, alerts, and/or provision of relevant content to users, according to exemplary embodiments.

FIG. 29A depicts diagram 2900 illustrating an exemplary comparison of exemplary relational data model vs. an exemplary document data model, vs. an exemplary graph data model, according to one exemplary embodiment. The exemplary diagram lists examples of advantages and disadvantages, as well as features of each of the various example data model structures of various example embodiments.

FIG. 29B depicts diagram 2910 illustrating an exemplary comparison of an ontology vs. a taxonomy, according to one exemplary embodiment. The exemplary diagram lists examples of advantages and disadvantages, as well as features of each of the terms of an ontology vs. a taxonomy. In one embodiment, the family tree data structure can be created in the form of a taxonomy. In another exemplary embodiment, the family tree data structure can be created in the form of an ontology, allowing greater definition and any-to-any relationships of more complex relationships.

FIG. 31 depicts diagram 3100 illustrating an exemplary screenshot of a mobile device with a touchscreen display and graphical user interface and showing dash board of individual medication 3110, an ability to track refills 3108, store images 3112 (e.g., of a pill, or directions, etc.), schedule for taking medication 3114, history of compliance (tracking of the taking of medication) 3116, medication factsheet 3118, and/or dosage strength history 3120, dosage strength 3106, start date of administrationd 3104, and ability to indicate when stopping use of a medicine 3102, according to exemplary embodiment.

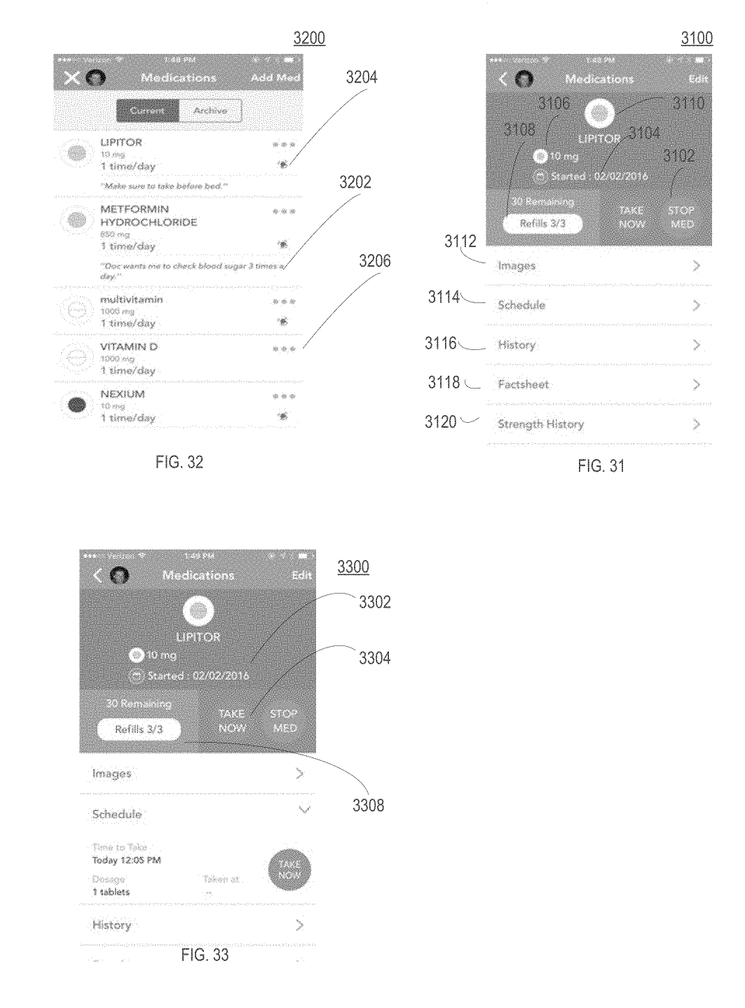

FIG. 32 depicts diagram 3200 illustrating an exemplary screenshot of a mobile device with a touchscreen display and graphical user interface and showing an example ability to track a list of multiple medications as illustrated, for instance including, e.g., non-compliance in order to trigger alerting (see FIG. 24), according to exemplary embodiment. Diagram 3200 can include, e.g., user entered data about a medication 3202, a reminder alarm indicator 3204, access to further information 3206, and allows for sending an alert when the user is determined not to have complied with taking their medication, via a one or more tiered alert process as set forth in greater detail with reference to FIG. 24.

FIG. 33 depicts diagram 3300 illustrating an exemplary screenshot of a mobile device with a touchscreen display and graphical user interface and showing subsection of medication dashboard with “Take Now” button 3304, that captures whether the user has taken their prescribed or unprescribed medications, and can be used to feed an exemplary notification system for medication compliance, also as shown, the number of units (e.g., pills) left can be automatically decremented as shown with “30 remaining” and the status can be depicted and if refills 3308 remain, then as the quantity of medication falls, communication can be sent to trigger refilling of the prescription, according to exemplary embodiment.

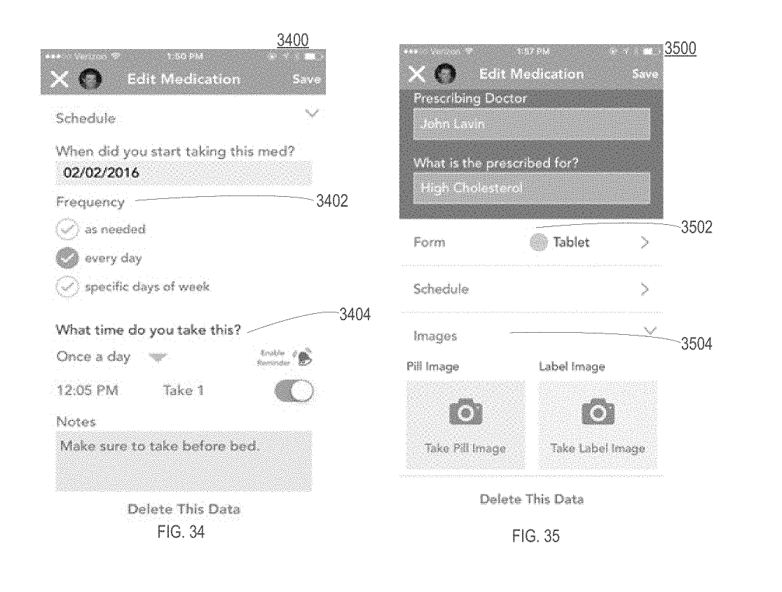

FIG. 34 depicts diagram 3400 illustrating an exemplary screenshot of a mobile device with a touchscreen display and graphical user interface and showing ability to edit frequency 3402 by selecting a GUI radio button element, and functions to allow adding and enabling reminders 3404, finally a field can be provided for note taking about the medication, according to exemplary embodiment.

FIG. 35 depicts diagram 3500 illustrating an exemplary screenshot of a mobile device with a touchscreen display and graphical user interface and showing ability to denote a form of the medication 3502 (e.g., tablet, capsule, pill, etc.) and/or alternatively permit a user to upload pictures of medication and/or medication labels 3504, according to exemplary embodiment.

FIG. 36 depicts diagram 3600 illustrating an exemplary screenshot of a mobile device with a touchscreen display and graphical user interface and depicting an exemplary Integrated Health File Cabinet 3602 including exemplary folders arranged as a file folder metaphor, according to exemplary embodiment.

FIG. 37 depicts diagram 3700 illustrating an exemplary screenshot of a mobile device with a touchscreen display and graphical user interface and showing application functionality enabling the ability to create new user defined folders 3702, prompting entry of a name for the new folder, according to exemplary embodiment.

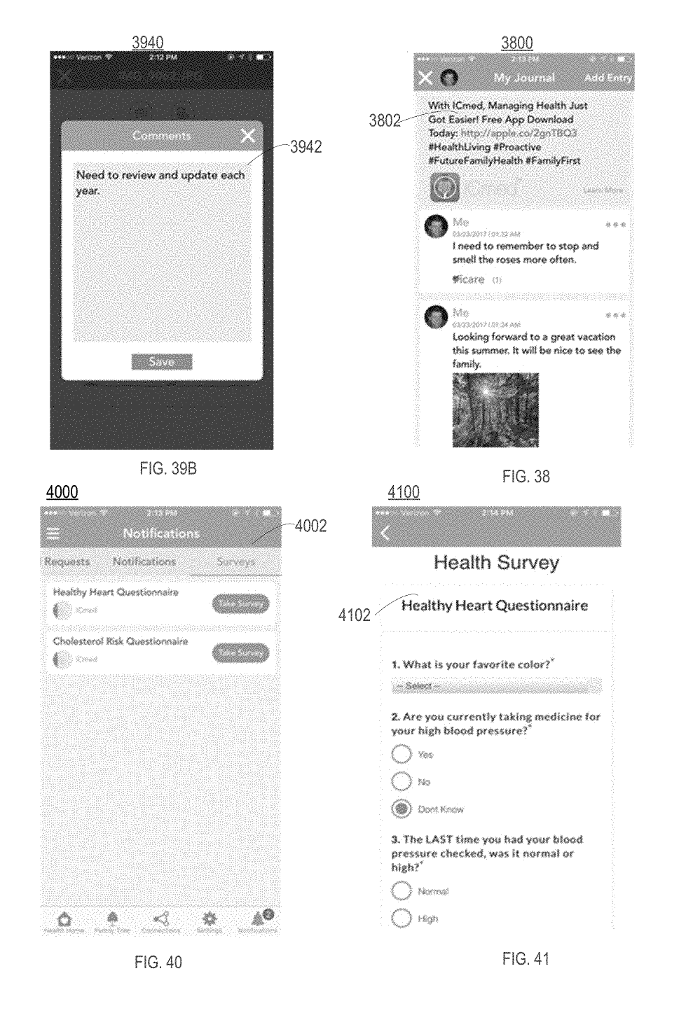

FIG. 38 is discussed further below after FIGS. 39A and 39B.

FIG. 39A depicts diagram 3900A illustrating an exemplary screenshot of a mobile device with a touchscreen display and graphical user interface and showing ability to share 3904, and/or edit contents 3906 of electronic file folders 3902, such as, in this case, an image in a JPEG format, with a example title IMG_9062.jpg, according to exemplary embodiment.

FIG. 39B depicts diagram 3900B illustrating an exemplary screenshot of a mobile device with a touchscreen display and graphical user interface and showing ability to leave comments on files stored in electronic file folders 3942, according to exemplary embodiment.

FIG. 38 depicts diagram 3800 illustrating an exemplary screenshot of a mobile device with a touchscreen display and graphical user interface and showing area shows posting from a Connected Organization of the user 3802, according to exemplary embodiment.

FIG. 40 depicts diagram 4000 illustrating an exemplary screenshot of a mobile device with a touchscreen display and graphical user interface and showing example of Notification and ability for Connected Organizations to publish surveys to connected users 4002, according to exemplary embodiment.

FIG. 41 depicts diagram 4100 illustrating an exemplary screenshot of a mobile device with a touchscreen display and graphical user interface and showing example of health survey designed by Connected Organization using the ICmed Enterprise (paid edition) platform 4102, according to exemplary embodiment.

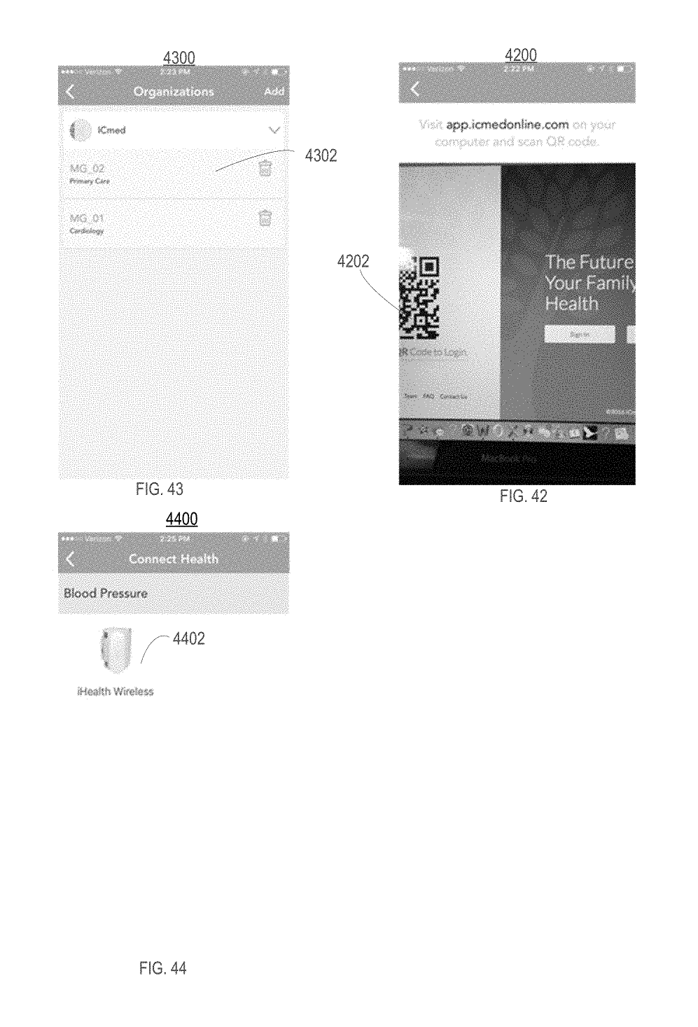

FIG. 42 depicts diagram 4200 illustrating an exemplary screenshot of a mobile device with a touchscreen display and graphical user interface and showing ability for users to access the ICmed system with QR codes 4202, according to exemplary embodiment.

FIG. 43 depicts diagram 4300 illustrating an exemplary screenshot of a mobile device with a touchscreen display and graphical user interface and showing ability for users to connect to Organization that provide them Organizational Codes 4302, according to exemplary embodiment.

FIG. 44 depicts diagram 4400 illustrating an exemplary screenshot of a mobile device with a touchscreen display and graphical user interface and showing ability for users to connect to other devices that track health data 4402, according to exemplary embodiment.

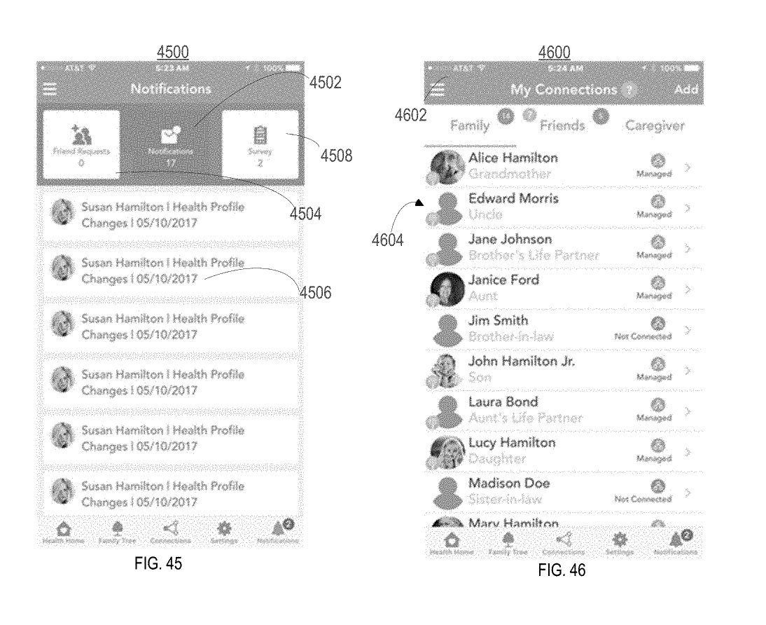

FIG. 45 depicts diagram 4500 illustrating an exemplary screenshot of a mobile device with a touchscreen display and graphical user interface and showing notifications dashboard 4502 and ability to manage connection requests 4504, notifications of changes 4506 to shared profiles, and ability to receive surveys from connected organizations 4508, according to exemplary embodiment.

FIG. 46 depicts diagram 4600 illustrating an exemplary screenshot of a mobile device with a touchscreen display and graphical user interface and showing connections dashboard 4602, and ability to manage connections with Family, Friends and Caregivers, according to exemplary embodiment.

While various embodiments of the present invention have been described above, it should be understood that they have been presented by way of example only, and not limitation. Thus, the breadth and scope of the present invention should not be limited by any of the above described exemplary embodiments, but should instead be defined only in accordance with the following claims and their equivalents.

What is claimed is:

1. A computer-implemented method of capturing and displaying health information of a first person on an electronic computing device, the electronic computing device comprising:
at least one computer processor; and
at least one memory device,
the computer-implemented method comprising:
a) receiving, by the at least one computer processor, data about a first person user on at the at least one first client computing device, wherein the first person user has one or more family member users, each having at least one computing device, or at least one user with which the user may wish to share a personal health data record, the data about the at least one first person user comprising:
any identification data about the first person;
any inputted health related data about the first person; or
and captured health related data about the first person, comprising at least one of:
any health related data;
an application programming interface (API) accessible data; or
other health records comprising at least one of:
electronic medical record (EMR);
scanned data;
sensed data; or
optical character recognition (OCR) captured data;
b) receiving, by the at least one computer processor, data about at least one second person user, wherein the at least one second person user comprises at least one of: any other person user with which the first person wishes to be connected, a family member user, a guardian user, a friend user, an individual friend user, an individual care provider, or organization, the data about the at least one second person user comprising:
any identification data about the at least one second person;
any inputted health related data about the at least one second person; or
any captured health related data about the at least one second person; and
at least one of:
c) creating, by the at least one computer processor, at least a portion of the data about the at least one second person user, or a managed user;
d) sharing, by the at least one computer processor, at least a portion of the data about the first person user or any managed user, to the at least one second person user, or from the at least one second person user to the first person user;
e) transferring ownership, by the at least one computer processor, the data collected about the second person user, if the second person user is the any managed user;
f) analyzing, by the at least one computer processor, the data collected about the at least one first user, or the at least one second user; or
g) disseminating, by the at least one computer processor, material relevant to the data collected about at least one of the at least one first user, at least one second user, or any managed user;
h) escalated alerting by the at least one computer processor, to the at least first person user or the connected second person users or organizations, user defined instances of non-compliance with outcomes; or
i) escalated alerting by the at least one computer processor, to the at least first person user or the connected second person users or organizations, user defined instances of non-compliance with outcomes, wherein said outcomes comprise at least one of:
identifying non-compliance with medications, or
identifying vitals determined outside of predetermined ranges.

2. The computer-implemented method according to claim 1, wherein said sharing of said (c) comprises at least one of:
i) sharing with a computing device of the at least one second user, wherein the at least one second user is an individual;
ii) sharing with a plurality of computing devices of the at least one second user, wherein the at least one second user is at least one of an individual, or a group;
iii) sharing with a computing device of a user previously managed by the first person user;
iv) sharing by a computing device of the first person user, wherein the first person user is a parent or guardian, to a computing device of the at least one second person user, wherein the at least one second person user is a child and wherein said sharing occurs at a time comprising at least one of:
A) when the child becomes an age of majority;
B) at a predetermined age, or
C) upon occurrence of a certain event;
v) sharing with at least one computing device of the at least one second user, wherein the at least one second user comprises at least one of an individual, or a group, and wherein the at least one individual or group comprises at least one of:
a computing device of a family member user;
a computing device of a friend user;
a computing device of a relative user;
a computing device of a parent user;
a computing device of a child user;
a computing device of a health care provider user;
a computing device of a doctor user;
a computing device of a dentist user;
a computing device of a specialist user;
a computing device of a nurse user;
a computing device of a nurse practitioner user;
a computing device of a care provider user; or
a computing device of another user.

3. The computer-implemented method according to claim 1, wherein said sharing of said (c) comprises at least one of:
i) selectively sharing of only a portion of the data of the first person user; or
ii) receiving a selected portion of the data of the first person user to be selectively shared with respect to the at least one second person user.

4. The computer-implemented method according to claim 1, further comprising:
d) receiving, by the at least one computer processor, permission data granting at least one of:
permission, opt-in; or opt-out, about providing selective access to the data about the first person to allow selectively sharing a selected portion of the data about the first person to the at least one second person, or selectively choosing at least one portion, or all of the data about the first person with at least one of:
the at least one second person; or
at least one additional person.

5. The computer-implemented method according to claim 1, further comprising:
d) encrypting and storing, by the at least one computer processor, the data and files of the first person user, and the data of the at least one second person user in the memory.

6. The computer-implemented method according to claim 1, further comprising:
d) analyzing, by the at least one computer processor, in an electronic decision support system the data about the user, to identify targeted educational assistance (TEA) content data based on the data of the first person and the at least one second person; and
e) providing, by the at least one computer processor, output of the analyzed TEA content data.

7. The computer-implemented method according to claim 6, further comprising:
f) transmitting, by the at least one computer processor, the identified targeted educational assistance (TEA) content resulting from said analyzing of said d), over an electronic communications network to at least one computing device of at least one of:
i. the first person; or
ii. the at least one second person

8. The computer-implemented method according to claim 1, further comprising:
wherein the at least one computing device comprises at least one interactive touch screen based input output display;
d) displaying, by the at least one computer processor, in an interactive electronic graphical user interface (GUI) on the at least one interactive touch screen based input output display, a graphical indication of any familial relationship between the first person user and the at least one second person user; and
e) enabling, by the at least one computer processor, interactive access to the graphical indication of the any familial relationship between the first person user and the at least one second person user.

9. The computer-implemented method according to claim 1, further comprising:
capturing, by the at least one computer processor, any familial relationship between the first person and the at least one second person.

10. The computer-implemented method according to claim 1, wherein the at least one second person user comprises at least one marketer, employer, insurer, care or service provider user of the first person and second person user; and further comprising:
d) electronically mining, by the at least one computer processor, the data of at least one of the first person user and the at least one second person user, and
e) based on said electronically mining, providing, by the at least one computer processor, targeted information based on said electronically mined data to at least one of the first or second person users.

11. The computer-implemented method according to claim 1, wherein said sharing of the data is provided via an electronic online social networking wall where social network wall posts can be posted of at least one personal health data post of the first person user or connected organizations and connected individuals of the first person, for selective sharing to the at least one second person user, and receiving indication of selection of, and displaying receipt of the selected indication of a graphical user interface element by the user indicating the user's reaction to the social network post.

12. The computer-implemented method according to claim 11, wherein the selection comprises receiving a selection of a positive indication of the social network post shared on the electronic online social networking wall.

13. A data processing system of capturing and displaying health information of a first person comprising:
an electronic computing device, the electronic computing device comprising:
at least one computer processor; and
at least one memory device; and
wherein the at least one computer processor is configured to:
receive data about a first person user on at the at least one first client computing device, wherein the first person user has one or more family member users, each having at least one computing device, or at least one user with which the user may wish to share a personal health data record, the data about the at least one first person user comprising:
any identification data about the first person;
any inputted health related data about the first person; or
any captured health related data about the first person, comprising at least one of:
any health related data;
an application programming interface (API) accessible data; or
other health records comprising at least one of:
electronic medical record (EMR);
scanned data;
sensed data; or
optical character recognition (OCR) captured data;
receive data about at least one second person user, wherein the at least one second person user comprises at least one of: any other person user with which the first person wishes to be connected, a family member user, a guardian user, a friend user, an individual friend user, an individual care provider, or organization, the data about the at least one second person user comprising:
any identification data about the at least one second person;
any inputted health related data about the at least one second person; or
any captured health related data about the at least one second person; and
at least one of:
create at least a portion of the data about the at least one second person user, or a managed user;
share at least a portion of the data about the first person user or any managed user, to the at least one second person user, or from the at least one second person user to the first person user;
transfer ownership of the data collected about the second person user, if the second person user is the any managed user;
analyze the data collected about the at least one first user, or the at least one second user;
disseminate material relevant to the data collected about at least one of the at least one first user, at least one second user, or any managed user;
escalate alert to the at least first person user or the connected second person users or organizations, user defined instances of non-compliance with outcomes; or
escalate alert to the at least first person user or the connected second person users or organizations, user defined instances of non-compliance with outcomes, wherein said outcomes comprise at least one of:
identify non-compliance with medications, or
identify vitals determined outside of predetermined ranges.

14. A computer program product embodied on a computer accessible non-transitory medium comprising program logic, which when executed on at least one computer processor implements a computer-implemented method of capturing and displaying health information of a first person on an electronic computing device, the electronic computing device comprising:
at least one computer processor; and
at least one memory device,
the computer-implemented method comprising:
a) receiving, by the at least one computer processor, data about a first person user on at the at least one first client computing device, wherein the first person user has one or more family member users, each having at least one computing device, or at least one user with which the user may wish to share a personal health data record, the data about the at least one first person user comprising:
any identification data about the first person;
any inputted health related data about the first person; or
any captured health related data about the first person, comprising at least one of:
any health related data;
an application programming interface (API) accessible data; or
other health records comprising at least one of:
electronic medical record (EMR);
scanned data;
sensed data; or
optical character recognition (OCR) captured data;
b) receiving, by the at least one computer processor, data about at least one second person user, wherein the at least one second person user comprises at least one of: any other person user with which the first person wishes to be connected, a family member user, a guardian user, a friend user, an individual friend user, or an individual care provider or organization, the data about the at least one second person user comprising:
any identification data about the at least one second person;
any inputted health related data about the at least one second person; or
any captured health related data about the at least one second person; and
at least one of:
c) creating, by the at least one computer processor, at least a portion of the data about the at least one second person user, or a managed user;
d) sharing, by the at least one computer processor, at least a portion of the data about the first person user or any managed user, to the at least one second person user, or from the at least one second person user to the first person user;
e) transferring ownership, by the at least one computer processor, the data collected about the second person user, if the second person user is the any managed user;
f) analyzing, by the at least one computer processor, the data collected about the at least one first user, or the at least one second user; or
g) disseminating, by the at least one computer processor, material relevant to the data collected about at least one of the at least one first user, at least one second user, or any managed user;
h) escalated alerting by the at least one computer processor, to the at least first person user or the connected second person users or organizations, user defined instances of non-compliance with outcomes; or
i) escalated alerting by the at least one computer processor, to the at least first person user or the connected second person users or organizations, user defined instances of non-compliance with outcomes, wherein said outcomes comprise at least one of:
identifying non-compliance with medications, or
identifying vitals determined outside of predetermined ranges

15. The computer program product according to claim 14, wherein the method of escalated alerting comprises:
transmitting alerts, to at least one of:
the first person user; or
any connected second person user; or
any connected second person user comprising at least one of;
at least one family member,
at least one individual care provider, or
at least one organization.

16. The system according to claim 13, further comprising wherein the data processing system comprises:
wherein the data processing system is configured to:
capture and display data in electronic file cabinets;
wherein said electronic file cabinets are configured to,
upon request by the first person or other person user with which the first person wishes to be connected, a family member user, a guardian user, a friend user, an individual friend user, or an individual care provider or organization,
create a folder to store the data.

17. The system according to claim 16, further comprising at least one of:
wherein the data about the at least one first person user comprises:
any identification data, any inputted health related data, or any captured health related data; or
wherein the data comprises at least one of:
personal medical and health information;
any health related data,
application programming interface (API) accessible data, or
other health records comprising at least one of:
electronic medical record (EMR),
scanned data,
sensed data, or
optical character recognition (OCR) captured data.

18. The system according to claim 13, further comprising wherein the data processing system comprises:
wherein the system is configured to at least one of:
detect that a patient is not adhering to prescribed or non-prescribed medications; and
upon detection, to activate a chain of escalating notifications based on the detection of non-adherence,
the system comprising:
an electronic computing device, wherein the electronic computing device comprises:
at least one computer processor; and
at least one memory device; and
wherein the at least one computer processor is configured to:
receive data about patient-adherence derived from inputs from at least one of:
the first person user;
other person user with which the first person wishes to be connected;
a family member user;
a guardian user;
a friend user;
an individual friend user;
an individual care provider; or
organization.
